(19) United States
(12) Patent Application Publication
(10) Pub. No.: US 2015/0368276 A1
(43) Pub. Date: Dec. 24, 2015

(54) VAPOCHROMIC COORDINATION POLYMERS FOR USE IN ANALYTE DETECTION

(71) Applicant: SIMON FRASER UNIVERSITY, Burnaby (CA)

(72) Inventors: Jeffrey Scott OVENS, Port Moody (CA); Ania Shantel SERGEENKO, Vancouver (CA); Bryton Ray VARJU, Port Coquitlam (CA); Matthew Lachlan BROWN, Burnaby (CA); Daniel Bernard LEZNOFF, Vancouver (CA); Julie LEFEBVRE, Saint-Jean-sur-Richelieu (CA); Michael Iacov KATZ, North Vancouver (CA)

(21) Appl. No.: 14/800,484

(22) Filed: Jul. 15, 2015

Related U.S. Application Data
(63) Continuation-in-part of application No. 13/279,099, filed on Oct. 21, 2011.
Application No. 13/279,099 is a continuation of application No. 12/169,406, filed on Jul. 8, 2008, now Pat. No. 8,043,860.
Application No. 12/169,406 is a continuation-in-part of application No. 11/577,299, filed on Nov. 28, 2007, now Pat. No. 8,008,090.
(60) Provisional application No. 60/618,573, filed on Oct. 15, 2004.

(51) Int. Cl. C07F 1/08; C09K 11/06; C09K 11/65; G01N 31/22; C01C 3/11

(52) U.S. Cl. CPC C07F 1/08; G01N 31/22; C01C 3/11; C09K 11/65; C09K 11/06; C09K 2211/188; C09K 2211/10

(57) ABSTRACT

Vapochromic coordination polymers useful for analyte detection are provided. The vapochromism may be observed by visible color changes, changes in luminescence, and/or spectroscopic changes, for example in the infrared (IR) or Raman signatures. One or more of the above chromatic changes may be relied upon to identify a specific analyte, such as a volatile organic compound or a gas. The chromatic changes may be reversible to allow for successive analysis of different analytes. The coordination polymer has the general formula M_{W}[M′_{X}(Z)_{Y}]_{N} wherein M and M′ are the same or different metals capable of forming a coordinate complex with the Z moiety; Z is selected from the group consisting of halides, pseudohalides, thiolates, alkoxides and amides; W is between 1-6; X and Y are between 1-9; and N is between 1-5. One embodiment provides [Metal(CN)₂]-based coordination polymers with vapochromic properties, such as Cu[Au(CN)₂]₂ and Zn[Au(CN)₂]₂ polymers.

### REFERENCE TO RELATED APPLICATIONS

This application is a continuation-in-part of U.S. patent application Ser. No. 13/279,099 filed 21 Oct. 2011 which is a continuation of U.S. patent application Ser. No. 12/169,406 filed 8 Jul. 2008, now U.S. Pat. No. 8,043,860, which is a continuation-in-part of U.S. patent application Ser. No. 11/577,299 filed 17 Oct. 2005, now U.S. Pat. No. 8,008,090, which claims the benefit of U.S. provisional patent application Ser. No. 60/618,573 filed 15 Oct. 2004. The disclosure of each of the previously referenced patent applications and patents is hereby incorporated by reference in its entirety.

### FIELD OF THE INVENTION

This application relates to coordination polymers having vapochromic properties useful for analyte detection.

### BACKGROUND OF THE INVENTION

The controlled design and synthesis of metal-organic coordination polymers from the self-assembly of simple molecular building blocks is of intense interest due to the promise of generating functional materials.^{1,2} Over the past decade, coordination polymers have been receiving increased attention due to the ability to tailor them toward various properties such as magnetism,²⁻⁸ porosity,⁹⁻¹⁴ luminescence¹⁵⁻²⁰ and vapochromism²¹⁻²⁷ through strategic choice of metal centres and bridging and ancillary ligands^{1,28-32} More recently, coordination polymers have been explored as solid-state sensors for the detection of explosive materials³³⁻³⁵ and volatile organic compounds (VOCs) in industrial settings.^{18,26,27,36} Such devices have important applications in defense, industry and safety and security.^{37,38}

Vapochromic materials, which display optical absorption or luminescence changes upon exposure to vapors of analytes, such as volatile organic compounds (VOCs), have been a focus of attention due to their potential applications as chemical sensors.^{39-44,21} For example, when exposed to certain organic solvents, the extended Prussian Blue Co²⁺-[Re₆Q₈(CN)₆]⁴⁻ (Q=S, Se) system yields dramatic changes in the visible spectrum that are attributable to the sensed solvent impacting the geometry and hydration around the Co^{II} centers.²¹ In another example, the porous metal-organic framework [(WS₄Cu₄)I₂(dptz)₃].3DMF (dptz=3,6-di-(pyridin-4-yl)-1,2,4,5-tetrazine; DMF=dimethylformamide) exhibits solvatochromism when immersed in solvents such as MeCN and CHCl₃, making it a potential sensor of these small molecules in solution.⁴⁵

Several vapochromic compounds based on Au^{I}, Pd^{II}, and Pt^{II} coordination polymers have also been reported.³⁹⁻⁴⁴ The vapochromism in these systems is based on changes in both the visible absorption and emission spectra. In the linear {Tl[Au(C₆Cl₅)₂]}ₙ polymer, weak interactions between the Tl atoms and the adsorbed VOC molecules modify slightly the colour, and more significantly the emission spectra.⁴² On the other hand, changes in the emission spectra of [Pt(CN—R)₄][M(CN)₄] (R=iso-C₃H₇ or C₆H₄—CₙH₂ₙ₊₁; n=6, 10, 12, 14 and M=Pt, Pd) occur when metal-metal distances are modified due to the presence of VOC molecules in lattice voids; small changes in the absorption spectrum can also be observed.^{43,46} Another example is the trinuclear Au^{I} complex with carbeniate bridging ligands, for which its luminescence is quenched in the solid-state when C₆F₆ vapor is adsorbed due to the disruption of Au-Au interactions.⁴¹

Some of these vapochromic materials have been incorporated in chemical sensor devices. For example, [Au-(PPh₂C(CSSAuC₆F₅)PPh₂Me)₂][ClO₄] has been used in the development of an optical fiber volatile organic compound sensor.⁴⁷ A vapochromic light emitting diode⁴⁸ and a vapochromic photodiode⁴⁹ have also been built using tetrakis(p-dodecylphenylisocyano) platinum tetranitroplatinate and bis(cyanide)-bis(p-dodecylphenylisocyanide)platinum(II), respectively.

In these previous discoveries, slight shifts in the ν_{CN} stretch are observed if hydrogen-bonding between the N(cyano) atoms and the VOC molecules present in the lattice occurs Importantly, VOCs cannot be readily differentiated or identified via IR spectroscopy in this case since ν_{CN} shifts of only 0-10 cm⁻¹ are usually observed.^{47,50,51}

As indicated above, other gold and platinum-containing materials have also been extensively employed as vapochromic sensors.^{40,47,52-69} The organometallic Au/Ag-based system AuAg(C₆F₅)₂L (L=pyridine, 2,2′-bipyridine, 1,10-phenanthroline, 1,2-diphenylacetylene and others)⁴⁷ changes from a red or orange colour to white when exposed to certain coordinating vapours, such as MeOH, EtOH and acetone. This change occurs when the coordinating solvent molecules bind to the Ag centres which breaks the Ag—Au bonds. These materials have also been used in conjunction with optical fibers, where the change in the material's refractive index provides the sensory readout.^{56-64,70} Several other examples of mixed Au/M (M=Tl, Ag, Cu) compounds⁶⁵⁻⁶⁸ also exist, such as Tl[Au(C₆Cl₅)₂]⁶⁶ described above and [Au(im(CH₂py)₂)₂(Cu(MeCN)₂)₂](PF₆)₃.⁶⁸ The former exhibits vapochromism and vapoluminescence when exposed to vapours such as THF, acetone and MeCN by virtue of changes to Au-M bonds in the structure, while the latter undergoes ligand exchange when exposed to vapours such as MeOH and MeCN. In another example, the dimeric gold-dithiocarbamate chains, such as Au₂(S₂CN)₂(C₅H₁₁)₄ exhibit both a vapochromic response and a ‘switching on’ of luminescence when exposed to polar aprotic solvents such as CH₂Cl₂, CHCl₃ and MeCN.⁴⁰ This change is a result of changes in the intermolecular Au—Au interaction distances.^{40,71} The related compound, [Au₂(dppm)(TU)][CF₃COO]₂ (dppm=bis(diphenylphosphino)methane; TU=2-thiouracyl) exhibits loss of emission when exposed to CF₃COOH vapour.⁵⁴ Another bimetallic material, (C₆F₅Au)₂(μ-1,4-diisocyanobenzene) exhibits mechanochromism,⁷² wherein the emission wavelength changes upon grinding of the material. However, once a solvent or vapour is exposed to it, the emission returns to its original colour. The trimeric Au-based system Au₃(CH₃N═COCH₃)₃ exhibits emission solvatochromism,⁵⁵ wherein direct exposure of the material to liquid solvent elicits a change in the emissive properties. In this case, exposure to neat CHCl₃ ‘turns on’ yellow emission.

To overcome the shortcomings of the prior art, the need has arisen for coordination polymers having improved vapochromic properties for enhancing the sensitivity of analyte detection. The IR and Raman signatures achieved by the present invention are unusually diagnostic for a particular analyte, both in the number and position of the IR or other spectral bands. In the case of some gases, the adsorption of the analyte to the polymer substantially enhances the IR response. That is, the response in the ν_{CN} or other pertinent region of the spectrum is extremely strong compared to the direct IR-signature of some gases, which is the current state-of-the-art in gas sensors. Moreover, in the present invention the vapochromism of polymers can be readily and reversibly observed both by multiple means, such as visible colour changes and luminescence changes in addition to spectroscopic changes.

### SUMMARY OF THE INVENTION

In accordance with the invention, a vapochromic coordination polymer is described having the general formula M_{W}[M′_{X}(Z)_{Y}]_{N} wherein M and M′ are the same or different metals capable of forming a coordinate complex with the 7 moiety; Z is selected from the group consisting of halides, pseudohalides, thiolates, alkoxides and amides; W is between 1-6; X and Y are between 1-9; and N is between 1-5. For example, in one embodiment W and X are 1 and Y and N are 2.

The vapochromic properties of the polymer change when the polymer is exposed to different analytes. The polymer may therefore be used for analyte detection. The vapochromism may be observed by visible colour changes, changes in luminescence, and/or spectroscopic changes. One or more of the above chromatic changes may be relied upon to identify a specific analyte, such as a volatile organic compound or a gas. The chromatic changes may be reversible to allow for successive analysis of different analytes using the same polymer.

In alternative embodiments of the invention M may be a transition metal, such as Cu and Zn, M′ may be a metal such as Au, Ag, Hg and Cu, and Z may be a pseuodohalide, such as CN, SCN, SeCN, TeCN, OCN, CNO and NNN. Optionally, an organic ligand may be bound to M. In one particular embodiment a new class of [Metal(CN)₂]-based coordination polymers with vapochromic properties is described, such as Cu[Au(CN)₂]₂ and Zn[Au(CN)₂]₂ polymers.

In alternative embodiments vapochromic coordination polymers may be described by the general formula Mₓ[M′_{y}M“_{2-x-y}(Z)₂] wherein M, M′ and M” are the same or different metals selected from the group consisting of Au, Ag, Cu and Tl; Z is selected from the group consisting of halides, pseudohalides, thiolates, alkoxides and amides; and X and Y are each between 0 and 1. In particular embodiments Y=2-X, i.e. M″ is omitted, and X and Y are non-integers. In some particular embodiments M is Cu, M′ is Au, and Z=CN. The Cu may be present in the Cu(I) oxidative state. The vapochromic polymers may be adapted for sensing analytes comprising oxygen, nitrogen, sulphur, phosphorus and selenium donors. The polymers may exhibit reactivity with analytes present in either the vapour phase or in solution, such as aqueous or hydrocarbon solutions.

In further alternative embodiments vapochromic coordination polymers may be described by the general formula M[M′(Z)₄] wherein M is a metal; M′ is Pt; and Z is selected from the group consisting of halides, pseudohalides, thiolates, alkoxides and amides. In some particular embodiments M is Pb, Z is CN and the polymer is adapted for reversibly sensing halogens such as chlorine or S-donors such as H₂S.

In some embodiments vapochromic coordination polymers having the general formula M_{W}[M′_{X}(Z)_{Y}(Z′)_{O}]_{N} are provided, for example Pb[Pt(CN)₄(x)₂] where X is a halogen, such as Cl. In one particular embodiment the hydrated product Cu(OH₂)₂[PtCl₂(CN)₄] can be used as sensor to vapochromically sense pyridine, ammonia, and dimethylformamide (DMF).

In one embodiment the polymer-analyte adduct Cu[Au(CN)₂](Me₂S) is described which is functional as a white-light emitter.

The invention also encompasses uranyl and mercury-based cyano metallate polymers and uses thereof as analyte sensors.

### BRIEF DESCRIPTION OF THE DRAWINGS

In drawings which describe embodiments of the invention but which should not be construed as restricting the spirit or scope of the invention in any way,

FIG. 1 is a diagram of the 1-D crystal structure of a first polymorph of Cu[Au(CN)₂]₂(DMSO)₂. DMSO-methyl groups were removed for clarity.

FIGS. 2(a) and (b) are diagrams of the 3-D crystal structure of the first polymorph of Cu[Au(CN)₂]₂(DMSO)₂. FIG. 2(a) shows offset stacks of chains in 1, viewed down the (101)-plane (slightly tilted). Au—Au bonds connect bridging and dangling [Au(CN)₂]⁻ units of neighboring chains (vertical lines). FIG. 2(b) shows the 3-D structure of 1 formed via Au—Au bonding, viewed down the a-axis.

FIGS. 3(a) and (b) are diagrams of the 2-D and 3-D crystal structure of a second polymorph of Cu[Au(CN)₂]₂(DMSO)₂. FIG. 3(a) shows the extended structure of 2 showing the 2-D corrugated layers, viewed down the a-axis. DMSO-methyl groups were removed for clarity. FIG. 3(b) shows layers stacked via aurophilic interactions to yield a 3-D network.

FIG. 4 is a graph showing the thermal stability of the first and second polymorphs of Cu[Au(CN)₂]₂(DMSO)₂.

FIG. 5 are photographs showing the vapochromic behavior of the second polymorph of Cu[Au(CN)₂]₂(DMSO)₂ after exposure to various analytes, namely DMSO, water, MeCN, DMF, Dioxane, Pyridine and NH₃.

FIGS. 6(a) and (b) are diagrams of the 2-D and 3-D crystal structure of Cu[Au(CN)₂]₂(DMF). FIG. 6(a) shows an extended structure of 3 showing the 2-D layers (hydrogen atoms were removed for clarity). FIG. 6(b) shows aurophilic interactions between the layers yield a 3-D network.

FIGS. 7(a) and (b) are diagrams of the 2D crystal structure of Cu[Au(CN)₂]₂(pyridine)₂.

FIG. 8 is a diagram of the postulated 2-D crystal structure of a solvent free complex of Cu[Au(CN)₂]₂.

FIG. 9 are photographs showing changes in luminescence in the Zn[Au(CN)₂]₂(analyte)ₓ system (top—under room light; bottom—under UV light). From left to right: Analyte=None, NH₃, pyridine, CO₂, DMSO. The cyanide-IR changes are dramatic and distinctive for each analyte.

FIG. 10 is a spectrograph showing the comparative IR spectra in the cyanide region for three analytes (solvents), namely pyridine, DMF and water using the Cu[Au(CN)₂]₂(solvent)ₓ polymer.

FIG. 11 is a series of photographs showing the structure of Zn[Au(CN)₂]₂ polymorph crystals. The crystal habit of polymorph crystals is shown. The left image shows two hexagonal crystal habits of 13α. The middle image shows the plate shaped crystal habit of 13β. The right image shows the cross shaped crystal habit of 13γ. Each arm of the cross is a two component non-merohedral twin.

FIGS. 12(a) and 12(b) are diagrams of the crystal structure of an α polymorph of Zn[Au(CN)₂]₂. Panel (a) shows the crystal structure of 13α viewed down the c-axis. (Left): A single quartz-like network. (Right): All six interpenetrated quartz-like networks. Panel (b) shows a 1-D chain of gold-gold bonded Au(CN)₂⁻ units.

FIGS. 13(a), 13(b) and 13(c) are diagrams of the crystal structure of an β polymorph of Zn[Au(CN)₂]₂. Crystal structure of 13β: panel (a) shows single diamond-like repeat unit. Panel (b) shows on the left: a single diamond-like network viewed down the b-axis; on the right: all 5 interpenetrated networks. Panel (c) shows a distorted hexagonal 2-D (6,3) network of gold-gold bonded Au(CN)₂⁻ units.

FIGS. 14(a), 14(b) and 14(c) are diagrams of the crystal structure of an γ polymorph of Zn[Au(CN)₂]₂. Crystal structure of 13γ: panel (a) shows single diamond-like repeat unit. Panel (b) shows on the left: single diamond-like framework; on the right: all 4 interpenetrated networks. Panel (c) shows a network of gold-gold bonded Au(CN)₂⁻ units containing dimers of Au(CN)₂⁻ (Au—Au=3.29 Å) connected via longer Au—Au distances of 3.58 Å.

FIG. 15 is a graph showing a difractogram of the γ polymorph of Zn[Au(CN)₂]₂. FIG. 15 shows simulated (lower) and observed (upper) powder difractograms of 13γ. Peaks labelled with * are due to a small (3%) percentage of 13α impurity.

FIGS. 16(a), 16(b), 16(c) and 16(d) are diagrams of the crystal structure of an δ polymorph of Zn[Au(CN)₂]₂. Crystal structure of 13δ: panel (a) shows one herringbone network. Panel (b) shows on the left: side view of herringbone network; on the right: a pair of interwoven herringbone networks. Panel (c) shows on the left: one full 3-D network; on the right: all 3 interpenetrated networks. Panel (d) shows a 1-D chain of gold-gold bonded Au(CN)₂⁻ units.

FIG. 17 is a series of graphs showing excitation spectra for the α, β, and γ polymorphs of Zn[Au(CN)₂]₂.

FIG. 18 is a series of photographs of powder of the α polymorph of Zn[Au(CN)₂]₂ under UV and visible light before and after exposure to ammonia. The powder of 13α is shown on the left under UV and visible light (bottom and top respectively). After exposure to ammonia a yellow compound of {Zn(NH₃)₂[Au(CN)₂]₂} 14 remains (top right) with bright green luminescence (bottom right).

FIGS. 19(a) and 19(b) are graphs showing excitation and emission spectra of (a) {Zn(NH₃)₂[Au(CN)₂]₂} (14) and (b) fully saturated {Zn(NH₃)₄][Au(CN)₂]₂} (15).

FIG. 20 is a graph showing simulated and observed powder difractograms of {Zn(NH₃)₂[Au(CN)₂]₂}. FIG. 20 shows simulated (lower) and observed (upper) powder difractograms of {Zn(NH₃)₂[Au(CN)₂]₂} 14. The 21l reflections are labeled with a *.

FIGS. 21(a) and 21(b) are diagrams of the crystal structure of {Zn(NH₃)₂[Au(CN)₂]₂} (14). Panel (a) shows a corrugated sheet of {Zn(NH₃)₂[Au(CN)₂]₂} 14. Panel (b) shows a side view of stacked sheets in {Zn(NH₃)₂[Au(CN)₂]₂} 14.

FIGS. 22(a) and 22(b) are diagrams of the crystal structure of Ag[Au(CN)₂] as viewed (a) perpendicular to the c-axis, showing the 1-D chains and (b) along the c-axis, showing the hexagonal arrangement of the 1-D chains. These chains are disordered with respect to each other along the c-axis, resulting in layers of randomly distributed Ag(I) and Au(I) centers, as depicted by the distribution of pink (Ag) and gold (Au) atoms. They interact with each other through a combination of Au—Au, Au—Ag and Ag—Ag interactions (not shown) of 3.4514(15) Å. Cu[Au(CN)₂] is isomorphous to this structure, with chains held together by analogous Au—Au interactions of 3.4136(15) Å.

FIG. 23 are photos of emissive Ag[Au(CN)₂] (left) and Cu[Au(CN)₂] (right) at room temperature. Ag[Au(CN)₂] is turquoise and Cu[Au(CN)₂] is orange-red at room temperature.

FIG. 24 is a diagram of the crystal structure of the 1-D zig-zag structure of Cu(py)₂[Au(CN)₂] (H atoms removed for clarity).

FIG. 25 is a diagram of the crystal structure of Cu₃(THT)₄[Au(CN)₂]₃ (20.THT-A; H atoms removed for clarity) showing (a) the coordination environment about Cu1 and Cu2 and the eight-membered ring created via bridging THT molecules (peripheral THT atoms removed for clarity) center, (b) the coordination environment about Cu3 and the S—S interactions of 3.575(3) Å (dashed lines) linking the 1-D ladder superstructures together and (c) one 2-D sheet built up of 1-D [Au(CN)₂]⁻-bridged ladders and S—S interactions in the orthogonal direction.

FIG. 26 is a diagram showing the crystal structure of Cu(THT)[Au(CN)₂] (20.THT-B; H atoms removed for clarity) showing (a) the helical chain structure formed by bridging THT units (Au atoms removed for clarity) and (b) the square-wave chain structure of Cu atoms bridging by [Au(CN)₂]⁻ units (THT molecules removed for clarity).

FIG. 27 is a diagram showing the crystal structure of Cu(dithiane)[Au(CN)₂] (20.dithiane); H atoms removed for clarity).

FIG. 28 is a diagram of the crystal structure of Cu(SMe₂)[Au(CN)₂] (H atoms removed for clarity) showing (a) the tetrahedral Cu(I) centers bridged in a zig-zag fashion by [Au(CN)₂]⁻ and (b) the corrugated chains formed by bridging Me₂S molecules in the orthogonal direction.

FIG. 29 is view of the 3-D framework of Cu(SMe₂)[Au(CN)₂] down the b-axis.

FIG. 30 is a graph showing TGA data for Cu(py)₂[Au(CN)₂] (dashed line) and Cu₃(THT)₄[Au(CN)₂]₃ (solid line).

FIG. 31 are photos of Cu(py)₂[Au(CN)₂], which is turquoise, Cu(PPh₃)[Au(CN)₂], which is turquoise, Cu(THT)[Au(CN)₂], which is purple, and Cu(SMe₂)[Au(CN)₂], which is white, under broad-band UV light.

FIG. 32 are graphs showing excitation (dashed lines) and emission (solid lines) spectra of CuL[Au(CN)₂] (L=dithiane, Et₂S, Me₂S) shown with photos of their emission under broad band UV light (top to bottom: white, aquamarine, blue).

FIG. 33 are graphs showing (left): Excitation (left peak; λₑₘ=506 nm) and emission (right peak; λₑₓ=380 nm) spectra of Cu(py)₂[Au(CN)₂]. (right) Excitation (left peak; λ_{cm}=404 nm) and emission (right peak; λₑₓ=338 nm) spectra of Cu(THT)[Au(CN)₂].

FIG. 34 is a graph showing emission spectrum of the Me₂S adduct of 22 with excitation at 362 nm, exhibiting a single peak at 451 nm.

FIG. 35 is a graph showing emission spectrum of the Et₂S adduct of 22 with excitation at 326 nm, exhibiting a peak at 414 nm and a shoulder at 475 nm.

FIG. 36 is a diagram showing (left): 1-D Pt(II) stacking in Pb[Pt(CN)₄](solvent). (Right): 2-D sheet structure of Pb(H₂O)₂[Pt(CN)₄Br₂].

FIG. 37 is a diagram of the 1-D ladder structure of [ⁿBu₄N]₂[(UO₂)₂(μ²-O₂)(NO₃)₂(μ²-Au(CN)₂]₂ (34)

FIG. 38 is a diagram of (Left) Labelled structure of [UO₂(bipy)(MeO)(MeOH)]₂[(μ²-Au(CN)₂)Au(CN)₂] (36). (Right). 1-D chain structure of 36.

FIG. 39 is a diagram of the 3-D structure of K(UO₂)(μ³-O)₂(NO₃)₂(UO₂)(Au(CN)₂].nMeCN (38) showing the cluster and channels within the network (MeCN solvent removed for clarity).

### DETAILED DESCRIPTION OF THE INVENTION

Throughout the following description specific details are set forth in order to provide a more thorough understanding of the invention. However, the invention may be practiced without these particulars. In other instances, well known elements have not been shown or described in detail to avoid unnecessarily obscuring the present invention. Accordingly, the specification and drawings are to be regarded in an illustrative, rather than a restrictive, sense.

This application relates to vapochromic coordination polymers useful for detection of analytes. In some embodiments the polymers have the general formula M_{W}[M′_{X}(Z)_{Y}]_{N} wherein M and M′ are the same or different metals capable of forming a coordinate complex in conjunction with the Z moiety; Z is selected from the group consisting of halides, pseudohalides, thiolates, alkoxides and amides; W is between 1-6; X and Y are between 1-9; and N is between 1-5. As will be apparent to a person skilled in the art and as described herein, the vapochromic coordination polymers of the invention may also comprise other constituents including ligands, counterbalancing ions and other metals. The invention encompasses coordination polymers comprising units having the same empirical formula as set out above which exhibit vapochromic properties.

As described below, the vapochromism of the polymers may be observed by (1) visible changes, such as changes in colour or luminescence upon exposure to analytes, or by (2) spectroscopic changes, such as changes to the infrared (IR) or Raman spectra. The invention thus provides two means or “channels” to thereby achieve highly sensitive analyte detection. As used in this patent application the term “vapochromic” refers to a material that has a spectroscopic property change upon exposure to a liquid or the vapour of a volatile liquid or gas and the term vapochromism refers to such a spectroscopic property change. The spectroscopic property may include any wavelength of light including microwaves, infrared, visible colour and luminescence. As used in this patent application the process of “detecting chromatic changes” includes detecting a spectroscopic property change, including both visible and non-visible changes resulting from exposure to an analyte.

As exemplified by the examples described below, in some embodiments of the invention M is a transition metal such as copper (Cu) or zinc (Zn) and M′ is a metal such as gold (Au), silver (Ag), mercury (Hg) or copper. The Z moiety may be an ion or anionic ligand. Suitable Z moieties include pseudohalide ions such as CN—. As will be apparent to a person skilled in the art, other suitable pseudohaldides include SCN, SeCN, TeCN, OCN, CNO and NNN. In particular embodiments of the invention Cu[Au(CN)₂]₂ and Zn[Au(CN)₂]₂ polymers are described. The Cu[Au(CN)₂]₂ embodiment takes advantage of the unique chemical properties of gold (I) and copper (II) ions, such as attractive gold-gold interactions and luminescence for gold and a flexible coordination sphere for copper. The attractive interactions enable the formation of chemically stable, high-dimensionality materials and the gold-luminescence, cyanide-IR and copper(II) visible spectrum can all act as simultaneous sensory outputs. Similarly, with respect to the Zn[Au(CN)₂]₂ embodiment, distinctive luminescence and other photochromic qualities are exhibited.

In other embodiments of the invention the metal M may be a 1^{st} row transition metal other than Cu or Zn, such as Sc, Ti, V, Cr, Mn, Fe, Co, or Ni, or some other transition-metal such as Zr, Nb or Ru. M may also be a lanthanide. Although the Mn (water)⁷³, Fe (with K-salt)⁷³, Co (none, with K-salt^{74,75}, and DMF⁷⁶), Zn (none)⁷⁷ and a few lanthanides (Gd, Eu, Yb—all with no ligands)^{78,79-81} complexes are known in the prior art (ligands shown in brackets), no sensor or vapochromic properties for such complexes have been previously described.

Optionally, an organic ligand may be bound to M. The ligand may be any ligand capable of capping the metal cation, and may include nitrogen, oxygen, sulfur or phosphorus donors.

Depending upon the resultant charge of the M_{W}[M′_{X}(Z)_{Y}]_{N} structure, a charge-balancing ion, either a cation or anion, may also be present. For example, a charge balancing ion may be required where M′ is Hg.

In alternative embodiments of the invention the metal M′ may be selected to produce both linear metal cyanides or non-linear cyanides. For example, cyanometallate units such as [Au(CN)₂]⁻, [Ag(CN)₂]⁻ or [Hg(CN)₂] may be incorporated into polymers in conjunction with different transition metal cations and supporting ligands according to the following general equation:^{82-84,85-90}

[METAL cation+organic ligand_{z}]ⁿ⁺+[M′(CN)ₓ]_{y}→[METAL(ligand)_{z}][M′(CN)ₓ]ₙ
(n=1-5, x=2-9, y=−5 to 0, z=0-9)

The synthesis may be readily accomplished in solvents such as water or alcohols. Compared to prior art approaches, the polymers and polymer-analyte compositions of the present invention can be prepared from extremely simple commercially available starting materials in minimal steps. As described in the Examples section below, the synthetic methodology, which has built-in design flexibility, low-cost and simple synthesis, is also a general advantage of coordination polymer systems over current zeolitic technology. The system is modular in that the metal cation and organic ligand can be chosen as desired to target a particular application or property.

An important advantage of embodiments of the invention described herein is that the vapochromic properties of the polymers may be reversible. For example, the Cu[Au(CN)₂]₂ embodiment shows reversible vapochromic sensor behaviour attributable to the Cu—Au pairing.²⁷ Starting with a solid of any Cu[Au(CN)₂]₂(solvent)ₓ, addition of a different solvent vapour (analytes) generates a new complex. As described below, exceptions may apply in the case of very strong donor solvents such as pyridine or ammonia, which bind strongly to the Cu^{II} center and are not easily displaced by other solvents. Similarly, the Zn[Au(CN)₂]₂ embodiment exhibits reversible vapoluminescent material qualities.⁹¹ The polymers of the invention may thus be employed in a dynamic system for successively detecting different analytes without the need for reinitialization (although reinitialization may still be required to repeatedly detect the same analyte).

The invention may be used for detecting a wide variety of analytes including volatile organic compounds (VOCs) and gases. The solid polymers adsorb (i.e. bind or trap) analyte, such as organic solvents, exposed to the polymers in a vapour (or liquid) phase. By way of example, the polymer may be suspended in a liquid solution containing the analyte, such as an aqueous or hydrocarbon solution. The detectable VOCs typically include a hetero (non-carbon) atom donor such as hydrogen, nitrogen, oxygen, sulfur, phosphorus and selenium donors. Examples of solvent vapours that will effectively adsorb to the polymers of the invention include pyridine, dioxane, water, ethanethiol and trimethylphosphine. Donor gases such as H₂S and ammonia also readily bind and are detectable. The binding capacity and sensitivity of the polymers may be adjusted through altering the identity of the metals M and M′ to enable detection of a range of gases, including but not limited to NOₓ, SOₓ, COₓ, alkenes and halogens. For example, the zinc-based polymer described herein appears to bind CO₂ and may have applications as a CO₂-sensor. By way of another example, the cyanoplatinate (II) embodiment described herein is useful as a reversible sensor for halogens, including chlorine.

In some embodiments M and/or M′ may be present in a (I) rather than (II) oxidative state. Ag(I)- and Cu(I)-containing materials have been extensively studied due to their luminescent properties^{24,25,92-105} especially toward the development of VOC sensors. Thus, while the Cu(II)-containing compounds such as Cu(OH₂)₂[Au(CN)₂]₂²⁷ are vapochromic but not emissive, Cu(I)-containing materials are frequently luminescent due to Cu-based charge transfer bands,^{24,25,106-108} and this luminescence is very sensitive to the coordination environment about the Cu(I) centre. A well-studied example is the reaction of CuCN with a variety of analytes with donor atoms.^{24,25,92} While CuCN itself emits a low intensity blue light, this colour changes dramatically on exposure to select VOCs, e.g., to bright green with 2-methylpyridine and to bright yellow with N-methylpiperidine.²⁵ In addition to being a sensitive emitter, Cu(I), since it is relatively “soft,” more readily binds ligands with softer S- and P-donors,^{102,109,110} an ability that the relatively “harder” Cu(II)-containing material Cu(OH₂)₂[Au(CN)₂]₂ lacks. This enables polymers having a Cu(I) centre to detect a wider range of potential analytes, such as Me₂S and H₂S.

In alternative embodiments the vapochromic coordination polymers may have the general formula Mₓ[M′_{y}M″_{2-x-y}(Z)₂] wherein M, M′ and M″ are the same or different metals selected from the group consisting of Au, Ag, Cu and Tl; Z is selected from the group consisting of halides, pseudohalides, thiolates, alkoxides and amides; and X and Y are each between 0 and 1. As will be apparent to a person skilled in the art and as described herein, the vapochromic polymers of these embodiments may also comprise other constituents including ligands, counterbalancing ions and other metals. The invention encompasses polymers comprising units having the same empirical formula as set out above which exhibit vapochromic properties.

In particular embodiments Y=2-X, i.e. M″ is omitted, and X and Y are non-integers. That is, M and M′ may be different metals present in a modified stoichiometry, such as where some of the M′ sites are substituted by M. For example, in some particular embodiments M is Cu, M′ is Au, and Z=CN. In a particular example of a “blended” polymer having modified stoichiometry the molar ratio of Cu:Au may be altered such that one third of the Au sites have been substituted by Cu.

In further alternative embodiments the vapochromic coordination polymers may be described by the general formula M[M′(Z)₄] wherein M is a metal; M′ is Pt; and Z is selected from the group consisting of halides, pseudohalides, thiolates, alkoxides and amides. In some particular embodiments M is Pb, Z is CN and the polymer is adapted for reversibly sensing halogens such as chlorine, resulting in the product Pb[Pt(CN)₄(X)₂] where X is Cl or for reversibly sensing H₂S. As in the other embodiments, the vapochromic coordination polymers of this formula may also comprise other constituents including ligands, counterbalancing ions and other metals. The invention encompasses polymers comprising units having the same empirical formula as set out above which exhibit vapochromic properties.

As will be appreciated by a person skilled in the art, the polymers of the invention may find application in wide range of industrial and commercial applications, such as in the chemical, energy and environmental sectors. The polymers may be used in many different solid forms depending upon the vapochromic application, such as powders, crystals, thin films or combinations thereof. Exemplary industrial applications include: personal and badge monitors in chemical laboratories (e.g. industrial chemical or pharmaceutical research laboratories, paint and coatings manufacturing, cosmetics manufacturing) for hazardous vapour detection; portable or stationary threshold monitors for chemical vapours in laboratory environments or chemical storage facilities for hazardous vapour detection or regulated emission requirements; environmental sensor for volatile organic compounds or gases (“electronic noses”) for use at environmental remediation sites, landfills, air-quality monitoring etc.; and responsive coatings, art supplies, colour-changing paint and other related applications where a colour-changing material is desired.

As will be apparent to a person skilled in the art, the vapochromic polymers described herein may be deployed in various different forms and applications for specifically detecting ammonia. For example, the polymers may be used in medical applications for sensing ammonia in the breath of patients. In one embodiment, a polymer may be embedded in a paper strip, similar to litmus paper, or onto a binding agent such as silica, which a patient would be instructed to breathe on. Many medical conditions, such as ulcers, kidney disease and liver disease, are associated with abnormally high (but still low in an absolute sense) levels of ammonia in the breath of some affected patients. Many other potential applications for detecting low levels of ammonia may also be envisioned.

Although the present invention has been principally described in relation to analyte sensing and detection, the polymers and compositions described herein may be useful for other purposes such as extraction, purification and storage applications.

### EXAMPLES

The following examples will further illustrate embodiments of the invention in greater detail although it will be appreciated that the invention is not limited to the specific examples.

The following description of experimental details and experimental results is presented in multiple parts. Example 1.0 describes synthetic procedures and experimental results for the Cu[Au(CN)₂]₂(solvent)ₓ system. Example 2.0 describes a similar synthetic procedure and experimental results for an analogous Zn[Au(CN)₂]₂(solvent)ₓ system. Example 3.0 describes further Cu-based polymers based on a different oxidative state of copper, i.e. Cu(I) rather than Cu(II). In particular, Cu(I) cyanoaurate (I) materials useful as sensors are described. Example 4.0 describes a Pb(II) cyanoplatinate (II) polymer for sensing halogens, including chlorine, and for sensing H₂S. Example 5.0 describes uranyl (UO₂²⁺)-based cyanoaurate materials useful as sensors for 0-donors such as aldehydes. Example 6.0 describes vapochromic sensors comprising polymers having the general formula M_{W}[M′_{X}(Z)_{Y}(Z′)_{O}]_{N}, for example Pb[Pt(CN)₄(x)₂]. Example 7.0 describes mercury-based polymers.

### Example 1.0

### Cu-Based Polymers

1.1 Cu[Au(CN)₂]₂(solvent)ₓ System

### 1.1.1 Experimental Apparatus and General Procedure

General Procedure and Physical Measurements.

All manipulations were performed in air. All the reagents were obtained from commercial sources and used as received Infrared spectra were recorded as KBr pressed pellets on a Thermo Nicolet Nexus 670 FT-IR spectrometer. Microanalyses (C, H, N) were performed at Simon Fraser University. Magnetic susceptibilities were measured on polycrystalline samples at 1 T between 2 and 300 K using a Quantum Design MPMS-5S SQUID magnetometer. All data were corrected for temperature independent paramagnetism (TIP), the diamagnetism of the sample holder, and the constituent atoms (by use of Pascal constants).¹¹¹ Solid-state UV-visible reflectance spectra were measured using an Ocean Optics SD2000 spectrophotometer equipped with a tungsten halogen lamp. Thermogravimetric analysis (TGA) data were collected using a Shimadzu TGA-50 instrument in an air atmosphere.

### 1.1.2 Synthetic Procedures

Synthesis of Cu[Au(CN)₂]₂(DMSO)₂, 1:

A 0.5 mL dimethylsulfoxide (DMSO) solution of Cu(ClO₄)₂.6H₂O (0.037 g, 0.1 mmol) was added to a 0.5 mL DMSO solution of KAu(CN)₂ (0.057 g, 0.2 mmol). Green crystals of Cu[Au(CN)₂]₂(DMSO)₂ were obtained by slow evaporation over several days, filtered and air-dried. Yield: 0.050 g, 70%. Anal. Calcd. for C₈H₁₂N₄Au₂CuO₂S₂: C, 13.39; H, 1.69; N, 7.81. Found: C, 13.43; H, 1.72; N, 7.61. IR (KBr): 3005(w), 2915(w), 2184(s), 2151(m), 1630(w), 1426(w), 1408(w), 1321(w), 1031(m), 993(s), 967(m), 720(w), 473(m) cm⁻¹. The same product can be obtained by absorption of DMSO by Cu[Au(CN)₂]₂(H₂O)₂.

Synthesis of Cu[Au(CN)₂]₂(DMSO)₂, 2:

A 0.2 mL DMSO solution of Cu(ClO₄)₂.6H₂O (0.037 g, 0.1 mmol) was added to a 0.4 mL DMSO solution of KAu(CN)₂ (0.057 g, 0.2 mmol). Blue needles of Cu[Au(CN)₂]₂(DMSO)₂ formed after one hour and were filtered and dried under N₂. Yield: 0.057 g, 80%. Anal. Calcd. for C₈H₁₂N₄Au₂CuO₂S₂: C, 13.39; H, 1.69; N, 7.81. Found: C, 13.50; H, 1.76; N, 7.62. IR (KBr): 3010(w), 2918(w), 2206(m), 2194(s), 2176(m), 2162(m), 1631(w), 1407(w), 1316(w), 1299(w), 1022(m), 991(s), 953(m), 716(w), 458(m) cm⁻¹.

Synthesis of Cu[Au(CN)₂]₂(DMF), 3:

A 2 mL N,N-dimethylformamide (DMF) solution of Cu(ClO₄)₂.6H₂O (0.037 g, 0.1 mmol) was prepared. This solution was added to a 3 mL DMF solution of KAu(CN)₂ (0.057 g, 0.2 mmol). A dark blue-green mixture of powder and crystals of Cu[Au(CN)₂]₂(DMF) was obtained after several days of slow evaporation and was filtered and air-dried. Yield: 0.033 g, 52%. Anal. Calcd for C₇H₇N₅Au₂CuO: C, 13.25; H, 1.11; N, 11.04. Found: C, 13.26; H, 1.11; N, 11.30. IR (KBr): 2927(w), 2871(w), 2199(s), 2171(shoulder), 1665(s), 1660(s), 1492(w), 1434(w), 1414(w), 1384(m), 1251(w), 1105(w), 674(w), 516(w), 408(w) cm⁻¹. Single crystals of 3 were obtained by dissolving Cu[Au(CN)₂]₂(H₂O)₂ (5) in DMF and allowing the solution to evaporate very slowly. The single crystals and the crystal/powder mixture as prepared above had identical IR spectra. The same product can also be obtained by vapour absorption of DMF by several Cu[Au(CN)₂]₂(solvent)ₓ complexes.

Synthesis of Cu[Au(CN)₂]₂(pyridine)₂, 4:

A 10 mL pyridine/water/methanol (5:47.5:47.5) solution of Cu(ClO₄)₂.6H₂O (0.111 g, 0.3 mmol) was prepared. This solution was added to a 10 mL pyridine/water/methanol (5:47.5:47.5) solution of KAu(CN)₂ (0.171 g, 0.59 mmol). A blue powder of Cu[Au(CN)₂]₂(pyridine)₂ was obtained immediately and was filtered and air-dried. Yield: 0.163 g, 75%. Anal. Calcd for C₁₄H₁₀N₆Au₂Cu: C, 23.36; H, 1.40; N, 11.68. Found: C, 23.52; H, 1.44; N, 11.58. IR (KBr): 3116(w), 3080(w), 2179(s), 2167(s), 2152(s), 2144(m), 1607(m), 1449(m), 1445(s), 1214(m), 1160(w), 1071(m), 1044(w), 1019(m), 758(s), 690(s), 642(m) cm⁻¹. Single crystals of 4 were obtained by slow evaporation of the remaining solution. The crystals and powder had identical IR spectra. The same product can also be obtained by vapour absorption of pyridine by several Cu[Au(CN)₂]₂(solvent)ₓ complexes.

Synthesis of Cu[Au(CN)₂]₂(H₂O)₂, 5:

A 10 mL aqueous solution of Cu(ClO₄)₂.6H₂O (0.259 g, 0.7 mmol) was prepared and added to a 10 mL aqueous solution of KAu(CN)₂ (0.403 g, 1.4 mmol). A pale green powder of Cu[Au(CN)₂]₂(H₂O)₂ formed immediately and was filtered and air-dried. Yield: 0.380 g, 91%. The same product can be obtained by vapour absorption of water by several Cu[Au(CN)₂]₂(solvent)ₓ complexes. Anal. Calcd for C₄H₄N₄Au₂CuO₂: C, 8.04; H, 0.67; N, 9.38. Found: C, 8.18; H, 0.71; N, 9.22. IR (KBr): 3246(m), 2217(s), 2194(vw), 2171(s), 1633(w) cm⁻¹.

Synthesis of Cu[Au(CN)₂]₂, 6:

Cu[Au(CN)₂]₂(H₂O)₂ was heated (150° C.) in vacuo to yield green-brown Cu[Au(CN)₂]₂. The yield is quantitative, with no ν_{CN} peaks for hydrated 5 observable. Anal. Calcd for C₄N₄Au₂Cu: C, 8.56; H, 0; N, 9.98. Found: C, 8.68; H, trace, N, 9.80. IR (KBr): 2191(s), 1613(vw), 530(m) cm⁻¹.

Synthesis of Cu[Au(CN)₂]₂(CH₃CN)₂, 7:

A 1 mL CH₃CN solution of Cu(ClO₄)₂.6H₂O (0.037 g, 0.1 mmol) was prepared and added to a 2 mL CH₃CN solution of KAu(CN)₂ (0.057 g, 0.2 mmol). A green powder of Cu[Au(CN)₂]₂(CH₃CN)₂ precipitated immediately along with a white powder of KClO₄. To prevent the replacement of CH₃CN by atmospheric water, the solvent was removed under vacuum and the KClO₄ side product was not removed through washing and filtering. Anal. Calcd for Cu[Au(CN)₂]₂(CH₃CN)₂+2(KClO₄) (C₈H₆N₆Au₂Cl₂CuK₂O₈): C, 10.44; H, 0.65; N, 9.12. Found: C, 10.99; H, 0.57; N, 8.69. IR (KBr): 2297(w), 2269(w), 2192(s), 1600(w), 1445(w), 1369(w), 1088(s), 941(w), 925(w), 752(w), 695(w), 626(m), 512(w), 468(w), 419(w) cm⁻¹. The same product (without KClO₄) can be obtained by vapour absorption of acetonitrile by Cu[Au(CN)₂]₂(DMSO)₂ (1 or 2).

Synthesis of Cu[Au(CN)₂]₂(dioxane)(H₂O), 8:

A 2 mL dioxane/water (2:1) solution of Cu(ClO₄)₂.6H₂O (0.037 g, 0.1 mmol) was prepared. This solution was added to a 4 mL dioxane/water (2:1) solution of KAu(CN)₂ (0.057 g, 0.2 mmol). A pale blue-green powder of Cu[Au(CN)₂]₂(dioxane)(H₂O) was obtained immediately and was filtered and air-dried. Yield: 0.057 g, 85%. The same product can be obtained by vapour absorption of dioxane by several Cu[Au(CN)₂]₂(solvent)ₓ complexes (the water molecule included in this case is from ambient moisture). Anal. Calcd for C₈H₁₀N₄Au₂CuO₃: C, 14.39; H, 1.51; N, 8.39. Found: C, 14.31; H, 1.21; N, 8.43. IR (KBr): 2976(m), 2917(m), 2890(w), 2862(m), 2752(w), 2695(w), 2201(s), 2172(w), 1451(m), 1367(m), 1293(w), 1255(s), 1115(s), 1081(s), 1043(m), 949(w), 892(m), 871(s), 705(w), 610(m), 515(m), 428(m) cm⁻¹.

Synthesis of Cu[Au(CN)₂]₂(NH₃)₄, 9:

This product was obtained by vapour absorption of NH₃ by several Cu[Au(CN)₂]₂(solvent)ₓ complexes. The yield is quantitative as shown by IR. Anal. Calcd for C₄H₁₂N₈Au₂Cu: C, 7.63; H, 1.92; N, 17.80. found: C, 7.56; H, 1.98; N, 17.71. IR (KBr): 3359(s), 3328(s), 3271(s), 3212(m), 3182(m), 2175(m), 2148(s), 1639(m), 1606(m), 1243(s), 685(s), 435(w) cm⁻¹.

### 1.1.3 X-Ray Crystallographic Analysis

X-Ray Crystallographic Analysis. Cu[Au(CN)₂]₂(DMSO)₂ 1 and 2, Cu[Au(CN)₂]₂(DMF) 3 and Cu[Au(CN)₂]₂(pyridine)₂ 4:

Crystallographic data for all structures are collected in Table 1. Crystals 1, 3 and 4 were mounted on glass fibers using epoxy adhesive and crystal 2 was sealed in a glass capillary. Crystal 1 was a green rectangular plate (0.09×0.12×0 3 mm³), crystal 2 was a pale blue needle (0.11×0.11×0.2 mm³), crystal 3 was a green needle (0.09×0.09×0.15 mm³) and crystal 4 was a dark blue platelet (0.02×0.06×0.15 mm³).

For 1, data in the range 4°<2θ<55° were recorded using the diffractometer control program DIFRAC¹¹² and an Enraf Nonius CAD4F diffractometer. The NRCVAX Crystal Structure System was used to perform psi-scan absorption correction (transmission range: 0.0301-0.1726) and data reduction, including Lorentz and polarization corrections.¹¹³ All non-hydrogen atoms were refined anisotropically. Full matrix least-squares refinement (1231 reflections included) on F (93 parameters) converged to R₁=0.042, wR₂=0.047 (Iₒ>2.5σ(Iₒ)).

For 2, 3 and 4, data in the ranges 6.9°<2θ<136.1°, 9.2°<2θ<144.0° and 12.0°<2θ<142.6° respectively were recorded on a Rigaku RAMS RAPID imaging plate area detector. A numerical absorption correction was applied (transmission range: 0.019-0.161, 0.0070-0.0199 and 0.3484-0.5826) and the data were corrected for Lorentz and polarization effects.¹¹⁴ For 2, the Au, Cu and S atoms were refined anisotropicaliy, while the remainders were refined isotropically. For 3 and 4, all non-hydrogen atoms were refined anisotropically. Full matrix least-squares refinement on F was performed on 2, 3 and 4, the data converging to the following results: for 2, R, =0.062, wR₂=0.082 (Iₒ>3.0σ(Iₒ), 2026 reflections included, 205 parameters); for 3, R₁=0.0315, wR₂=0.0456 (Iₒ>3.0σ(Iₒ), 1538 reflections included, 148 parameters); for 4, R, =0.0276, wR₂=0.0401 (Iₒ>3.0σ(Iₒ), 1021 reflections included, 107 parameters).

All structures were refined using CRYSTALS.¹¹⁵ The structures were solved using Sir 92 and expanded using Fourier techniques. Hydrogen atoms were included geometrically in all structures but not refined. Diagrams were made using Ortep-3 (version 1.076)¹¹⁶ and POV-Ray (version 3.6.0)¹¹⁷. Selected bond length and angles for 1-4 are reported in Tables 2 to 5 respectively.

### 1.1.4 Results

Synthesis.

The reaction of Cu^{II} salts with KAu(CN)₂ in dimethylsulfoxide (DMSO) produced two different compounds, depending on the total concentration of starting reagents. In dilute solution, green crystals of polymorph 1 formed slowly, whereas blue crystals of polymorph 2 were obtained rapidly in a highly concentrated solution. The IR spectra of 1 and 2 show different features (Table 6); the higher-energy bands likely correspond to bridging CN-groups, while the lower-energy bands are due to either free or loosely bound CN-groups.¹¹⁸ The X-ray crystal structures of 1 and 2 revealed two different polymeric networks, both with the same empirical formula Cu[Au(CN)₂]₂(DMSO)₂, as confirmed by elemental analysis.

Crystal Structure of the Green Cu[Au(CN)₂]₂(DMSO)₂ Polymorph, 1.

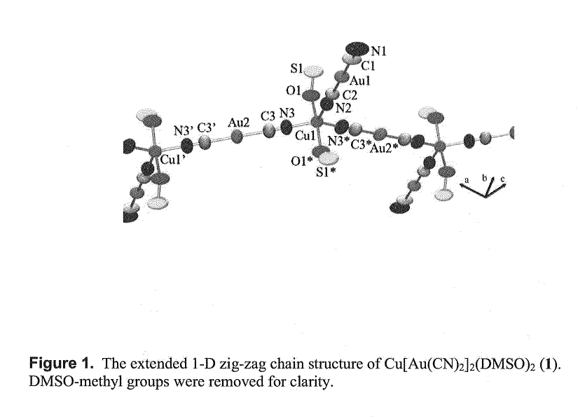

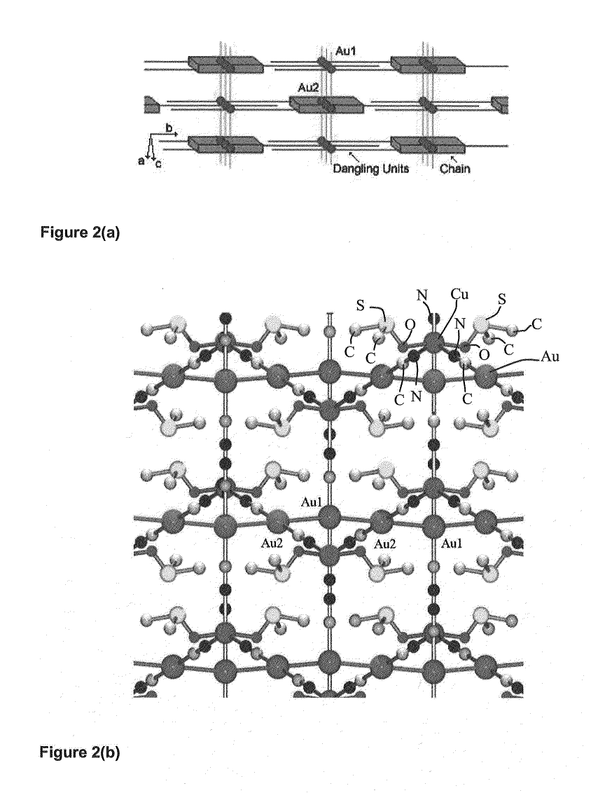

The five-coordinate Cu^{II} center in 1 has a τ-value¹¹⁹ of 0.44, where τ=0 is pure square pyramidal and τ=1 is pure trigonal bipyramidal, suggesting that the coordination geometry could be considered equally distorted from either polyhedron. The Cu^{II} center is bound to two DMSO-O atoms (O—Cu—O=167.06°) and three N(cyano) atoms (FIG. 1). Selected bond lengths and angles for 1 are listed in Table 2. The asymmetric unit contains two different [Au(CN)₂]⁻ units: a Cu^{II}-bridging moiety that generates a 1-D chain, and a Cu^{II}-bound dangling group. The chains stack on top of each other parallel to the (101)-plane, forming stacks of chains that are offset to allow interdigitation of the dangling [Au(CN)₂]⁻ units. Each chain is connected to the four neighbouring chains through Au—Au interactions of 3.22007(5) Å between the Au(1) atoms of each dangling group and the Au(2) atoms of the chain backbone (FIG. 2 (a)). The DMSO molecules occupy the channels between the chains; these channels are delineated by both [Au(CN)₂] groups and Au—Au bonds (FIG. 2(b)). A viable Au—Au interaction is considered to exist when the distance between the two atoms is less than 3.6 Å, the sum of the van der Waals radii for gold.¹²⁰

Crystal Structure of the Blue Cu[Au(CN)₂]₂(DMSO)₂ Polymorph, 2.

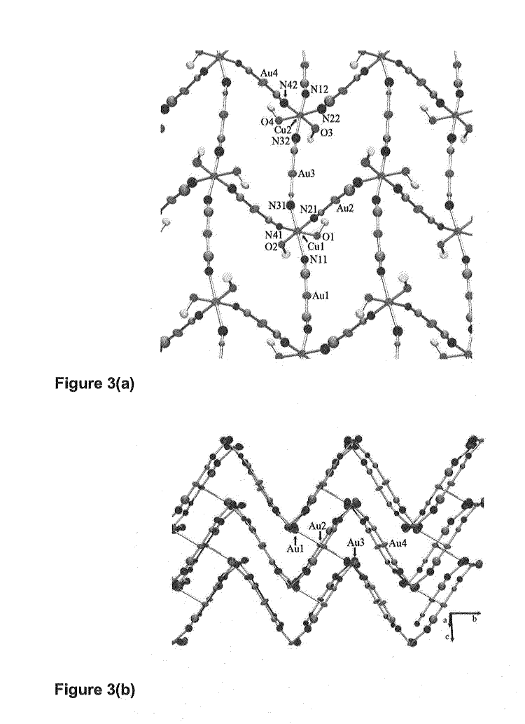

The structure of polymorph 2 contains Cu^{II} centers in a Jahn-Teller distorted octahedral geometry, with the two DMSO molecules bound in a cis-equatorial fashion (O—Cu—O=95.2°) rather than in the nearly 180°-arrangement in 1. Selected bond lengths and angles for 2 are found in Table 3. The four remaining sites (two axial and two equatorial) are occupied by N(cyano) atoms of bridging [Au(CN)₂]⁻ units, generating corrugated 2-D sheets (FIG. 3(a)). These 2-D layers stack (FIG. 3(b)) and are held together by weak Au(1)-Au(2) interactions of 3.419(3) Å and perhaps weak Au(3) . . . Au(4) contacts of 3.592(4) Å. Thus, the colour difference between the two polymorphs can be attributed to the different coordination number and geometry around the Cu^{II} centers. That said, the coarse features of 1, namely the rectangular “channels” filled with DMSO molecules, are also clearly delineated in 2.

Magnetic Properties.

As polymorphs 1 and 2 clearly have significantly different solid-state structures, it follows that their physical and chemical properties may also vary; this is obviously the case for their solid-state optical reflectance spectra, which show λₘₐₓ of 550±7 and 535±15 nm respectively (Table 6). To explore this key issue, a series of representative properties were investigated. For example, the magnetic susceptibilities of 1 and 2 were measured at temperatures varying from 300 to 2 K. At 300 K, μ_{eff}=1.98 and 1.93 μ_{B} for 1 and 2 respectively, typical for Cu^{II} centers.¹²¹ As the temperature drops, μ_{eff} decreases and reaches 1.74 and 1.67 μ_{B} at 2 K for 1 and 2 respectively. There is no maximum in either χ_{M} vs T plot. This behaviour is consistent with weak antiferromagnetic coupling, probably mediated by the diamagnetic Au^{I} center.^{82-84,122} Thus, the two polymorphs have similar magnetic properties.

Thermal Stability.

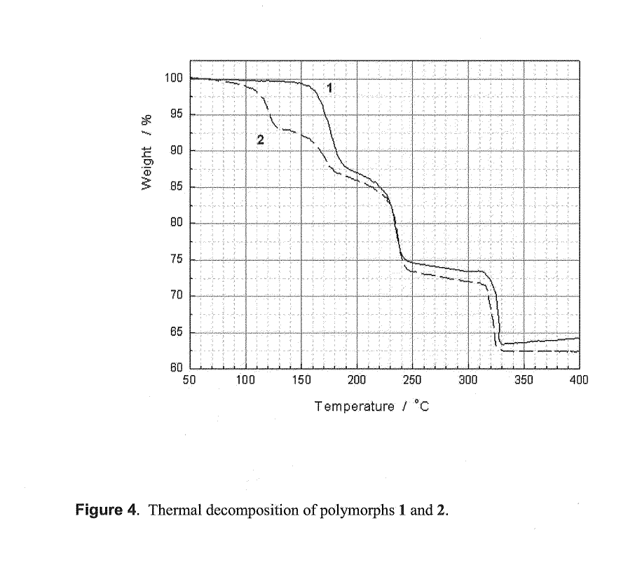

Examining the thermal stabilities of 1 and 2 by thermogravimetric analysis (FIG. 4), 1 loses its first DMSO molecule from 150-190° C. and the other one from 210-250° C. For polymorph 2 (which has 4 crystallographically distinct DMSO molecules), the first two DMSO molecules are lost between 100-135° C. and then 150-190° C., while the two remaining DMSO molecules dissociate around 210-250° C., comparable with 1. Both polymorphs are then stable until ˜310° C., at which point cyanogen (C₂N₂) is released, consistent with the decomposition of the Cu[Au(CN)₂]₂ framework.¹²³ Hence, the thermal stabilities of the two polymorphs with respect to the loss of the first DMSO molecules are significantly different. Differential scanning calorimetry shows no evidence for the thermal interconversion in the solid state from 2 to 1 below the decomposition temperature of 2.

Vapochromic Behavior.

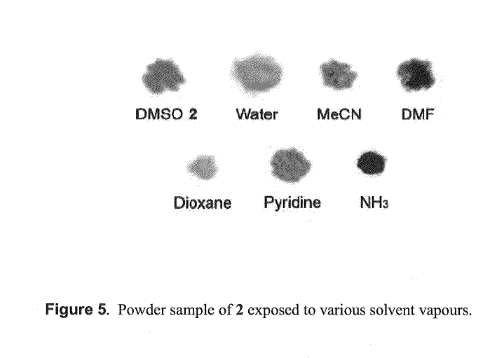

Interestingly, even though both polymorphs are thermally stable up to at least 100° C., the DMSO molecules can easily be replaced by ambient water vapour at room temperature to yield Cu[Au(CN)₂]₂(H₂O)₂ (5), as shown by elemental and thermogravimetric analysis. Despite the fact that both polymorphs have different solid-state structures, IR spectroscopy and powder X-ray diffraction show that both polymorphs convert to the same Cu[Au(CN)₂]₂(H₂O)₂ (5) complex (Table 6). This conversion is reversible. However, if DMSO vapour is added back to 5, only the green polymorph Cu[Au(CN)₂]₂(DMSO)₂ (1) is formed, even if the original DMSO-complex to which H₂O was added was the blue polymorph (2). The exchange of DMSO for H₂O can be observed visually from the associated colour change (FIG. 5).

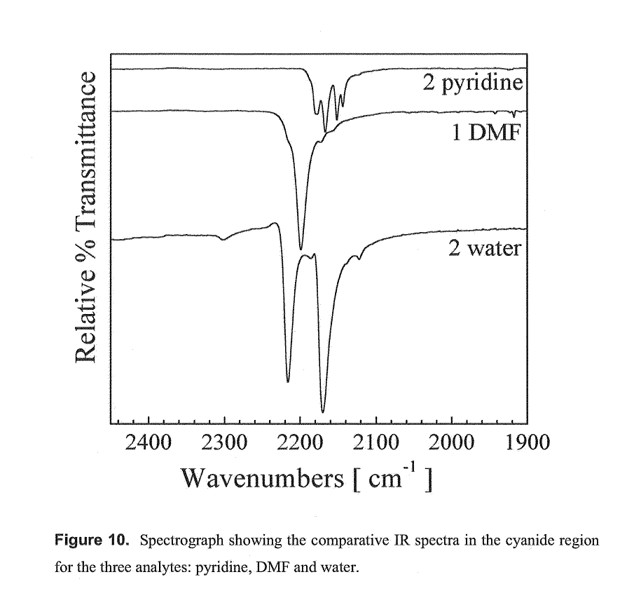

Cu[Au(CN)₂]₂(DMSO)₂ (either 1 or 2) also displays vapochromic behaviour when exposed to a variety of other donor solvent vapours (i e analytes) in addition to H₂O. Each Cu[Au(CN)₂]₂(solvent)ₓ complex can be distinguished easily by its colour (FIG. 5 and Table 6). In addition, the ν_{CN} region of the IR spectrum for each solvent complex is a characteristic, sensitive signature for that solvent (Table 6). FIG. 10 is a spectrograph showing the comparative IR spectra in the cyanide region for three solvents (i.e. analytes), namely pyridine, DMF and water using the Cu[Au(CN)₂]₂(solvent)ₓ polymer. FIG. 10 show graphically the characteristic, sensitive signature for each solvent in the ν_{CN} region of the IR spectrum. Thus both the visible colour changes and the cyanide-IR changes are dramatic and distinctive for each analyte, allowing for more specific and sensitive analyte detection.

Importantly, this solvent exchange is completely reversible, thus permitting dynamic solvent sensing. As indicated in the above synthetic examples, starting with a solid of Cu[Au(CN)₂]₂(solvent)ₓ, addition of a different solvent vapour generates a new complex. The only exceptions occur in the case of very strong donor solvents such as pyridine or ammonia, which bind strongly to the Cu^{II} center and are not easily displaced by other solvents.

Each Cu[Au(CN)₂]₂(solvent)ₓ complex was also synthesized by reacting Cu(II) salts with [Au(CN)₂]⁻in the appropriate solvent and each was found, by elemental analysis, IR spectroscopy, TGA, and crystallography, to be identical to the complex generated by solvent exchange. In every case, elemental analysis and TGA (Table 7) indicate that the number of solvent molecules incorporated into the complex per transition metal center is always the same as the number incorporated by vapour adsorption. This is easily rationalized by the fact that all adsorbed solvent molecules are ligated to the Cu^{II} center in a 1:1, 1:2 or, in the case of ammonia, a 1:4 ratio, with no additional loosely trapped solvent molecules in channels (as shown by TGA, Table 7), as is often observed in other porous systems that include solvent.¹²⁴⁻¹²⁷

Crystal Structure of Cu[Au(CN)₂]₂(DMF), 3.

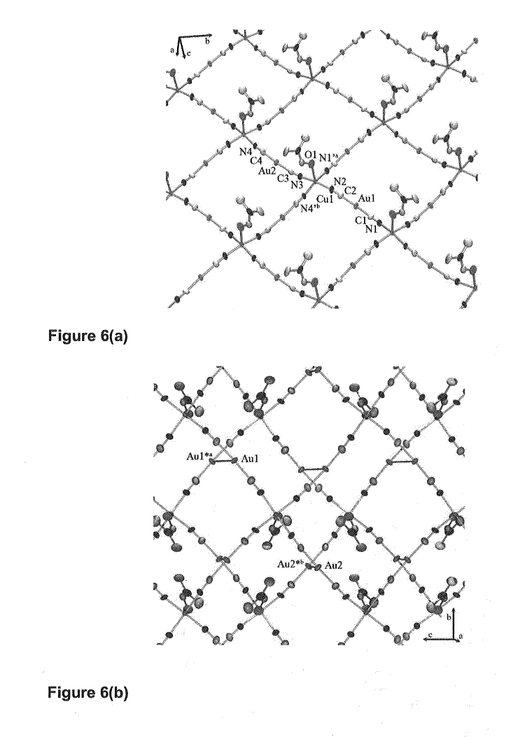

In order to better understand the structural changes that occur during a vapochromic response of the DMSO polymorphs, the structures of Cu[Au(CN)₂]₂(DMF) (3) and Cu[Au(CN)₂]₂(pyridine)₂ (4) were investigated. The structure of 3 contains Cu^{II} centers with a square-pyramidal geometry, where the four basal sites are occupied by N(cyano) atoms of bridging [Au(CN)₂]⁻units and the apical site is occupied by an O-bound DMF molecule. Selected bond lengths and angles for 3 are listed in Table 4. The alternation of Cu^{II} centers and [Au(CN)₂]⁻units generates a 2-D square grid motif with all the DMF molecules pointing either above or below the plane of the sheet (FIG. 6(a)). This grid is similar to that observed in the blue Cu[Au(CN)₂]₂(DMSO)₂ complex (2) if one DMSO molecule was removed and the corrugation reduced. The layers stack on top of each other in an offset fashion, thereby disrupting any channels, and are held together by Au(1)-Au(1*^{a}) and Au(2)-Au(2*^{b}) interactions of 3.3050(12) Å and 3.1335(13) Å (FIG. 6(b)).

Crystal Structure of Cu[Au(CN)₂]₂(pyridine)₂, 4.

The structure of 4 is similar to that of 3, except that the Cu^{II} centers are surrounded by two solvent molecules, generating octahedrally coordinated metals. The axial sites and two of the equatorial sites are occupied by N(cyano) atoms of bridging [Au(CN)₂]⁻units. Pyridine molecules occupy the two other equatorial sites. Selected bond lengths and angles for 4 are listed in Table 5. As observed for 3, infinite 2-D layers are obtained (FIGS. 7(a) and (b)). No aurophilic interactions are present between the Au atoms of neighboring sheets, but π-π interactions of ˜3.4 Å are found between stacked pyridine rings of adjoining sheets. Thus, the square-grid array present in 2 and 3 is maintained but in this case the sheets are completely flat, as opposed to the corrugated array found in 2. The 180° disposition of the pyridine rings (vs. the cis orientation of the DMSO molecules in 2) also serves to separate the sheets, disrupting potential intersheet Au—Au interactions.

Solvent Free Cu[Au(CN)₂]₂, 6.

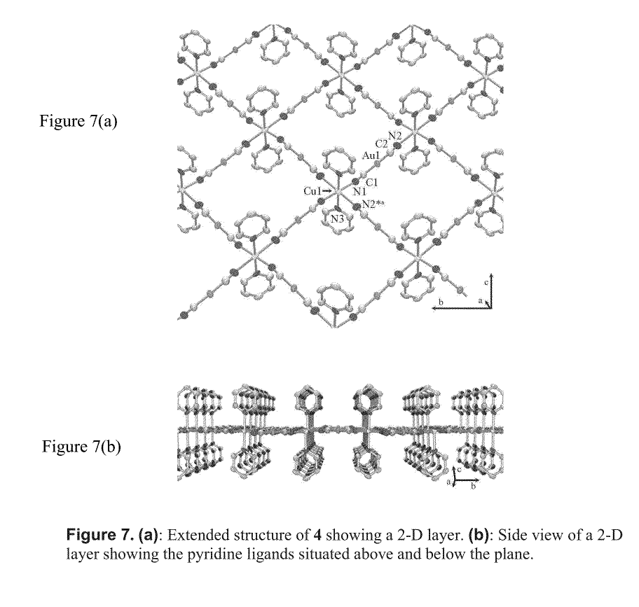

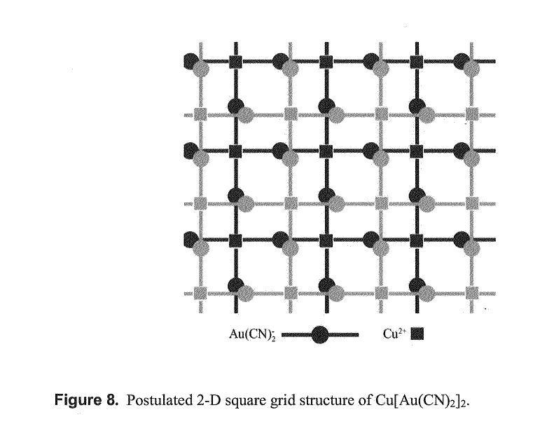

The green-brown solvent-free complex, Cu[Au(CN)₂]₂ (6), was also prepared by thermally removing in vacuo the water molecules from 5. Changes in the powder X-ray diffractogram and in the ν_{CN} peaks of 6 indicate that some rearrangement in the framework occurred. The IR spectrum only shows one stretching frequency (2191 cm⁻¹), indicating that all CN groups are in a similar environment, reminiscent of the Cu[Au(CN)₂]₂(DMF) structure. This is also comparable with the results published for the Mn[Au(CN)_{2]2}(H₂O)₂¹⁶ and the Co[Au(CN)₂]₂(DMF)₂¹⁹ systems (which show stretches at 2150 and 2179 cm⁻¹ respectively). In these two coordination polymers, the M[Au(CN)₂]₂ unit (M=Mn or Co) forms 2-D square grids, with solvent molecules hanging above and below the plane of the sheet. Although the three-dimensional topology of Cu[Au(CN)₂]₂ is not known, it likely forms a similar 2-D square grid network with all N(cyano) atoms equatorially bound to a square planar Cu^{II} center (FIG. 8), as would be generated by structurally erasing the DMF molecule from 3. The Cu[Au(CN)₂]₂ system was found to be only slightly porous by N₂-adsorption measurements, suggesting that the 2-D sheets stack in an offset fashion, likely with significant aurophilic interactions, thereby blocking channel formation. Despite this, solvents are still taken up by this system to yield the same Cu[Au(CN)₂]₂(solvent)ₓ complexes.

Concentration-Controlled Synthesis of Structural Isomers of Coordination Polymers

Results obtained by X-ray crystallography and elemental analysis indicate that 1 and 2 of this Example are true polymorphs or supramolecular isomers, as opposed to pseudopolymorphs that differ by incorporation of varying amounts or identities of co-crystallized solvent molecules.^{128,129} As mentioned above, many factors contribute to the preferential formation of one polymorph over another and it can often be a challenge to control the synthesis of a desired isomer.¹²⁸⁻¹³² Varying crystallization conditions, such as solvent type, starting materials, temperature and concentration are often important to ensure generation of just one polymorph. For example, crystallizing Ni[Au(CN)₂]₂(en)₂ (en=1,2-ethylenediamine) from [Ni(en)₃]Cl₂.2H₂O or [Ni(en)₂Cl₂] generates molecular and 1-dimensional polymorphic materials respectively.¹²² Also, it has been shown that metastable polymorphs can be obtained by rapid crystallization from a supersaturated solution, e.g., via a fast drop in temperature.^{131,133} For example, {Cu[N(CN)₂]₂(pyrazine)}ₙ forms green/blue and blue polymorphs when crystallized from concentrated and dilute solution respectively.¹³⁴

Similarly, in the Cu[Au(CN)₂]₂(DMSO)₂ system described in this Example, if the total concentration of reagents is below 0.2 M, 1 is formed, while 2 is obtained exclusively from >0.5 M solutions. The concentration-controlled synthesis of structural isomers of coordination polymers is uncommon relative to examples with molecular systems.^{134,135} This concentration dependence suggests that green 1 is the thermodynamic product, while blue 2, which rapidly precipitates from solution, is likely a kinetic product. The fact that Cu[Au(CN)₂]₂(H₂O)₂ converts exclusively to the green polymorph 1 when adsorbing DMSO is further evidence that 1 is the most energetically favorable polymorph. Interestingly, the density of thermodynamically preferred 1 is actually lower than that of 2. This surprising situation has been observed in other polymorphs.¹³⁶ Although it is unclear if this result can be attributed to entropic or enthalpic contributions, it is conceivable that the formation of shorter Au—Au bonds in 1 relative to 2 could be an important energetic factor.

Metal-Ligand Superstructures

It has been recognized that a system does not need to be porous in order to undergo guest uptake.¹³⁷ For example, a flexible metal-ligand superstructure can dynamically adapt in order to accommodate a variety of potential guests.¹³⁷⁻¹⁴³ In this light, the Jahn-Teller influenced flexible coordination sphere and the greater lability of Cu^{II} compared with other transition metals are likely important features of the Cu[Au(CN)₂]₂(solvent)ₓ system. The related Mn[Au(CN)₂]₂(H₂O)₂ and Co[Au(CN)₂]₂(DMF)₂ systems previously reported form more rigid frameworks.^{73,76} For these two systems, thermal treatment is required to remove the guest molecules and yield compounds exhibiting zeolitic properties. The lability of Cu^{II} in the system of the present invention facilitates the reversible exchange of adsorbed solvent molecules without any thermal treatment required. It also likely increases the flexibility of the framework by allowing the breaking and the reformation of Cu—N(cyano) bonds, thereby adapting to the solvent guest present. Gold-gold interactions are probably present in all the Cu[Au(CN)₂]₂(solvent)ₓ complexes and help to stabilize the 3D-network as solvent exchange takes place.

Taking into account the varied structures of the Cu[Au(CN)₂]₂(solvent)ₓ complexes, several modes of flexibility within the fundamental structural framework, i.e. the two-dimensional square-grid network of the Cu[Au(CN)₂]₂ moiety (FIG. 8), can be identified. Firstly, the 2-D square-grid can lie entirely flat, as in the bis-pyridine or mono-DMF complexes 3 and 4, or it can buckle to generate a corrugated 2-D array, as observed in the blue bis-DMSO polymorph 2. The extent of this corrugation can even force the partial fragmentation of the square array via the breaking of one Cu—N(cyano) bond, as observed in the green bis-DMSO polymorph 1. Such fragmentation is probably also present in the Cu[Au(CN)₂]₂(NH₃)₄ complex (9); the Cu^{II} center in 9 is likely still octahedral, with two Cu—N(cyano) bonds (out of four in the fundamental square-grid structure) breaking completely to make way for two additional NH₃ ligands, thereby disrupting the 2-D array. Another mode of flexibility lies in the ability of the Cu^{II} center to readily alternate between being five- and six-coordinate, as well as accessing a range of five-coordinate geometries. This adaptability is independent of the extent of corrugation: five-coordinate Cu^{II} centers are found in both flat 3 and corrugated 1 while six-coordinate centers are present in both flat 4 and corrugated 2. Finally, the Jahn-Teller distortions endemic to Cu^{II} complexes yield a third mode of flexibility: the arrangement of equatorial/axial or basal/apical N(cyano) ligands and donor solvents. Again, this pliability is independent of the extent of corrugation: both the five-coordinate DMF complex 3 and six-coordinate bis-pyridine complex 4 contain flat Cu[Au(CN)₂]₂ square-grids, but in 3 the N(cyano) ligands are all basal (and therefore roughly identical in length) while in 4 two N(cyano) ligands are equatorial and two are axial, leading to significantly different Cu—N(cyano) bond lengths. This form of structural flexibility is particularly important since substantially different IR signatures in the cyanide region are generated depending on the N(cyano) bonding arrangement in the system. Of course, all three modes of flexibility work in concert to generate the adaptable, dynamic network solid that is ultimately able to bind and sense different donor solvents.

The source of the vapochromism in the Cu[Au(CN)₂]₂(solvent)ₓ system differs from that of other Au^{I}-containing systems.³⁹⁻⁴² Cu[Au(CN)₂]₂(solvent)ₓ shows vapochromism in the visible since each donor solvent molecule that is adsorbed binds to the Cu^{II} center and modifies differently the crystal field splitting. As a consequence, the colour of the vapochromic compound changes as the d-d absorption bands shift with donor. In addition to donor identity, the resulting coordination number (five or six) and specific geometry of the copper center also influences the colour of the complexes by altering the splitting of the d-orbitals.

The [Au(CN)₂]⁻unit is also a key component of this system since it telegraphs the changes in solvent bound to the Cu^{II} centers via the ν_{CN} stretch. Each Cu[Au(CN)₂]₂(solvent)ₓ has a different IR signature since every VOC modifies in a different manner the electron density distribution around the Cu^{II} center. This influences the amount of π-back bonding from the Cu^{II} center to the CN group, which in turn is observed in the IR spectrum due to the change in vibration frequency.¹¹⁸ Also, the number of bands observed is related to the symmetry and coordination number of the Cu^{II} centers, as described in detail above.

In summary, it has been illustrated in this Example that, despite their different solid-state structures, the two Cu[Au(CN)₂]₂(DMSO)₂ polymorphs exhibit the same vapochromic behaviour with respect to sorption of analytes such as VOCs. The use of [Au(CN)₂]⁻as a building block is important to the function of this vapochromic coordination polymer. First, it provides the very sensitive CN reporter group that can allow IR-identification of the solvent adsorbed in the materials. Also, Au—Au interactions via the [Au(CN)₂]⁻units increase the structural dimensionality of the system in most cases and probably help provide stabilization points for the flexible Cu[Au(CN)₂]₂ framework.

### 1.2 Cu[Au(CN)₂]-Based Sensing of Ammonia and Amines

In this example coordination polymer Cu[Au(CN)₂]₂(μ-H₂O)₂ (5) was shown to be effective in reversibly sensing ammonia and amines at low concentrations.

As indicated above, Cu[Au(CN)₂]₂(μ-H₂O)₂ 5 is a green powder which, upon exposure to vapours of volatile organic compounds, exhibits visible vapochromism and changes in the υ_{CN} region of the IR spectrum. In this example, a finely ground powder of Cu[Au(CN)₂]₂(μ-H₂O)₂ (5) deposited onto a CaF₂ plate was exposed to a series of solvent vapours in a range of concentrations in order to determine sensitivity levels. Use of the υ_{CN} IR signature was more sensitive than use of the colour change monitored by UV-Vis solid state reflectance for all analytes; sensitivity limits for a range of VOCs via both detection channels are reported in Table 8.

Consistent with the vapochromic mechanism, which requires that the analyte ligate to the copper(II) center, 5 was found to be insensitive to non-coordinating or very weakly coordinating classes of VOCs (with respect to copper(II)) and related analytes. A representative set of compounds (in brackets) covering a range of functional groups such as esters (ethyl acetate), ethers (tetrahydrofuran), ketones (acetone), thiols (tetrahydrothiophene), aldehydes (formaldehyde), saturated hydrocarbons (pentane), aromatic hydrocarbons (benzene), chloroalkanes (dichloromethane) and even, remarkably, concentrated acetic acid, all generated no response from 5, which remained unscathed after exposure to saturated atmospheres of the respective VOCs. Compound 5 generated vapochromic responses to weak donors such as DMSO, DMF and MeCN (Table 8), with IR-sensitivities in the range of 400-1000 ppm, while stronger nitrogen-based donor VOCs and ammonia had much higher sensitivities, from several-hundred ppm down to ppb levels.

Among a series of representative amines, 5 was found to be more sensitive to primary(1°) amines versus secondary and tertiary (2° and 3°) amines. This observation is likely attributable to the higher steric hindrance of 2° and 3° amines (or long-chain 1° amines such as butylamine) restricting their donor ability, rather than their increasing vapour pressures; the boiling point of pyridine (115° C.) and ethylenediamine (118° C.) are similar, yet their sensitivities are 400 ppm vs. 385 ppb respectively. Similarly, although the boiling point of ethylenediamine (118° C.) is significantly higher than diethylamine (55° C.), 5 was much more sensitive towards ethylenediamine. In the case of propylamine and butylamine, since their basicity and boiling points are fairly similar, the large decrease in sensitivity (140 ppb vs. 100 ppm respectively) probably reflects the limited ability of the flexible coordination polymer structure to readily adapt to accommodate longer chain alkyl groups.

Indeed, as shown in Table 8 below, 5 was found to be extremely sensitive to ammonia and low molecular-weight 1°-amines. For example, the detection limit with the naked eye (by watching the colour change) when 5 is exposed to ammonia is as low as 40 ppm; with visible reflectance spectroscopy and using the spectrum of 1 as a background, it drops to 230 ppb. By using the υ_{CN} IR spectroscopy channel, ammonia concentrations as low as 36 ppb could be detected. Similarly, propylamine could be detected down to 140 ppb.

Titration Studies.

Titration of 5 with consecutive equivalents of ammonia or propylamine showed that a series of intermediates were obtained en route to the final products observed upon exposure to a large excess. Monitored by IR spectroscopy, 5 interacts with ammonia and amines in a similar manner. Titration with two or less equivalents of NH₃ per Cu(II) centre of 5 causes a decrease in the ν_{CN} bands attributable to 5 at 2216 and 2171 cm⁻¹ and the formation of two new bands at 2181 and 2151 cm⁻¹. Upon continuing the titration from two to four equivalents of ammonia, new ν_{CN} peaks at 2175 and 2148 cm⁻¹ replaced the 2181/2151 cm⁻¹ set. Finally, further titration (up to 35 equiv.) generated the final NH₃-saturated film that exhibited a new ν_{CN} band at 2141 with a small band at 2136 cm⁻¹. This titration data suggests that two intermediates of stoichiometry Cu[Au(CN)₂]₂(NH₃)₂ (9) and Cu[Au(CN)₂]₂(NH₃)₄ (10) are formed on the way towards the final saturated product. Note that the IR spectrum of 9 matches that observed for the low-concentration/high sensitivity tests of 5 with NH₃ (Table 8). The presence of two ν_{CN} bands for all intermediates and the product also indicates that two different cyanide environments exist in the solids.

A similar trend was observed for the propylamine titration of 5: one equivalent of propylamine vapour generated new peaks at 2185 and 2155 cm⁻¹, along with the peaks of 5 at 2216 and 2171 cm⁻¹. Addition of a second equivalent of propylamine greatly increased the peaks at 2185 and 2155 cm⁻¹ with a concomitant loss of the peaks for 5. A third equivalent of propylamine generated three new peaks at 2182, 2142 and 2133 cm⁻¹ with a decrease in the intensity of the 2185/2155 cm⁻¹ set; these peaks became dominant upon addition of a fourth equivalent. Excess propylamine generates a peak at 2143 cm⁻¹. The propylamine titration results also suggest the presence of two intermediates, namely Cu[Au(CN)₂]₂(CH₃CH₂CH₂NH₂)₂ (11) and Cu[Au(CN)₂]₂(CH₃CH₂CH₂NH₂)₃ (12) prior to saturation.

These titrations were also monitored by visible reflectance spectroscopy due to the drastic colour changes from green to blue-green to deep blue that occur upon exposure of 5 to ammonia or propylamine. When 5 is exposed to one to two equivalents of ammonia the λₘₐₓ shifts from 535 to 510 nm with one isosbestic point at 522 nm suggesting that there are two compounds in equilibrium, most probably the starting material and the Cu[Au(CN)₂]₂[NH₃]₂ complex. When exposed to three to six equivalents of ammonia, the λₘₐₓ shifts up to 470-485 nm with another crude isosbestic point at approximately 500 nm suggesting that another set of two compounds are in equilibrium, most probably the bis- and the tetrakis-amine coordinated complexes 9 and 10. It was observed that the maxima obtained after exposing 5 to 1 and 2 equivalents of ammonia and allowing it to equilibrate are very close and the same trend is observed when exposing it to 3 to 4 equivalents of ammonia, suggesting that there are two intermediates formed Cu[Au(CN)₂]₂[NH₃]ₓ (x=2, 4) before it sees an excess of ammonia, which generates a maximum at 435 nm.

When 5 was titrated with propylamine vapour, the same blue-shifting trend was observed as for the ammonia analyte. Thus, the addition of one and two equivalents of propylamine shifted the visible reflectance spectrum from 535 to 502 nm, with a clear isosbestic point at 513 nm. Titration with a third equivalent of propylamine caused a further shift to 462 nm, with a new isosbestic point at 491 nm; a fourth equivalent initiated no further shift in this case. The presence of two separate isosbestic points and the titration equivalents needed to maximize the bands (two and three equiv.) are consistent with the proposed formation of intermediates 11 and 12. Addition of an excess of propylamine (14 equivalents) shifted λₘₐₓ to 428 nm, generating a dark blue compound. When saturated with ammonia or propylamine, the observed UV-Vis maxima are unique to each analyte, since the ammonia/propylamine binds to the copper(II) centre and each has a different ligand field strength; the same can be said for the other strongly-bonding analytes in Table 8.

Kinetics of Vapochromic Response.

Kinetic studies of analyte adsorption/desorption were also performed on the coordination polymer 5 by exposing it to an excess of ammonia and propylamine vapour over a period of 2 minutes. When exposed to ammonia, one isosbestic point was observed at 2175, suggesting that two compounds were in equilibrium. The ν_{CN} stretches were recorded with respect to time after the exposure of compound 5 to ammonia and it was observed that the band of the dry coating at 2171 and 2216 cm⁻¹ shifts to 2181 and 2151 cm⁻¹ first, which matches the value obtained for Cu[Au(CN)₂]₂[NH₃]₂ using both IR titration studies and synthetic studies. With time peaks at 2175 and 2148 cm⁻¹ are formed, which matches the value obtained for Cu[Au(CN)₂]₂[NH₃]₄ as described above. After some time, compound 5 sees an excess ammonia and hence a peak at 2141 cm⁻¹ was observed due to the presence of free Au(CN)₂⁻.

A stepwise blue-shifting of the visible absorption band is observed over the same time-period for ammonia adsorption. However, the presence of dynamic mixtures of adducts renders the shifting conglomerate bands difficult to assign based on their maxima; however, the end-point is the fully saturated system at 435 nm.

Desorption of NH₃ analyte from the copper center is also observed when the cell is opened to air at room temperature. Kinetic studies were also performed on the desorption of ammonia over two minutes from a mixture of 10 and the fully saturated species at 2175/2148 and 2141/2136 cm⁻¹ respectively; the bis-ammonia adduct 9 rapidly grew in at 2181/2150 cm⁻¹, confirming the loss of two ammonia molecules. A visible colour change is also observed from blue to green with the final visible maximum at 525 nm (a mixture of 5 and 9) over 2 minutes. Note that the desorption of ammonia is very quick and hence as soon as the cell is opened loss of ammonia commences.

Analogous kinetic studies with propylamine as analyte also showed the formation of intermediates. When compound 5 was exposed to a small excess of propylamine, a shift in the IR ν_{CN} stretches of the starting material with respect to time was observed. The ν_{CN} stretches shifts from 2171 and 2216 cm⁻¹ to 2155 and 2187 cm⁻¹, consistent with the formation of Cu[Au(CN)₂]₂[CH₃CH₂CH₂NH₂]₂ (11). With time the peak at 2155 cm⁻¹ decreases and the peaks at 2182, 2140 and 2133 cm⁻¹ increase, analogous to Cu[Au(CN)₂]₂[CH₃CH₂CH₂NH₂]₃ (12).

Desorption of propylamine from the copper centre was also observed when the cell containing compound 5 and propylamine vapour was opened to air at room temperature. The IR ν_{CN} stretches for Cu[Au(CN)₂]₂[CH₃CH₂CH₂NH₂]₃ 12 moved from 2182, 2140 and 2133 cm⁻¹ to 2155 and 2187 cm⁻¹, analogous to Cu[Au(CN)₂]₂[CH₃CH₂CH₂NH₂]₂ 11, as analysed by IR titration and synthetic studies. A peak at 2171 cm⁻¹ attributable to the hydrate 5 also grew in over time; exposing the sample to a high humidity (68%) atmosphere for two hours, sharp peaks at 2171 and 2216 cm⁻¹ were observed with residual peaks at 2155 and 2187 cm⁻¹ corresponding to Cu[Au(CN)₂]₂[CH₃CH₂CH₂NH₂]₂ 11. However, at low humidity, the Cu[Au(CN)₂]₂[CH₃CH₂CH₂NH₂]₂ 11 compound is not reversible unless a burst of heat is applied (to give the anhydrous complex, Cu[Au(CN)₂]₂).

Upon absorption of propylamine by 5, blue shifts occur but, as with the NH₃ case, the presence of a dynamic mixture of Cu[Au(CN)₂]₂[CH₃CH₂CH₂NH₂]ₓ compounds, each with a different absorption band, precluded a detailed analysis of the changes; the final visible maximum (broad, 425-440 nm) after saturation corresponds to a mixture of 11 and the saturated species 12. Upon desorption, the band red-shifts and broadens but, as is evident from the IR-data, does not rapidly settle to a single compound—it represents a mixture of bis-propylamine 11 and hydrate 5.

In general, the response time of 5 depends greatly on the analyte (Table 8) and is longer with vapour-saturated dimethylformamide, dimethylsulfoxide, pyridine and acetonitrile (minutes to hours) vs. ammonia (<5 seconds). At lower vapour concentrations of analyte, the response times increase, to within a minute for NH₃, for example.

Resetting the Vapochromic Material.

Upon standing in an NH₃-free environment at high humidity, 5 loses all bound ammonia and propylamine within 2 hours as determined by IR and UV-Vis spectroscopy. However, in order to quickly and fully liberate bound analyte and thereby fully reset the sensor, 5 was heated at 160° C. for 150 seconds. Rather than regenerate 5 exactly, the related anhydrous Cu[Au(CN)₂]₂ complex 6 was produced, as confirmed by the single ν_{CN} stretch at 2191 cm⁻¹. This material reacts in the same fashion with NH₃ as 5 to reform 9 but the sensitivity is three times lower than the original hydrated 5 and its response time is also slower. Thus, in the absence of high humidity or a heating reset, 5 acts primarily as a sensitive one-time dosimeter for ammonia and 1°-amines. Using a heating reset, the sensor was repeatedly cycled a further three times with no apparent degradation or change in performance.

On the other hand, when exposed to more weakly-bound analytes such as DMF, DMSO, pyridine and acetonitrile, the material will reset to the analyte-free hydrated 5 at room temperature in ambient atmosphere upon removal of the analyte vapour; the speed of this regeneration depends on the specific analyte and ambient humidity but range from seconds for acetonitrile to minutes for pyridine. Thus, for these analytes, 5 acts as a reversible sensor; repeating the cycle several times caused no apparent degradation of the material.

The potential cross-interference of different VOCs with ammonia was also analyzed by introducing mixtures of NH₃ and another VOC to 5: only small alkyl chain 1°-amines interfere with the NH₃ sensory response and even then only if they are present at a higher concentration than the ammonia. Other coordinating VOCs such as pyridine, acetonitrile, DMF and DMSO do not interfere. A high level of humidity has an impact on the vapochromic response of 5 to weaker donating solvents (DMSO, DMF, pyridine, acetonitrile etc.) but not with NH₃ or small 1° amines.

As will be apparent to a person skilled in the art, the quantitative values referred to in this example are guidelines only and are subject to a margin of error. The detection sensitivity of a particular vapochromic polymer to a particular analyte will vary depending upon various factors including atmospheric conditions, the manner in which the polymer is deployed and the concentration of the polymer.

### Example 2.0

### Zn-Based Polymers

2.1 Zn[Au(CN)₂]₂(solvent)ₓ System

Synthesis of Zn[Au(CN)₂]₂(DMSO)₂.

To a 1 mL DMSO solution of Zn(ClO₄)₂(H₂O)₆ (0.032 g, 0.086 mmol) was added KAu(CN)₂ (0.050 g, 0.173). Slow evaporation yielded crystals of Zn[Au(CN)₂]₂(DMSO)₂. Anal. Calcd. for C₈H₁₂N₄Au₂O₂S₂Zn: C, 13.35; H, 1.68; N, 7.79%. Found: C, 13.50; H, 1.72; N, 8.04%. IR (KBr, cm⁻¹) 3009 (m), 2919(m), 2849(w), 2186(s), 2175(s), 1409(m), 1314(m), 1299(m), 1031(m), 1013(s), 1005(s), 957(m), 710(w).

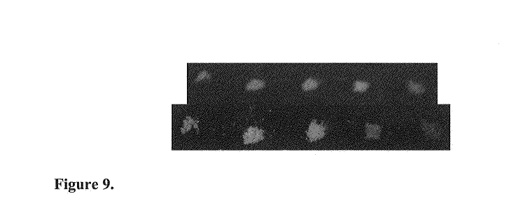

Although the structure of a solvent-free Zn[Au(CN)₂]₂ polymer (13) is known, it is believed that no luminescence or analyte binding properties have previously been reported. FIG. 9 consists of photographs showing changes in luminescence in a Zn[Au(CN)₂]₂(analyte), system under room light (top) and ultraviolet light (bottom). From left to right in the dish, the analyte is None, NH₃, pyridine, CO₂ and DMSO. As in Example 1.0 above, the cyanide-IR changes are also dramatic and distinctive for each analyte.

The zinc-based polymer described herein appears to bind CO₂. Anal. Calcd. for C₅N₄Au₂O₂Zn: C, 9.89; H, 0.00; N, 9.22%. Found: C, 9.73; H, 0.00; N, 9.32%. IR (KBr, cm⁻¹): 2192 (s).

### 2.2 Synthesis, Structure and Photoluminescent Properties of Four Polymorphs of Zn[Au(CN)₂]₂(13)

### 2.2.1 General Procedures and Physical Measurements

All manipulations were performed in air. [ⁿBu₄N][Au(CN)₂].½H₂O was synthesized as previously described.¹⁴⁴ All other reagents were obtained from commercial sources and used as received. Infrared spectra were recorded as pressed KBr pellets on a Thermo Nicolet Nexus 670 FT-IR spectrometer. Microanalyses (C, H, N) were performed at Simon Fraser University on a Carlo Erba EA 1110 CHN Elemental Analyzer. Thermogravimetric analysis (TGA) data were collected using a Shimadzu TGA-50 instrument heating at 1° C./min in an air atmosphere. Differential Scanning calorimetry (DSC) measurements were collected on a Perkin Elmer DSC 7 instrument with a Perkin Elmer TAC 7/DX controller heating at 2° C./min from 25-300° C.

Solid-state luminescence data were collected at room temperature on a Photon Technology International (PTI) fluorometer, using a Xe arc lamp and a photomultiplier detector. Finely ground powder samples were drop cast, from the synthesis solvent, on a quartz plate and placed at an approximately 45° angle in a quartz cuvette Ammonia exposure experiments were conducted under the same conditions, sealing the top of the cuvette with parafilm to prevent rapid loss of ammonia gas. The headspace of a bottle of concentrated ammonia solution (29.4%) was used as the source of ammonia gas.

Emission lifetimes data were determined using a customized apparatus (Prof. K. Sakai, Kyushu University) equipped with an Iwatsu DS-4262 Digital Oscilloscope and a Hamamatsu R928/C3830 photomultiplier tube coupled to a Horiba H-20-VIS grating monochromator. The excitation source was an N2 laser (337 nm) (Usho KEN-1520).

Nitrogen porosity measurements at 77 K of 13α-13δ were carried out on a custom-built vacuum line (Prof. I. Gay, Simon Fraser University) using a gas-volumetric measurement technique. Samples of α-δ were pretreated by heating to 150° C. under vacuum in order to degas the sample and remove any surface-bound solvent. A maximum pressure of 80 Torr was used.

The vapochromic behaviour of the polymorphs 13α-13δ was quantified in a customized chamber of known volume. The visible emission spectrum was monitored using an Ocean Optics QE65000 spectrometer with an Ocean Optics deuterium/tungsten-halogen DH-2000-FHS source. Titration and sensitivity limit studies were both performed on the different polymorphs, by introducing a known amount of NH₃ (as 2.0 M NH₃ solution in 2-propanol) into the chamber through a septum using an air-tight syringe.

The sensitivity of the different polymorphs to NH₃ was determined by sequentially introducing known concentrations of NH₃ into the chamber and observing any change in visible emission at 520 nm. The 520 nm wavelength was chosen to ensure that no peak overlap was observed. The emission spectrum of the appropriate NH₃-free polymorph starting material was used as the background; this yielded higher sensitivities than use of a MgO white background.

The titration studies were performed by adding sequential equivalents of NH₃ per Zn(II) centre, allowing the material in the chamber to equilibrate for 30 seconds, and then measuring the IR spectrum.

### 2.2.2 Synthetic Procedures

Although the inventors have experienced no difficulties, perchlorate salts are potentially explosive and should only be used in small quantities and handled with care.

α-Zn[Au(CN)₂]₂ (13α).

A 15 mL aqueous solution containing Zn(ClO₄)₂.6H₂O (37 mg, 0.10 mmol) was added to a 15 mL aqueous solution of KAu(CN)₂ (57 mg, 0.20 mmol). Crystals begin to form after two days of slow, partial, evaporation yielding colourless X-ray quality crystals of α-Zn[Au(CN)₂]₂, (α). Yield: 40 mg (72%). Anal. Calcd for C₄N₄Au₂Zn: C, 8.53%; H, 0.00%; N, 9.94%. Found: C, 8.84%; H, 0.00%; N, 10.15%. IR (KBr, cm⁻¹): 2216 (w), 2198 (s), 2158 (w), 517 (m). A similar preparation (using a different stoichiometry) and the crystal structure have been previously reported.⁷⁷

β-Zn[Au(CN)₂]₂ (13β). To a 3 mL acetonitrile solution containing Zn(NO₃)₂.6H₂O (30 mg, 0.10 mmol), a 3 mL acetonitrile solution of [ⁿBu₄N][Au(CN)₂].½ H₂O (100 mg, 0.20 mmol) was added while stirring, yielding an immediate precipitate. The mixture was centrifuged, after which the solvent was removed and the powder allowed to dry overnight. The sample was washed with three portions of acetonitrile (6 mL) through filter paper to remove any KNO₃ or unreacted starting material. The resulting powder was air dried, yielding a white powder of β-Zn[Au(CN)₂]₂, (13β). Yield: 40 mg (72%). Anal. Calcd for C₄N₄Au₂Zn: C, 8.53%; H, 0.00%; N, 9.94%. Found: C, 8.51%; H, 0.00%; N, 9.78%. IR (KBr, cm⁻¹): 2221 (sh), 2199 (s), 2158 (w), 521 (m).

X-ray quality crystals of 13β can be grown by slow, partial, evaporation of a 20 mL methanol solution of KAu(CN)₂ (10 mL, 57 mg, 0.20 mmol) and Zn(ClO₄)₂.6H₂O (10 mL, 37 mg, 0.10 mmol). The crystals and powder had identical IR spectra and powder diffractograms. Crystals of KClO₄ are interspersed with crystals of 13β.

γ-Zn[Au(CN)₂]₂ (13γ). Method 1: To a 1 mL acetonitrile solution containing Zn(ClO₄)₂.6H₂O (37 mg, 0.10 mmol), a 1 mL acetonitrile solution of [ⁿBu₄N][Au(CN)₂].½H₂O (150 mg, 0.30 mmol) was added dropwise while stirring, yielding an immediate precipitate. The mixture was centrifuged, after which the solvent was removed and the powder allowed to dry overnight. The sample was washed with three portions of acetonitrile (2 mL) through filter paper to remove any KClO₄ and unreacted starting material. The resulting powder was air dried, yielding a white powder of γ-Zn[Au(CN)₂]₂, (13γ). Yield: 40 mg (72%). Anal. Calcd for C₄N₄Au₂Zn: C, 8.53%; H, 0.00%; N, 9.94%. Found: C, 8.62%; H, 0.00%; N, 9.82%. IR (KBr, cm⁻¹): 2187 (s), 2149 (w), 526 (m).

Method 2:

To a 5 mL (99:1) acetonitrile:water solution containing Zn(ClO₄)₂.6H₂O (37 mg, 0.10 mmol), a 5 mL (99:1) acetonitrile:water solution of KAu(CN)₂ (57 mg, 0.20 mmol) was added dropwise while stirring, yielding an immediate precipitate, which was filtered and washed with three portions of acetonitrile (3 mL), leaving a powder of 13γ. Yield: 43 mg (77%). The IR spectra and X-ray powder diffractograms of the products from both methods are identical.

δ-Zn[Au(CN)₂]₂ (13δ). A 15 mL aqueous solution containing KAu(CN)₂ (114 mg, 0.40 mmol) and KCN (26 mg, 0.40 mmol) was covered with a watch glass and brought to a boil, after which HCl (0.80 mL, 0.100 N solution, 0.080 mmol) was added. The solution was cooled until the beaker was warm to the touch, after which a 15 mL aqueous solution of ZnCl₂ (26 mg, 0.20 mmol) was added. Over several hours, crystals of δ-Zn[Au(CN)₂]₂ (13δ) deposited. The crystals were immediately filtered and dried. Yield 60 mg (56%). Anal. Calcd for C₄N₄Au₂Zn: C, 8.53%; H, 0.00%; N, 9.94%. Found: C, 8.44%; H, 0.00%; N, 10.27%. IR (KBr, cm⁻¹): 2191 (s), 2188 (s), 2156 (w), 2151 (w), 526 (m). Further evaporation yields a mixture of 13α and 13δ crystals, after which a yellow powder of AuCN is produced.

{Zn(NH₃)₂[Au(CN)₂]_{2} (}14).

Ammonia gas (10 mL), from the saturated headspace of a bottle of concentrated ammonia solution (29.4%), was introduced to a vial containing 20 mg of 13β. The vial was sealed and left standing for 30 min, yielding a white powder. The vial was then opened and the ammonia allowed to escape for 5 min, generating a bright, yellow powder of {Zn(NH₃)₂[Au(CN)₂]₂} 14. Anal. Calcd. for C₄H₆N₆Au₂Zn: C, 8.04%; H, 1.01%; N, 14.07%. Found: C, 8.30%; H, 0.91%; N, 13.87%. IR (KBr, cm⁻¹): 3290 (m), 3178 (w), 2158 (s), 2117 (sh), 1202 (s), 618 (br, m).

Using 13α, 13γ, or 13δ as the starting material still generated {Zn(NH₃)₂[Au(CN)₂]₂} 14.

If a sample of {Zn(NH₃)₂[Au(CN)₂]₂} 14 is left unsealed for an hour, a white powder of Zn[Au(CN)₂]₂ 13 forms. Anal. calcd. for C₄N₄Au₂Zn: C, 8.53%; H, 0.00%; N, 9.94%. Found: C, 8.86%; H, 0.00%; N, 9.80%. IR (KBr, cm⁻¹): 2197 (s), 2160 (w), 518 (m).

### 2.3.3 X-Ray Crystallographic Analysis

Crystallographic data for the four polymorphic compounds 13α-13δ and {Zn(NH₃)₂[Au(CN)₂]₂} 14 are tabulated in Table 9. Crystals of 13β and 13δ were mounted on glass fibers using epoxy adhesive. 13β was a colourless plate having dimensions 0.20×0.20×0.02 mm³ and 138 was a colourless plate having dimensions 0.14×0.11×0.06 mm³. The data for compounds 13β and 13δ were collected at room temperature on a Broker Smart instrument with an APEX II CCD area detector at a distance of 6.0 cm from the crystal. A Mo Kα fine-focus sealed tube operated at 1.5 kW power (50 kV, 30 mA) was utilized for data collection. The following data ranges were recorded: 13β=4°<2θ<57°; 13δ=7°<2θ<65°.

For compound 13β, a total of 776 frames were collected with a scan width of 0.5° in ω; all frames were collected with a 20 s exposure time. The frames were integrated with the Bruker SAINT software package. Data were corrected for absorption effects using a numerical face-indexed technique (SADABS) with a transmission range of 0.058-0.700. Final unit-cell dimensions were determined based on the refinement of the XYZ-centroids of 1969 reflections with ranges 4°<2θ<51°

Crystals of compound 13δ were determined to be two component non-merohedral twins (CELL_NOW) by an approximately 180° rotation about the [100] direction in real space. A total of 4079 frames were collected with a scan width of 0.5° in w; all frames were collected with a 20 s exposure time. Frames were integrated with the Bruker SAINT software package using the appropriate twin matrix. Data were corrected for absorption effects (TWINABS) with a transmission range of 0.036-0.110. Final unit-cell dimensions were determined based on the refinement of the XYZ-centroids of 9904 reflections with ranges 7°<2θ<61°

The structures of compounds 13β and 13δ were solved in CRYSTALS¹⁴⁵ using direct methods (SIR92) and expanded using Fourier techniques. Diagrams were prepared using Cameron.¹⁴⁶

The coordinates and anisotropic temperature factors for all atoms of compounds 13β and 13δ were refined. For 13β, the final refinement using observed data (Iₒ>2.50σ(Iₒ)) included an extinction parameter, and statistical weights included 103 parameters for 1656 unique reflections. For 13β, the final refinement using observed data (Iₒ>2.50σ(Iₒ)) and statistical weights included 104 parameters for 2105 unique reflections. Selected bond lengths and angles are given in Tables 10 and 11 respectively.

X-ray powder diffractograms were collected on a Rigaku RAXIS rapid curved image plate area detector with a graphite monochromated Cu—Kα radiation source and a 0.5 μm collimator. Powder samples were adhered to a glass fiber with grease. Peak positions for 13γ and cell parameters were determined with Dicvol.¹⁴⁷ Structural models for 13γ were produced and refined with Powder Cell.¹⁴⁸ using triclinic symmetry. The spacegroup and atomic positions of the carbon and nitrogen atoms were determined with CRYSTALS¹⁴⁵ using distance and angle restraints. A final refinement cycle for γ was conducted in Powder Cell¹⁴⁸ in the tetragonal spacegroup P bar-4 b 2.

The powder pattern of {Zn(NH₃)₂[Au(CN)₂]₂} 14 was compared with simulated patterns of the coordination polymer {Cd(NH₃)₂[Ag(CN)₂]₂},¹⁴⁹ which was found to have a similar diffraction pattern. Unit cell determination and further refinements were performed in Powder Cell¹⁴⁸ using the atomic positions of the {Cd(NH₃)₂[Ag(CN)₂]₂} complex.¹⁴⁹ The relative intensities of the 21l reflections for the observed powder pattern were consistently less intense and very broad then the intensities in the calculated powder diffractogram.

### 2.2.4 Synthesis and IR Spectra

Equations 1-4 below summarize schemes identified by the inventors for controlled synthesis of polymorphs 13α-13δ by the reaction of Zn(II) salts with two equivalents of the linear anionic Au(CN)₂⁻ building block. All four materials have comparable elemental analyses and thus are true polymorphs, not pseudo-polymorphic solvent adducts. Elemental analysis indicated that when 13β was initially formed (eq 2), it contained at least one labile acetonitrile per Zn[Au(CN)₂]₂ unit. This complex readily desolvated when left in an unsealed container overnight. Powder X-ray diffractograms showed no difference between the solvated and desolvated forms of 13β.

Polymer 13 exhibits exquisite structural sensitivity to synthetic conditions. More particularly, the synthesis of each polymorph is sensitive to solvent choice,¹⁵⁰⁻¹⁵³ concentration,¹⁵⁴ pH,^{155,156} and even the counterions associated with either the zinc(II) or gold(I) starting material, despite the fact that these counterions are not incorporated into the final polymer. This last point is best exemplified in the synthesis of 13β vs. 13γ (Equation 2 & 3), where changing the gold counterion from K⁺ to [ⁿBu₄N]⁺ and the zinc counterion from NO₃⁻ to ClO₄⁻ generates 13γ instead of 13β, under similar reaction conditions. Furthermore, if only one counterion is changed, a mixture of polymorphs 13β and 13γ are obtained. The counterions in the synthesis of 13β and 13γ could play an important role as a templating agent, preferentially inducing the formation of one network versus another.

Conversely, the synthetic route to 13α is insensitive to counterions and moderately insensitive to concentration, although mixtures of 13α and 13δ are formed under extremely concentrated conditions (2 mL total). Changing the solvent in equation 1 from water to methanol produces crystals of 13β only when Zn(ClO₄)₂ is used (See experimental section above). The difference may be partially attributed to changes in the hydrogen bonding characteristics of water vs. methanol.¹⁵⁷ The same effect is also observed in the synthesis of 138, which is done under acidic conditions (Equation 4) with ZnCl₂.

While the rationale behind the preferential formation of a particular polymer under a defined set of conditions is unclear, it is obvious (Equation 1-4) that the formation constant for each polymorph is relatively similar. Changing the solvent, concentration, counterion, and/or pH is sufficient to easily shift the resultant energy minimum from one polymorphic form to another.

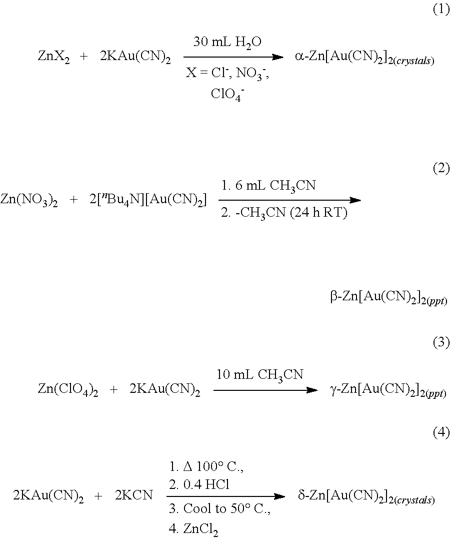

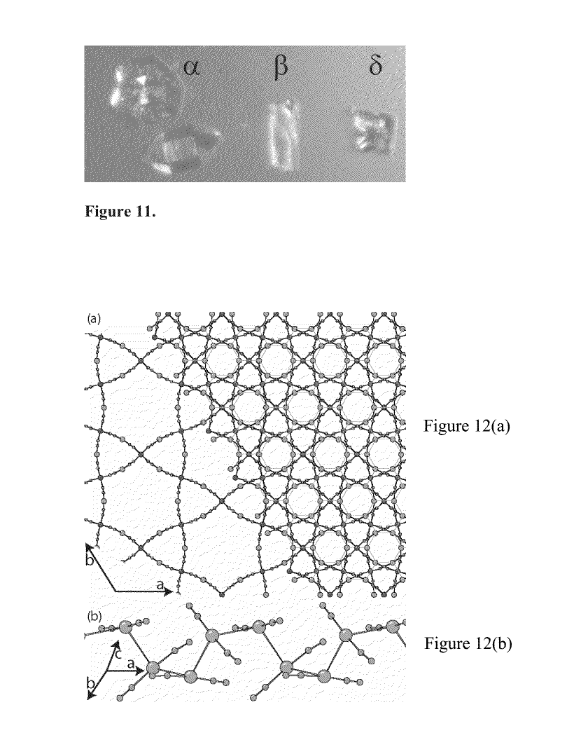

The IR spectra of all four polymorphs, 13α-13δ, are similar, having strong υ_{CN} stretches between 2187 and 2199 cm⁻¹ and readily visible ¹³C-satellites between 2158 and 2149 cm⁻¹. These bands are all shifted to higher energy relative to KAu(CN)₂ (υ_{CN}=2141 cm⁻¹), indicating that all of the cyanide groups are bound to a zinc centre.¹¹⁸ For the most part, the similarities in the IR spectra for 13α-13δ precluded the use of the IR signatures as a definitive polymorph identifier; this was accomplished on the basis of a combination of distinct crystal habit (FIG. 11), distinct X-ray powder diffractograms, and emission data (See below).

### 2.2.5 Crystal Structure of the Polymorphs

Crystal Structure of 13α.

The synthesis, with a Zn:Au(CN)₂ ratio of 3:1, and the crystal structure of the resulting hexagonal crystals of Zn[Au(CN)₂]₂ (13α) were previously reported.⁷⁷ The inventors have determined that the stoichiometrically rational reaction of Zn(II) and two equivalents of KAu(CN)₂ in water generates the same hexagonal crystals (Table 10, FIG. 11); the crystal structure is briefly described below for comparative purposes. The crystal structure contains a zinc centre in a tetrahedral geometry, with four N-bound cyanides (Zn—N bond lengths of 1.939 and 1.978 Å), thereby generating a 3-D coordination polymer. The network structure of a consists of corner-sharing tetrahedra, analogous to SiO2-quartz (FIG. 12a);¹⁵⁸⁻¹⁶² each tetrahedron is defined by a gold(I) atom at each vertex and a zinc(II) atom at the centre. In order to efficiently utilize the large space between neighbouring zinc centres of this quartz-type net, the structure is six-fold interpenetrated (FIG. 12a-right).^{160,161} The interpenetration is supported via gold-gold bonds of alternating 3.11 and 3.16 Å, forming a 1-D zig-zag chain of Au(CN)₂⁻ with an angle of 114.98° (FIG. 12b). A similar structure was reported for Co[Au(CN)₂]₂.⁷⁴

Crystal Structure of 13β.

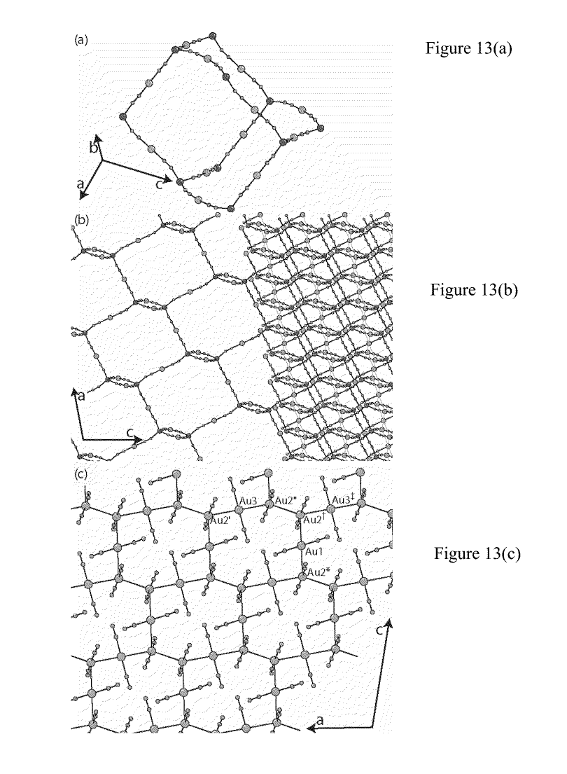

Rectangular plate crystals of 13β (FIG. 11) were obtained from the partial evaporation of a methanol solution of Zn(ClO₄)₂ and KAu(CN)₂. Similar to the crystal structure of 13α, 13β also consists of a zinc(II) centre surrounded by 4 N-bound cyanide groups in a tetrahedral geometry with Zn—N bond lengths of 1.941(14)-1.961(14) Å (Table 11). The tetrahedra are corner-sharing, this time forming a 3-D structure that has a diamond-type topology;^{157,160,161,163-165} each building block in the network can be viewed as an adamantyl unit (FIG. 3a). The framework is analogous to cristobalite, another polymorph of SiO₂ (FIG. 3).¹⁶² The 3-D networks in β are five-fold interpenetrated (FIG. 13b-right).^{160,161,164} The interpenetrated networks are linked via gold-gold bonds ranging from 3.1471(11)-3.2702(6) Å and angles ranging from 104.951(17)-180° (Table 11, FIG. 13c). Whereas the aurophilic array of α forms 1-D chains of Au-centres, the Au-array in β forms a 2-D (6,3)-network¹⁶⁰ in which the gold atoms form a distorted hexagonal motif array with gold atoms located at the vertices of the hexagons (FIG. 13c).

Crystal Structure of 13γ.

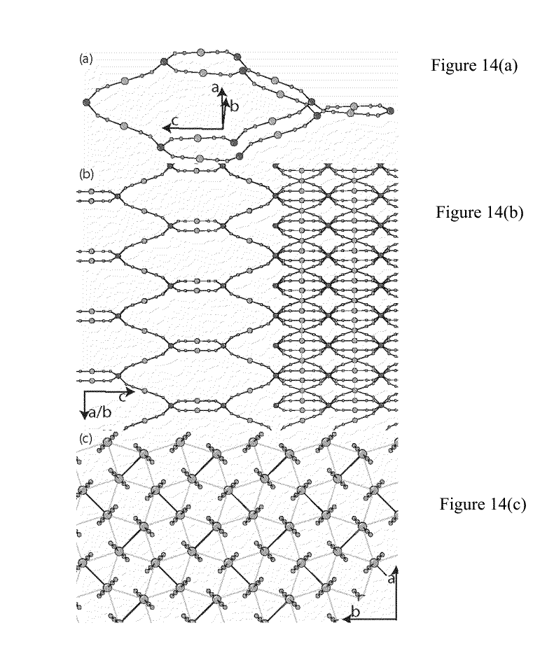

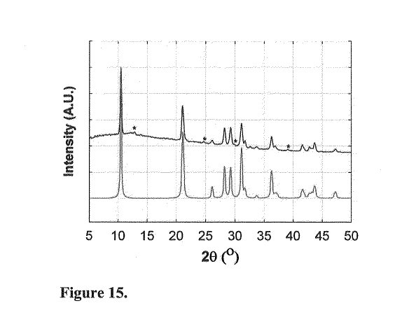

Although single crystals of 13γ could not be obtained, pure microcrystalline powder of 13γ was synthesized from Zn(ClO₄)₂ and [cation] [Au(CN)₂] (cation=K⁺,ⁿBu₄N⁺) in MeCN. The powder diffractogram of 13γ was observed to be similar to the previously reported Pb[Au(CN)₂]₂ structure.²⁰¹ Using this Pb(II) structure as a starting model, the structure of 13γ was determined from powder X-ray diffraction data. An excellent match between predicted and experimental powder diffractograms (FIG. 15) was obtained. The structure is both chemically reasonable and spectroscopically consistent. Interestingly, the crystal structure of 13γ has the same network structure as 13β: a diamond-type array formed by fused adamantyl units (FIGS. 13a and 13b}).^{157,160,161,163-165} There are several differences between these polymorphs. Firstly, the networks of 13γ are four-fold interpenetrating (FIG. 14b) while 13β contains five independent networks (FIG. 13c).^{160,164} The interpenetration in 13γ is supported by gold-gold bonds of 3.29 Å. However, while a 2-D array of gold atoms is present in β, the gold atoms in 13γ primarily form dimers. Long gold-gold interactions of 3.58 Å link the dimers to one another (FIG. 14b). In addition, the shape of the diamond network in 13γ is more prolate than that of 13β. A single adamantyl framework in 13β has the dimensions 25.8×16.5×13 Å (FIG. 3a) while the adamantyl framework in 13γ has the dimensions 33.8×9.6×9.6 Å.

Crystal Structure of 13δ.

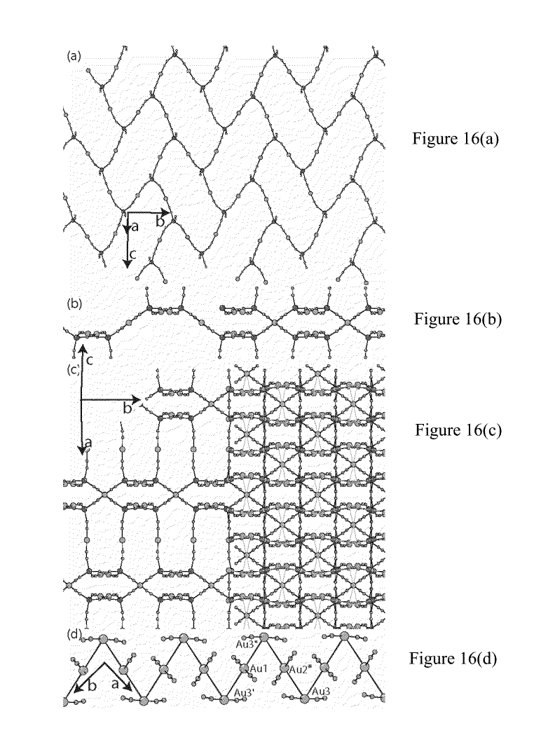

Twinned cross-shaped crystals of 13δ (FIG. 11) were obtained from an acidic aqueous solution of ZnCl₂, KAu(CN)₂ and KCN; this synthesis was modified from an old report of Zn/Au(CN)₂ reactivity that did not identify any of the polymorphs.¹⁶⁶ As in 13α-13γ, the crystal structure of 13δ contains a tetrahedral zinc centre with Zn—N(cyano) bond lengths ranging from 1.956(10) to 1.986(10) Å. However, while 13α, 13β, and 13γ form easily recognizable structures based on corner-sharing tetrahedra, the 3-D structure of 13δ is considerably more complicated. Temporarily omitting one of the Au(CN)₂⁻units on each zinc (the Au(CN)₂⁻unit formed by Au(3)), the structure can be simplified to a corrugated 2-D (6,3)-herringbone structure (FIGS. 16a & 16b) along the (1 0 −1) plane.^{160,163} A second (6,3)-herringbone network is interwoven through the first (FIG. 16b-right). Long gold-gold distances of 3.6430(9) Å represent the only close contact between this pair of networks. Via the previously omitted Au(CN)₂⁻ unit, each individual herringbone network is linked to four additional networks (FIG. 16c-left)—the pair of interwoven networks above, and the pair of networks below—completing the basic 3-D structure. The void space is filled by two additional identical 3-D interpenetrated networks (FIG. 16c-right).¹⁶⁰ The interpenetration is supported via gold-gold bonds of 3.3318(4) and 3.3382(5) Å (FIG. 16d). The gold-gold bonds in δ are longer then those observed in 13α, 13β, and 13γ.

Polymorphism has been extensively investigated in coordination polymers, with structural differences between polymorphic forms attributed to connectivity, interpenetration, and degree of solvent inclusion (pseudo-polymorphism).^{133,153,163,167-169} Even the widely investigated prototypical Prussian Blue-like system, Mn[Fe(CN)₆], has been observed in two polymorphic forms: the standard rock-salt structure, and the doubly interpenetrated form.¹⁷⁰

In the case of the four polymorphs 13α-13δ all have a zinc centre in a tetrahedral geometry. The difference between the networks of 13α and 13δ, and the diamond-like networks of 13β and 13γ is due to the pathway connecting zinc centres. Furthermore, the four polymorphs differ in the degree of interpenetration, decreasing from six to three from 13α to 13δ respectively. In all of the polymers the interpenetration is supported by gold-gold bonds ranging from 3.11-3.34 Å. While it is generally believed that a lower degree of interpenetration is ideal for creating empty cavities,¹⁵⁷ it is interesting to note that 13β has a significantly lower density then the other polymorphs, despite the relatively high degree of interpenetration.^{123,171,172}

### 2.2.6 Thermal Stability

All four polymorphs are stable until at least 350° C., after which they begin to decompose, losing all of the cyanide groups in one step between 350-390° C. Thus, despite the different levels of interpenetration and supporting gold-gold networks, the four polymorphs show very similar thermal stabilities. In addition, DSC measurements of 13α-13δ over the range 25-300° C. show no indication of a phase change from one polymorph to another.

### 2.2.7 Photoluminesence

Gold (I) centres which are separated by less then 3.6 Å (the sum of the Van der Waals radii for gold)¹⁷³ are said to show gold-gold (aurophilic) bonding;¹⁷⁴ such systems are known to be potentially luminescent. As a result of their interesting emission properties, compounds containing gold-gold bonds have received a great deal of attention.¹⁷⁵⁻¹⁷⁸ In the crystal structures of 13α-13δ, network interpenetration is supported via gold-gold bonds on the order of 3.11-3.34 Å and indeed, 13α-13γ are emissive when exposed to UV light at room temperature.

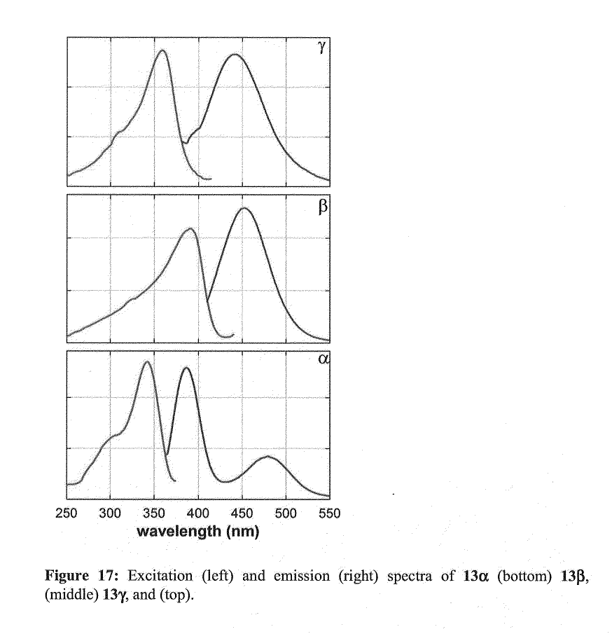

The photoluminescence spectra of 13α-13δ are summarized in Table 12. Compound 13α shows two emission bands at 390 and 480 nm (FIG. 17) at room temperature. The excitation spectra show an identical excitation maximum at 345 nm for both emission bands (FIG. 17 bottom). However, for crystals, or densely packed powder samples of 13α, the 480 nm emission band can be directly excited at 390 nm with a concomitant change in the relative intensities of the 390 and 480 nm emissions. The lifetimes of both emission energies were measured in order to determine the nature of the emission. The 390 nm emission has a lifetime of 240 ns while the 480 nm emission has a lifetime of 930 ns. Based on this data and the lifetimes of other Au(CN)₂⁻-based coordination polymers,^{179,180} the 390 and 480 nm emissions are assigned to a singlet (flouresence) and triplet (phosphoresence) emission respectively. Due to the large spin-orbit coupling of gold, phosphoresence is generally the predominant emission pathway. The presence of both types of emission, as in 13α, is less common.¹⁸⁰

In contrast, 13β and 13γ show only one emission band with similar energies at 450 and 440 nm respectively (Table 12, FIG. 17). For 13δ, despite the presence of gold-gold bonds, hand-picked single crystals of δ showed no observable room temperature luminescence. The absorption spectra of 13α-13γ showed that the lowest energy absorption band is consistent with the lowest fluorescence excitation energy, confirming that the observed emissions are attributed to the polymorphs. Other Au(CN)₂⁻-based coordination polymers have also shown excitation and emission energies in this range.^{175,178,181}

It has been observed both theoretically and experimentally that the gold-gold distances in a structurally related series of metal-metal bonded gold(I) systems are inversely proportional to the emission energies. Indeed, the low energy, phosphoresence, emissions of 13α-13γ obey this trend; on average, shorter gold-gold bonds in a (3.11 and 3.16 Å) emit at lower energy than the gold-gold bonds in 13β (3.1471(11)-3.2702(6) Å) and 13γ (3.29 Å). A plot of average Au—Au distance vs. emission energy yields a straight line and also predicts that 13δ should emit at around 427 nm. However, a non-emissive decay pathway may be more prevalent in 13δ at room temperature, rendering it truly non-emissive.

### 2.2.8 Response to Ammonia Exposure

Based on the sensitive and dramatic visible and IR spectral response of the related Cu[Au(CN)₂]₂(H₂O)₂ system to ammonia gas as described above, the response of the colourless polymorphs 13α-13δ to ammonia vapour was examined, with particular focus on possible emission changes acting as a sensory output. Ammonia detectors have a variety of applications in agriculture, the automotive industry, industrial refrigeration, medical diagnosis, and anti-terrorism.¹⁸² From a health perspective, the human nose is capable of sensing ammonia at a concentration of 50 ppm, but the permissible long term exposure limit of ammonia is below this, at 20 ppm.^{182,183} For these reasons, the design of materials for the detection of ammonia is of great interest.

When the four polymorphs 13α-13δ were exposed to a large excess of NH₃ gas, a new white powder was formed, the IR spectrum of which contained only one υ_{CN} band at 2141 cm⁻¹, indicative of free Au(CN)₂⁻ units. The IR spectrum also showed the presence of metal-bound ammonia,¹⁸⁴ suggesting that the zinc(II) centre is either tetrahedral, coordinated by four ammonia units, or octahedral, coordinated by six ammonia units; the former is more likely on the basis of typical Zn(II)-ammine coordination chemistry¹⁸⁵⁻¹⁸⁷ and thus this ammonia-saturated powder is tentatively formulated as {Zn(NH₃)₄[Au(CN)₂]₂} 15. The room temperature luminescence spectrum of this ammonia-saturated complex shows a single emission peak at 430 nm with an excitation band at 365 nm (FIG. 19). Unfortunately, rapid loss (seconds) of some of the ammonia occurs when the sample is unsealed, precluding further structural or elemental analysis.

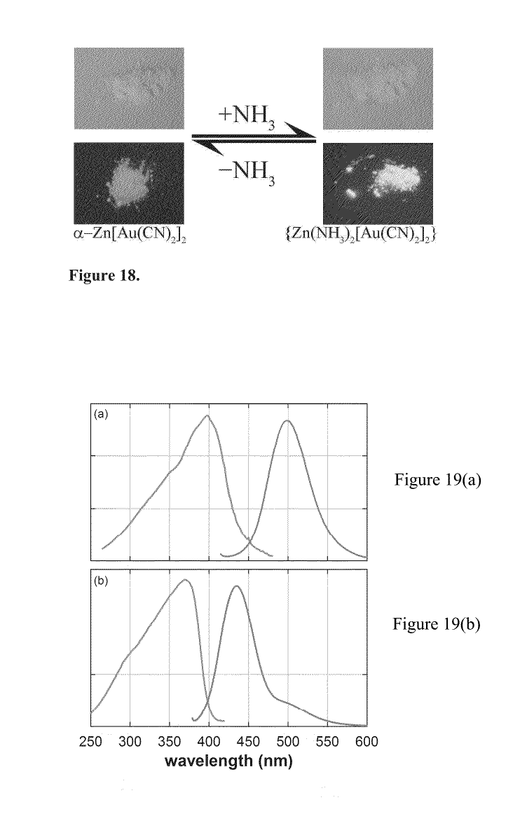

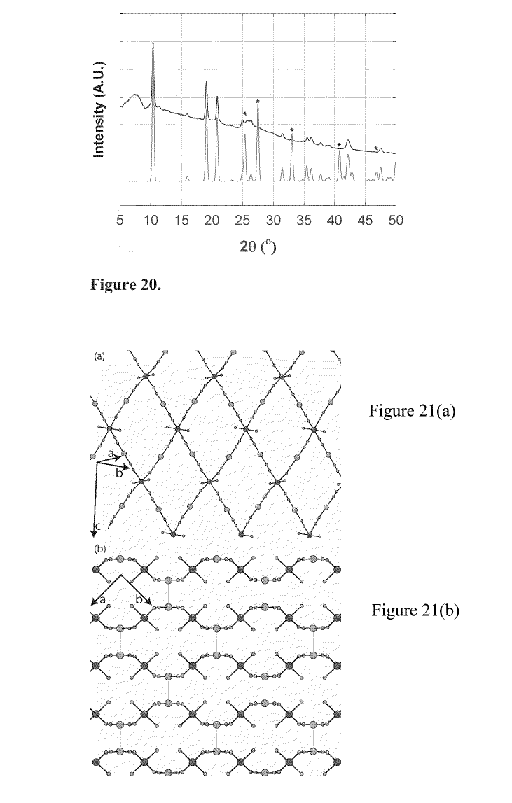

Removal from the ammonia-rich atmosphere and subsequent rapid loss of excess ammonia from {Zn(NH₃)₄[Au(CN)₂]₂} 15 generates a yellow powder (FIG. 18), which is stable in the absence of ammonia for 30 minutes. Elemental analysis of this yellow powder is consistent with a bis-ammonia adduct of Zn[Au(CN)₂]₂13, namely {Zn(NH₃)₂[Au(CN)₂]₂} 14. The IR spectrum of {Zn(NH₃)₂[Au(CN)₂]₂} 14 shows a single υ_{CN} band at 2158 cm⁻¹, suggesting that all of the Au(CN)₂⁻units occupy a similar environment. Furthermore, the vibrational modes associated with the ammonia molecule suggest a metal-bound amine is present.¹⁸⁴ Comparison of the powder X-ray diffractogram of {Zn(NH₃)₂[Au(CN)₂]₂} 14 to other closely related bis-ammonia coordination polymers¹⁸⁸ reveals a similar diffractogram to both {Cd(NH₃)₂[Ag(CN)₂]₂}¹⁴⁹ and {Cu(NH₃)₂[Ag(CN)₂]₂}.¹⁸⁹ The powder pattern of the cadmium polymer is a better fit, which is consistent with the fact that both zinc(II) and cadmium(II) do not contain the Jahn-Teller axis present in the copper(II) system. Using the Cd-system as a starting model, the solid-state structure of {Zn(NH₃)₂[Au(CN)₂]₂} was determined by fitting atomic coordinates to the experimental powder X-ray diffraction pattern. A good match was obtained (FIG. 20), except for the {21l} reflections. These planes intersect Zn atoms, making them sensitive to NH₃ gain/loss, and are thereby much broader in comparison with the remaining peaks. Consistent with the IR data, the structure contains an octahedral zinc centre in D₄ₕ geometry having trans-ammonia molecules and four N-bound cyanides. Linking through the Au(CN)₂⁻ units, the zinc centres form a 2-D corrugated sheet (FIG. 21a),^{160, 161} with Au(CN)₂⁻ units at the apex of the corrugation.¹⁴⁹ Additional parallel sheets stack via gold-gold bonds of 3.06 Å (FIG. 21b-left). Rather then forming chains or sheets of gold-gold bonds as in 13α, 13β and 13δ, only discrete dimers of Au(CN)₂⁻ units are found, similar to 13γ. A second set of sheets are inclined and interpenetrated through the aforementioned parallel sheets.¹⁶⁰ These perpendicular sheets show no close gold-gold bonds or other interactions to one another. Room temperature photoluminescence of {Zn(NH₃)₂[Au(CN)₂]₂} 14 shows a single emission band at 500 nm with an excitation at 400 nm (FIG. 19), which also matches the Au—Au distance/energy correlation graph.

The TGA of {Zn(NH₃)₂[Au(CN)₂]₂} 14 shows a drop starting at room temperature and ending at 95° C. The mass loss is consistent with a loss of two equivalents of ammonia (% loss observed 6%; calculated 5.7%). As the temperature is increased a second loss from 350 to 390° C. is observed, consistent with decomposition of the polymer via cyanide loss and formation of ZnO and Au (% loss observed 15.2%; calculated 14.7%), as seen for 13α-13δ. However, this ammonia loss also occurs without heating: if {Zn(NH₃)₂[Au(CN)₂]₂} 14 is left open to air for 30 minutes all ammonia molecules are released, leaving behind a white powder of Zn[Au(CN)₂]₂ 13. Interestingly, the X-ray powder diffractogram of this ammonia-free product indicated that a mixture of both 13α and 13δ polymorphs had been generated. However, the ratio of the two polymorphs is sample-dependent; cases ranging from pure 13α to pure 13δ and various ratios in between have all been observed (the controlling factor remains unclear). Photoluminescence spectra of the mixtures is consistent with the luminescence of 13α, and mixtures of 13α and non-emissive 13δ. It is important to note that reintroduction of ammonia vapour to any mixture of 13α:13δ, or even to pure δ, invariably regenerates the saturated {Zn(NH₃)₄[Au(CN)₂]₂} 15 complex, followed by the bis-ammonia complex {Zn(NH₃)₂[Au(CN)₂]₂} 14 (as confirmed by powder X-ray diffraction measurements in situ) upon removal of the ammonia-rich atmosphere.

In order to probe the mechanism of adsorption/desorption,¹⁹⁰ titration of all four polymorphs with sequential equivalents of NH₃, monitoring the υ_{CN} stretch in the IR, was investigated. Titration of 13α and 13δ reveals that they bind ammonia in a stepwise fashion (Equation 5), first converting to {Zn(NH₃)₂[Au(CN)₂]₂} 14 (υ_{CN} 2158 cm⁻¹) and then to {Zn(NH₃)₄[Au(CN)₂]₂} 15 (υ_{CN} 2141 cm⁻¹). This reaction is completely reversible; i.e., loss of ammonia regenerates the same polymorph. However, titration of 13β and 13γ reveals that the tetraaminezinc(II) complex forms directly (Equation 6), with no intermediate of {Zn(NH₃)₂[Au(CN)₂]₂} observed. Apparently, sufficient ammonia must be present to break all the bonds between the zinc(II) and the four cyanides in order for initial NH₃-uptake to occur. Due to the adsorption routes for the four polymorphs, it is clear that once {Zn(NH₃)₄[Au(CN)₂]₂} is formed from 13β and 13γ, these polymorphs cannot be regenerated upon NH₃-desorption; mixtures of 13α and 13δ are produced instead.

(α/δ)Zn[Au(CN)₂]₂+2NH_{3(g)}→{Zn(NH₃)₂[Au(CN)₂]₂}

{Zn(NH₃)₂[Au(CN)₂]₂}+2NH_{3(g)}→{Zn(NH₃)₄[Au(CN)₂]₂} (5)

(β/γ)Zn[Au(CN)₂]₂+4NH_{3(g)}→{Zn(NH₃)₄[Au(CN)₂]₂}

{Zn(NH₃)₄[Au(CN)₂]₂}→{Zn(NH₃)₂[Au(CN)₂]₂}+2NH_{3(g)} (6)

Porosity measurements on all four polymorphs showed no adsorption of nitrogen gas at 77 K. Despite this, 13α-13δ reversibly bind ammonia vapour. It is well-known that non-porous coordination polymers can be quite flexible in the solid-state.^{129,190,192} The d¹⁰ zinc(II) cation can adopt several geometries encompassing coordination numbers from two to six;^{177,193} undoubtedly, this flexibility facilitates the structural rearrangement which occurs as the ammonia interacts with the zinc(II) centre. Note that although NH₃-binding occurs at Zn(II), it is the array of Au(CN)₂⁻units that act as the sensor, as the structural rearrangement changes the gold-gold distance and thus the emission energy.

As discussed above, ammonia sensors are used in a wide range of settings.¹⁸² For each application there are different requirements for an ideal sensor, including detection limits (0.1 ppb-200 ppm), response times (seconds-minutes), and operating temperatures (0-500° C.).¹⁸² Due to the highly varying requirements there are several different types of sensors employed in the detection of ammonia. Some common ammonia-sensor materials include conducting compounds based on metal-oxides¹⁹⁴⁻¹⁹⁶ or polymers such as polypyrrole¹⁹⁷ and polyaniline;¹⁹⁸ other sensors are based on spectrophotometric determination.^{199,200} While metal oxide-based sensors are very common, they require a high operating temperature, making them unsuitable in some applications, e.g. medical diagnostics.¹⁸² Conversely, although atomic absorption-based sensing can be operated at room temperature with high sensitivity, it is extremely expensive.¹⁸²

This example clearly shows that all four polymorphs of zinc polymer 13 act as vapoluminescent sensors for ammonia. However, in order to determine if the Zn[Au(CN)₂]₂ materials (which are relatively inexpensive and quite stable) could compete with current NH₃-detection systems, quantitative detection limits for each polymorph were measured, by monitoring the intensity of the {Zn(NH₃)₂[Au(CN)₂]₂} emission band (λₘₐₓ=500 nm, λₑₓ=400 nm) emission band at 520 nm. Although sensitivities of the polymers vary depending on polymorph, the lowest detection limit was observed for 13β, with a NH₃-detection limit of 1 ppb. The response times are also fast: within seconds for all polymorphs. In comparison with other materials used as ammonia sensors, these four coordination polymers have some of the lowest NH₃-detection limits and response times.

In summary, the reaction of various zinc salts with the linear, anionic Au(CN)₂⁻ bridging ligand formed four structurally unique polymorphs, three of which are luminescent at room temperature. Care must be taken when synthesizing these polymorphs since changing the concentration, counterion, pH, and/or solvent can redirect the synthesis from one polymorphic form to another. All four polymorphs reversibly act as very sensitive sensors for ammonia vapour, changing their emission energies as ammonia is bound. The emission can be correlated to the gold-gold array distance in each compound.

### Example 3.0

### Cu(I)-Based Polymers

3.1 Cuₓ[Au₂₋ₓ(CN)₂] (x=1, 1.33) (Solvent) System

The Cu(I)-based polymers described in this example are embodiments of the general formula Mₓ[M′_{y}M“_{2-x-y}(Z)₂] relating to ternary compounds wherein M is Cu, M′ is Au, M” is omitted and Z is CN. In some embodiments M and M′ may have a modified stoichiometry, such as where some of the M′ sites are substituted by M. In a particular example of a “blended” polymer having modified stoichiometry, the molar ratio of Cu:Au may be altered such that one third of the Au sites have been substituted by Cu.

3.2 Synthesis, Structure and Characterization of Cuₓ[Au₂₋ₓ(CN)₂] (x=1, 1.33)

Addition of [Cu(NCMe)₄]OTf to a solution of [Cat][Au(CN)₂] ([Cat]⁺=K⁺,ⁿBu₄N⁺) in a 1:1 stoichiometry results in the instant formation of yellow Cu[Au(CN)₂] (20) powder. The related material having a different molar ratio of Cu:Au, namely CuₓAu₂₋ₓ(CN)₂ (where x=1.33; (22) can also be prepared by adding an excess of 2 molar HNO₃ to a solution containing a 2:1 ratio of [Cu(CN)₄]³⁻ and [Au(CN)₂]⁻. In material 22 having modified stoichiometry one third of the Au sites have been substituted with Cu. The ν_{CN} stretching frequencies in the IR and Raman spectra of both materials are substantially blue-shifted from those in K[Au(CN)₂]. These materials (and those with several other Cu:Au ratios) have been previously reported in the literature via a different preparatory procedure.²⁰²

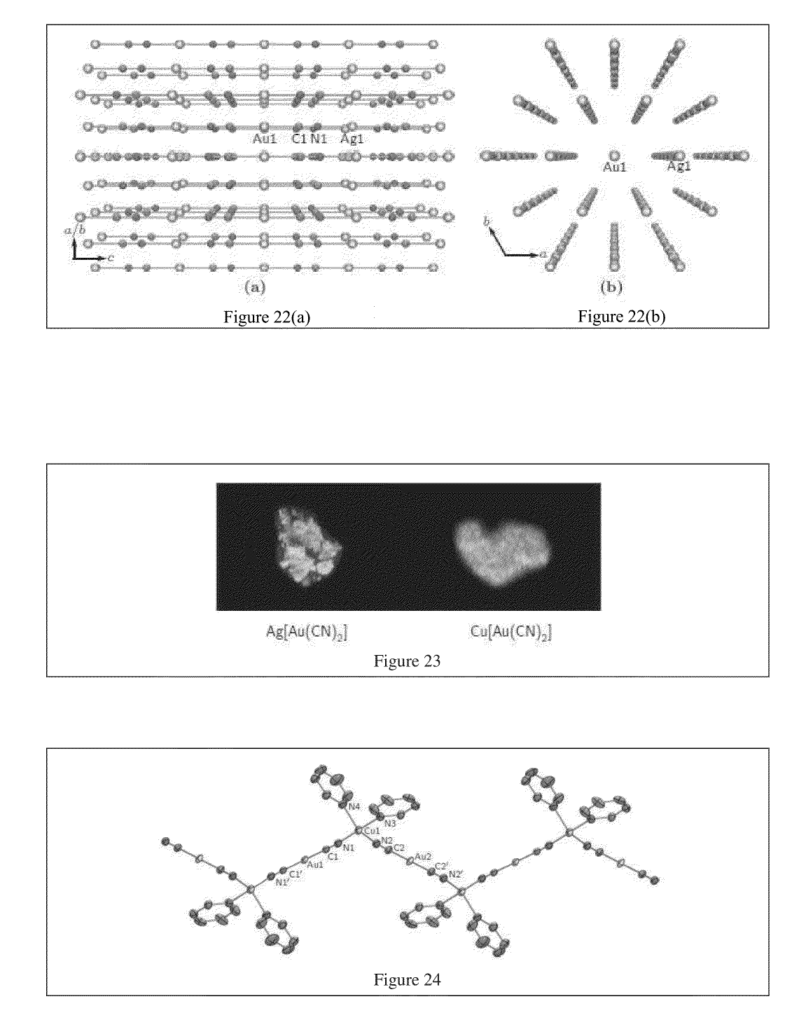

The structures of 20 and 22 have been previously described as analogous to AuCN,^{203,204} consisting of linear chains with alternating Au and Cu centres to which the N(cyano) groups are bound. Although the chains are not disordered within themselves such as in AuCN, each individual chain is offset along the c-axis from its neighbours, such that each layer in the ab plane is a hexagonal arrangement of 50:50 randomized Au and Cu metals. FIG. 22 shows a representative structure of the isostructural Ag-analogue displaying this behavior (with the metals shown as a random distribution of atoms in FIG. 22b). The thermal stability of solid samples of 20 was determined by TGA, indicating that 20 is stable at temperatures up to about 300° C., where loss of cyanogen occurs, as indicated by a sharp drop in mass. This fairly high thermal stability (which has been previously reported)²⁰² makes 20 and its analogues promising for use in device applications.

Both solids 20 and 22 emit a dull, low-intensity red light when irradiated by broad-band UV light at room temperature (see FIG. 23); emission from 22 is markedly weaker than that from 20. Although the emission spectra for 20 and 22 have been reported,²⁰² the ability of these materials to react with small molecules (and the concomitant changes in their emission properties) have not, and therefore their utility as luminescent sensors is novel.

3.3 Cu[Au(CN)₂]-Based Coordination Polymers with Bound Ancillary Ligands

As discussed above, several studies have shown that Cu(I) complexes may emit through Cu-based charge transfer pathways.^{74,75,106-108} This emission is highly sensitive to the type and identity of the ligand bound to the Cu(I) centre. In addition, emission by Au(I)-based materials is sensitive to the Au—Au distance, which is in turn sensitive to the crystallographic geometry.^{18,205} These characteristics combined make 20 an exceptionally useful platform for sensing a wide variety of small molecules. The Cu(II)-based material Cu(OH₂)₂[Au(CN)₂]₂ can bind N- and O-donating molecules, such as H₂O, dimethyl formamide (DMF) and MeCN, which can be thought of as “hard.” By comparison, the relative softness of Cu(I) with respect to Cu(II), and even Zn(II), results in a propensity for analogous materials containing copper in the lower oxidation state to bind softer S- and P-donors.²⁰⁶ Described below are a set of reactions that survey the ability of 20 and 22 to incorporate N-, S- and P-donors in solution, and the structures and emission properties of the resulting products.

Cu(py)₂[Au(CN)₂] (20.py).

Addition of an MeCN solution of [ⁿBu₄N][Au(CN)₂].0.5H₂O to a 1:10 py/MeCN solution containing [Cu(NCMe)₄]OTf results in pale yellow crystals of Cu(py)₂[Au(CN)₂] (20.py). The crystal structure adopted by this material is a simple 1-D zig-zag chain of tetrahedral Cu(I) centres, bridged by [Au(CN)₂]⁻building blocks. The additional tetrahedral sites are occupied by py ligands (see FIG. 24). No Au—Au interactions are present in 20.py.

The structural motif adopted by this compound resembles several similar materials reported consisting of tetrahedral Cu(I) centres bridged simply by a cyano unit, with pyridine derivatives and other N-donors occupying the remaining two sites.²⁵ Other, similar motifs with three-coordinate Cu(I) centres have also been reported.^{25,107}

Cu₃(THT)₄[Au(CN)₂]₃ (20.THT-A).

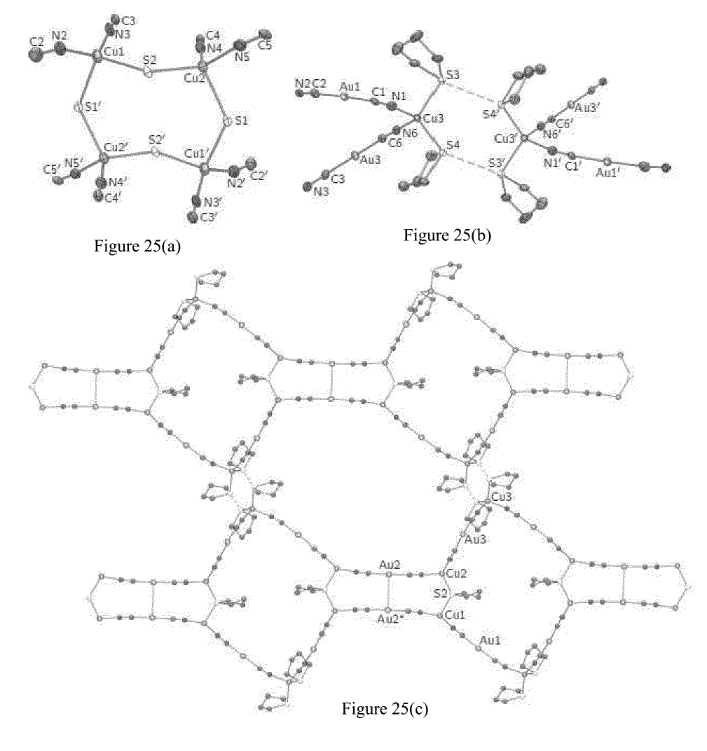

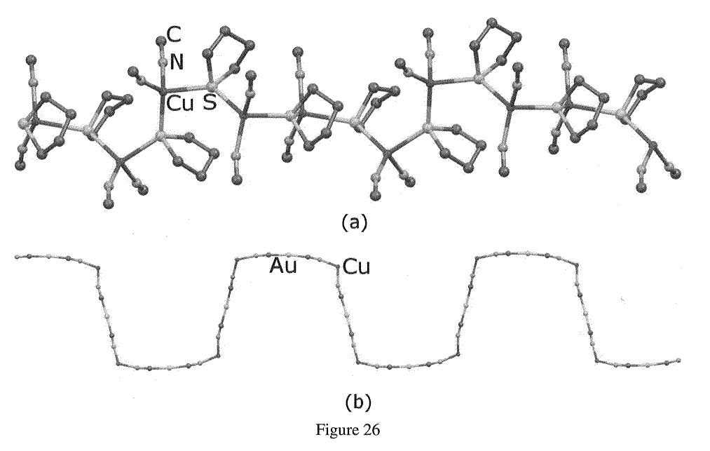

In an analogous synthesis to that of 20.py, where a 1:10 THT/MeCN solution is used instead of py/MeCN, white Cu₃(THT)₄[Au(CN)₂]₃ (20.THT-A) crystals formed. The structure adopted by this compound is significantly more complicated than those above. This structure is built from three crystallographically unique tetrahedral Cu(I) centres. Bound to each of these centres are two bridging [Au(CN)₂]⁻units, forming an undulating chain in 1-D. The remaining two coordination sites on Cu1 and Cu2 are occupied by THT molecules which bridge to a neighbouring Cu(I) centre, as seen in FIGS. 25a and 25b. These bridging THT molecules create an eight-membered ring of alternating Cu and S atoms, connecting the aforementioned chains to neighboring chains (rotated 180° from the first), resulting in a 1-D ladder-like construct (see FIG. 25c). On Cu3, the bound THT molecules do not bridge to another Cu(I) centre, but form interchain S—S interactions of 3.575(3) Å (c.f. sum of van der Waals radii of 3.60 Å),¹⁷³ which connect neighbouring “ladders.” In the third dimension, additional layers and interpenetrating networks of these sheets interact with each other via Au—Au interactions of 3.2145(5), 3.3570(5) and 3.5601(6) Å (not shown). Table 13 contains a list of selected bond lengths and angles for this complex material.

There are several examples of complexes incorporating THT as either a pendant or bridging ligand such as the case here.^{65,92,107,207-211} It is usually found bound to softer metals such as second and third row transition metals such as silver,⁶⁵ gold,²⁰⁸ tantalum²⁰⁷ and others, however it has also been found on some first row transition metals such as iron and magnesium.²⁰⁹ Several examples have also shown THT bound to Cu(I) centres, with typical Cu—S distances observed in the range 2.28-2.47 Å, since they are soft relative to other first row transition metals.^{92,107,210}

This structure clearly shows sulfur's propensity to bridge metal centres via its two lone pairs of electrons. Structures (including clusters) in which two metal centres are bridged by sulfur are well known.^{212,213} In addition, the soft nature of sulfur atoms, in similar fashion to the relatively soft bromine and iodine atoms, have often resulted in S—S interactions such as those observed here. Typical interaction distances range from 3.4-4.0 Å with interaction energies of 11-14 kJ/mol.^{214,215}

Cu(THT)[Au(CN)₂] (20.THT-B).

Depending on the concentration of THT used in the reaction, Cu(THT)[Au(CN)₂] (20.THT-B) may form. In this case, rather than Cu—S—Cu—S— rings, helical chains of Cu(I) atoms bridged by THT molecules form (FIG. 26a.) In the other dimension, [Au(CN)₂]⁻ units bridge the Cu(I) nodes in a ‘square-wave’ motif (FIG. 26b); an additional interpenetrating structure exists, which interacts with the primary framework via aurophilic interactions.

Cu(dithiane)[Au(CN)₂] (20.dithiane).

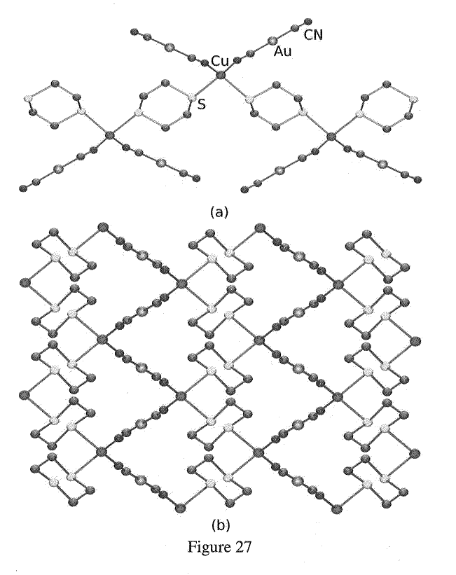

When [Cu(NCMe)₄]OTf, 1,4-dithiane (dithiane) and [Bu₄N][Au(CN)₂]H₂O are reacted in MeCN, the white solid Cu(dithiane)[Au(CN)₂] (20.dithiane) forms. Although this procedure is prone to producing an instant microcrystalline precipitate, addition of a very small amount of pyridine slows this precipitation, yielding X-ray quality crystals of 20.dithiane. Single crystal X-ray analysis reveals the solid state structure (FIG. 27) which is characterized by zig-zag chains of [Au(CN)₂]⁻units bridging Cu(I) centres. Each dithiane molecule also bridges Cu(I) centres, which increases dimensionality and results in a 3-D framework overall.

Cu(SMe₂)[Au(CN)₂] (20.Me₂S) and Cu(SEt₂)[Au(CN)₂] (20.Et₂S).

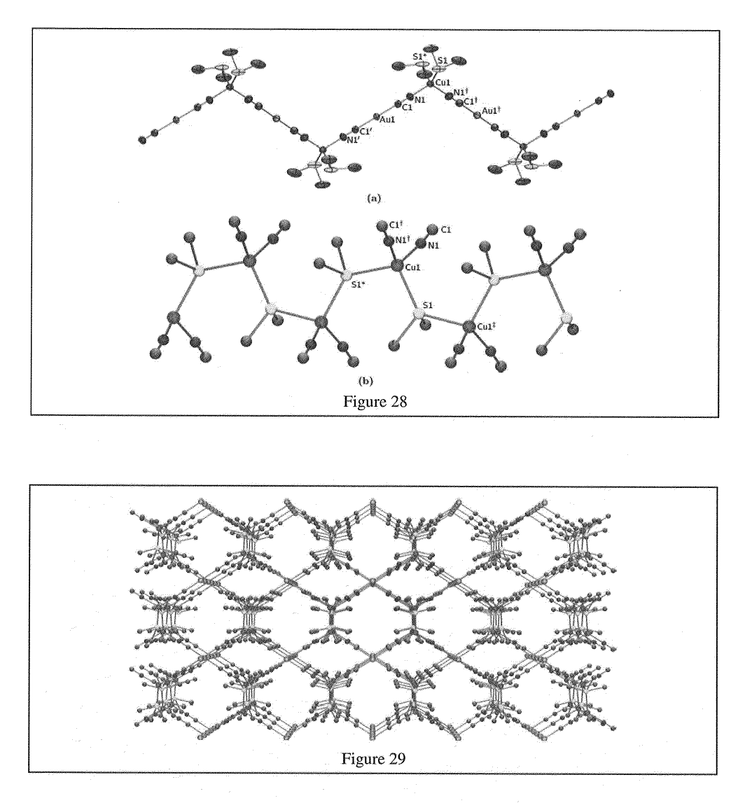

When THT is replaced by Me₂S (at the same concentration) in the synthesis described above, white Cu(SMe₂)[Au(CN)₂] (20.Me₂S) results. Much like 20.py, this structure contains a zig-zag arrangement of tetrahedral Cu(I) centres bridged by [Au(CN)₂]⁻units (FIG. 28a.) However, the Me₂S units occupying the remaining coordination sites on the Cu(I) centres form bridges to adjacent zig-zag chains in a similar fashion to the THT molecules in 20.THT (FIG. 28b.) This material desolvates rapidly when removed from the mother liquor, which results in conversion back to 20 (as confirmed by IR and Raman spectral analysis.)

Because the neighbouring chains are offset, an overall 3-D framework forms (FIG. 29). Occupying the resultant voids is an independent interpenetrating network that interacts with the primary network via Au—Au contacts of 3.396(1) Å; thus, the system is not porous. Table 14 contains a list of selected bond lengths and angles.

The Et₂S-containing analogue, Cu(SEt₂)[Au(CN)₂] (20.Et₂S) is made similarly. It is isomorphous with 20.Me₂S.

In summary, the Cu(I) centres in polymer 20 have a propensity to bind not only N-containing molecules, but also those that contain S and P, and can therefore act as sensors for these classes of molecules in solution. Polymer 22 having a modified stoichiometry shows similar reactivity to the analytes in solution as the parent material 20.

### 3.4 Thermal Stability of Cu(I)-Based Coordination Polymers Containing Ancillary Ligands

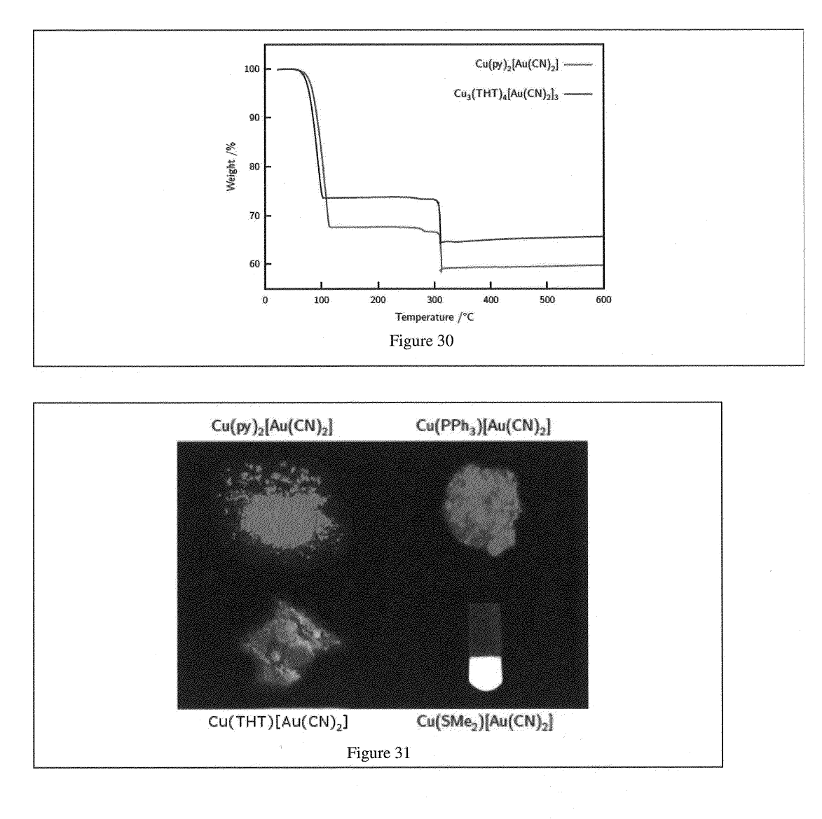

Like 20, all of the coordination polymers containing ancillary are stable with respect to oxidation to Cu(II) under normal atmosphere at room temperature. In order to determine whether or not the ligand molecule can be removed from the material without decomposition of the parent framework (20), TGA data were recorded for 20.py and 20.THT-B. The results are shown in FIG. 30.

In both cases, the py or THT molecule is cleanly lost at the mild temperature of about 90° C., and the materials convert to 20. These results, together with the observed desolvation of 20.Me₂S to 20 under normal atmosphere at room temperature, are good indicators for the use of 20 as a sensor for VOCs.

3.5 Emission and Vapochromic (Vapoluminescent) Properties of Cu(I)-Based Coordination Polymers Cu[Au(CN)₂] with and without Bound Analytes

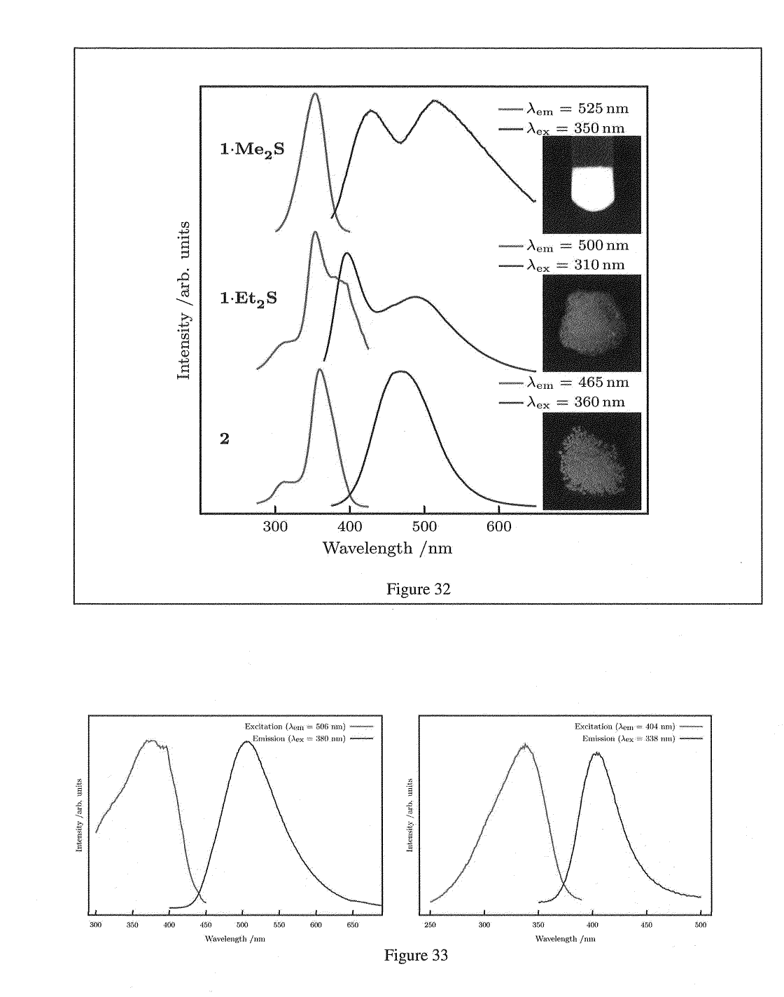

The series of 20.analyte compounds were photographed under broad-band excitation (FIGS. 31 and 32.) Selected spectra at distinct excitation/emission wavelengths are given in FIGS. 32 and 33. Most compounds emit a distinct colour: while 20.py and Cu(PPh₃)(NCMe)[Au(CN)₂] emit a similar turquoise colour, 20.THT-B emits purple, 20.Et₂S emits a pale aquamarine colour, and 20.Me₂S emits white light. Thus, when various ligands are bound to the Cu(I) centre, the emission changes appreciably, which suggests that 20 could be used as a vapochromic sensor by monitoring emission peaks (i.e., the compounds exhibit strong vapoluminescence). As an example, 20.py emits at 506 nm (green) upon excitation at 380 nm. From a sensor application perspective, when the solid 20 is exposed to py vapour, it converts to Cu(py)₂[Au(CN)₂] within minutes, and can be reversed thermally without decomposition of the Cu[Au(CN)₂] framework. There is effectively no contribution to the emission by the parent 20 at this wavelength, which makes this an effective “turn-on” sensor. However, the parent 20 does not respond in the solid-state to vapours of most analytes; in particular, it exhibits no change in emission upon exposure to vapours of sulfur-donors such as Me₂S or Et₂S.

By contrast, 22 (i.e., Cu_{1.33}Au_{0.67}(CN)₂ in which a third of the Au-sites have been substituted by Cu and the Cu:Au ratio is 2:1)²⁰² does react with a wider range of vapour-phase analytes in the solid-state (see Table 16 for a summary of its reactivity with various analytes); this is attributed to the reduced number of stabilizing aurophilic interactions in the material, which increases the structural flexibility of the metal-cyanide chains. For example, upon exposure to pyridine, the emission of 22 changes from a dull orange to a bright green colour within several minutes, that is, on a time scale similar to 20's response to pyridine. In this case, however, gradual loss of pyridine under normal atmosphere results in partial irreversible oxidation of the Cu(I) centres to Cu(II); a similar effect occurs on exposure to THT vapour. On the other hand, when 22 is exposed to Me₂S (forming 22.Me₂S), the emission rapidly changes (i.e., within seconds) to an intense blue colour. Powder X-ray diffraction (PXRD) data for 22.Me₂S show that a single phase, isomorphous to 20.Me₂S, is formed, presumably with the chemical formula Cu(Me₂S)[{Cu_{0.33}Au_{0.67}}(CN)₂]. When left under normal atmosphere at room temperature, 22.Me₂S loses thioether over several hours and converts cleanly to the parent 22. Analogous results are obtained with Et₂S.

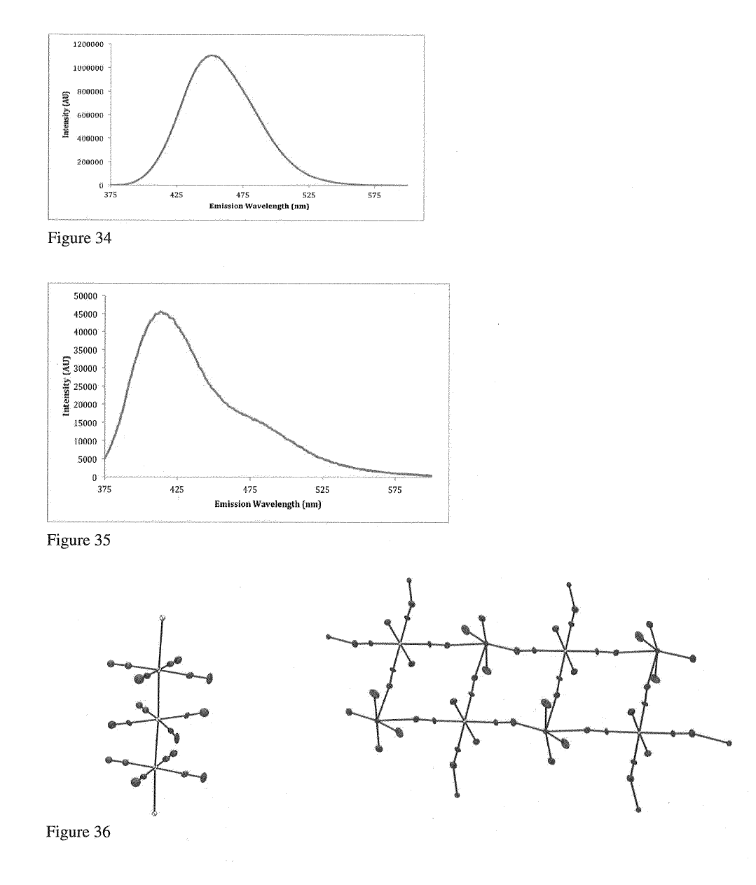

When excited at 362 nm, 22 emits at 451 nm (FIG. 34). When excited at 362 nm, the Et₂S adduct 22.Et₂S emits primarily at 414 nm (FIG. 35). This indicates that materials with different molar ratios of M=Cu/Ag/Au in the formula MₓM′₂₋ₓ(CN)₂ can also act as vapoluminescent sensors for nitrogen and sulfur-containing analyte vapours, even when the parent compound does not; the ternary compounds MₓM′_{y}M″_{2-x-y}(CN)₂] (x, y between 0 and 1; M, M′ and M″=Au, Ag, Cu) should also have utility in this application.

The adduct 20.Me₂S is also of particular note due to its nearly white emission. There is great interest in developing white light emitters, especially those that can be tuned, for applications such as in OLED technology and general lighting.^{99,216-218} The emission spectrum of 20.Me₂S, as shown in FIG. 32, contains two emission bands: one relatively intense peak in the UV region at 429 nm and a much broader peak centred in the visible region at 515 nm. This broad peak, which encompasses most of the visible region, in combination with the sharp blue peak, gives rise to the observed white emission. Studies in the literature on Cu/S cluster-like materials (containing Cu—S bonds) suggest that the emission bands arise from a combination of ligand-to-metal charge-transfer and metal-centred emission bands;⁹² white light emitting Cu(I)-based materials such as 20.Me₂S are rare.

The material 22 was also tested for its ability to detect the small molecules Me₂S, Et₂S and pyridine in both hexanes and aqueous solutions at concentrations as low as 1% by volume. After suspending 22 in the solution containing the analyte, the mixture was shaken for 30 seconds at room temperature, and its emission under broad-band UV light was observed for any changes. The 22 material did not dissolve in any of the solutions and there was no emission from the solutions themselves. When exposed to aqueous or hexanes solutions of Me₂S in concentrations as low as 1% v/v, 22 underwent an immediate change from its native orange emission to an intense blue colour. A similar change was observed for Et₂S, however this change occurred only in aqueous solution. When this test was repeated with an aqueous or hexanes solution of pyridine, the emission changes to a yellow colour (again with a pyridine concentration as low as 1% v/v). Table 16 summarizes these results.

### 3.6 Summary of Experimental Results

The materials Cu[Au(CN)₂] (20) and Cu_{1.33}Au_{0.67}(CN)₂ (22) act as vapochromic sensors with the Cu(I)-based emission serving as sensory readout. Incorporation of the soft Cu(I) metal centre enables the sensing S- or P-containing molecules. A series of coordination polymers with the general formula 20.L (L=py, THT, Me₂S, Et₂S) was synthesized, isolated, and structurally characterized. Most members of this set had unique emission wavelengths, which validated the general concept of using coordination polymers as sensors. The 20.Me₂S material emits white-light upon UV-excitation. Solid 22 also acts as a vapoluminescent sensor and, critically, reversibly binds thioether vapours, which results in dramatic changes in emission. In addition, when suspended in aqueous or hexanes solutions containing Me₂S, Et₂S, or pyridine, 22 exhibits an immediate change in emission analogous to that observed for its reaction with the respective vapours.

### 3.7 General Procedure and Physical Measurements for Experiments of Example 3.0

General Procedure and Physical Measurements.

All reactions were performed in air. All reagents were obtained from commercial sources and used as received. Infrared spectra were measured on a Thermo Nicolet Nexus 670 FT-IR spectrometer equipped with a Pike MIRacle attenuated total reflection (ATR) sampling accessory. Raman spectra were measured using a Renishaw inVia Raman microscope equipped with a 785 nm laser. Solid-state UV-visible reflectance spectra were measured using an Ocean Optics SD2000 spectrophotometer equipped with a tungsten halogen lamp. Microanalyses (C, H, N) were performed on a Carlo Erba EA 1110 CHN elemental analyzer. Thermogravimetric analysis (TGA) data were collected using a Shimadzu TGA-50 instrument in an air atmosphere at 1 or 2 degrees per minute. Solid state luminescence measurements (excitation and emission spectra) were performed at room temperature on a Photon Technology International fluorimeter using a Xe arc lamp and a photomultiplier detector or a Horiba Jobin Yvon Fluorolog fluorimeter. Samples were prepared by drop casting the vapour adducts of 20 or 22 from acetonitrile onto Teflon slides, and placing the slides into a 4-sided quartz cuvette.

Crystallographic Analysis

All crystallographic data (powder and single crystal) were collected on a Bruker SMART ApexII Duo diffractometer equipped with a Mo Kα (single crystal; λ=0.7109 Å) TRIUMPH-monochromated source and a Cu Kα (powder; λ=1.54184 Å) Incoatec microsource using ω and φ scans. All samples were mounted on MiTeGen sample holders using paratone oil. Additional crystallographic information can be found in Table 15. All single crystal diffraction data were processed and initial solutions found with the Bruker ApexII software suite. Subsequent refinements were performed in ShelXle.²¹⁹ Hydrogen atoms were placed geometrically and refined using a riding model. All PXRD powder pattern data were processed using the Broker ApexII software suite. Indexing and Pawley and Rietveld refinements for 20 and 22 were performed using Topas Academic.²²⁰ Diagrams were made using ORTEP-3¹¹⁶ and POV-ray.¹¹⁷

### 3.8 Synthetic Procedures and Chemical Characterizations

Cu[Au(CN)₂] (20).

A (different) preparation for this material has been previously reported.²⁰² Colourless [ⁿBu₄N][Au(CN)₂]0.5H₂O solid (243 mg; 0.486 mmol) was added to a 10 mL MeCN solution of [Cu(NCMe)₄]OTf (0.05 mol/L; 0.5 mmol), resulting in an immediate yellow precipitate of Cu[Au(CN)₂] (20). This suspension was stirred for 10 min, then the Cu[Au(CN)₂] powder was collected by vacuum filtration (131 mg; 86% yield). IR (cm⁻¹): 2208 (s; ν_{CN}). Raman (cm⁻¹): 2224 (s; ν_{CN}), 592 (w), 339 (m). Anal calcd. for C₂N₂AuCu: C, 7.67%; H, 0.00%; N, 8.96%. Found: C, 8.43%; H, 0.11%; N, 9.19%.

Cu(py)₂[Au(CN)₂] (20.py).

3.5 mL of py/MeCN (1:6) was added to a 2 mL colourless MeCN solution of [Cu(NCMe)₄]OTf (0.05 mol/L; 0.1 mmol), resulting in no discernible colour change To this, a 5 mL colourless solution of [ⁿBu₄N][Au(CN)₂]0.5H₂O (61 mg; 0.12 mmol) was added, again resulting in no discernible colour change. This solution was partially covered and set aside for slow evaporation. After about one hour, colourless needle-shaped crystals of Cu(py)₂[Au(CN)₂] (20.py) formed, were collected then dried under reduced pressure (17 mg; 36% yield). IR (cm⁻¹): 2201 (vw; ν_{CN}), 2152 (vw; ν_{CN}), 1595 (s), 1482 (m), 1443 (vs), 1260 (w), 1212 (w), 1149 (w), 1068 (m), 1034 (m), 1006 (w), 752 (s). Raman (cm⁻¹): 2169 (s; ν_{CN}), 1596 (m), 1220 (w), 1214 (m), 1069 (w), 1036 (m), 1008 (s), 653 (w), 625 (m), 514 (m), 328 (w), 176 (m), 134 (m). Anal calcd. for C₂N₂AuCu.1.9C₅H₅N (slightly desolvated from C₂N₂AuCu.2C₅H₅N): C, 29.84%; H, 2.07%; N, 11.80%. Found: C, 29.85%; H, 1.96%; N, 11.65%. The same product can also be obtained by vapour absorption of pyridine by 20.

Cu₃(THT)₄[Au(CN)₂]₃ (20.THT-A) and Cu(THT)[Au(CN)₂] (20.THT-B).

3.5 mL of THT/MeCN (1:6) (THT=tetrahydrothiophene) was added to a 2 mL colourless MeCN solution of [Cu(NCMe)₄]OTf (0.05 mol/L; 0.1 mmol), resulting in no discernible colour change. To this, a 5 mL colourless solution of [ⁿBu₄N][Au(CN)₂].0.5H₂O (50 mg; 0.10 mmol) was added, again resulting in no discernible colour change. This solution was partially covered and set aside for slow evaporation. After one day, colourless needle or plate-shaped crystals of Cu₃(THT)₄[Au(CN)₂]₃ (20.THT-A) and Cu(THT)[Au(CN)₂] (20.THT-B) formed in different amounts depending on the actual THT concentration, were collected then dried under reduced pressure (25 mg; 58% yield). IR (cm⁻¹): 2164 (vs; ν_{CN}); 2943 (s), 2857 (m), 1439 (s), 1267 (s), 1256 (s), 1146 (w), 1030 (m), 952 (m), 881 (m). Raman (cm⁻¹): 2185 (s; ν_{CN}), 2179 (s; ν_{CN}), 1438 (m), 1269 (w), 1254 (m), 1211 (w), 1197 (w), 1131 (w), 1069 (w), 1031 (m), 956 (m), 880 (m), 814 (w), 762 (s), 527 (w), 471 (m), 411 (w), 327 (m), 212 (w), 177 (w), 126 (w). Anal. Calcd. for C₂N₂AuCu.1.33C₄H₈S (5.THT-A): C, 20.48%; H, 2.50%; N, 6.51%. Found C, 20.13%; H, 2.29%; N, 6.59%. Anal calcd. for C₂N₂AuCu.C₄H₈S (5-THT-B): C, 17.98%; H, 2.01%; N, 6.99%. Found: C, 18.16%; H, 1.39%; N, 7.02%.

Cu(SMe₂)[Au(CN)₂] (20.Me₂S).

3.5 mL of Me₂S/MeCN (1:6) was added to a 2 mL colourless MeCN solution of [Cu(NCMe)₄]OTf (0.05 mol/L; 0.1 mmol), resulting in no discernible colour change. To this, a 5 mL colourless solution of [ⁿBu₄N][Au(CN)₂].0.5H₂O (50 mg; 0.10 mmol) was added, again resulting in no discernible colour change. This solution was partially covered and set aside for slow evaporation. After a few minutes, colourless needle-shaped crystals of Cu(SMe₂)[Au(CN)₂] (1.Me₂S) formed, were collected then air dried (10 mg; 27% yield). This material desolvates to 20 within an hour when left in ambient air. λₑₓ=353 nm, λₑₘ=429, 515 nm IR (cm⁻¹): 2167 (vs; ν_{CN}); 2924 (w), 1421 (m), 1034 (m), 980 (s). Raman (cm⁻¹): 2185 (s; ν_{CN}), 733 (w), 679 (s), 525 (w), 327 (w). Anal calcd. for C₂N₂AuCu.C₂H₆S: C, 12.82%; H, 1.61%; N, 7.48%; S, 8.56%. Found: C, 12.46%; H, 1.64%; N, 7.56%; S, 8.33%.

Cu(SEt₂)[Au(CN)₂] (20.Et₂S).

3.5 mL of Et₂S/MeCN (1:6) was added to a 2 mL colourless MeCN solution of [Cu(NCMe)₄]OTf (0.05 molL⁻¹; 0.1 mmol), resulting in no discernible colour change. To this, a 5 mL colourless solution of [Bu₄N][Au(CN)₂]H₂O (48 mg; 0.10 mmol) was added, again resulting in no discernible colour change. This solution was partially covered and set aside for slow evaporation. After a few minutes, colourless needle-shaped crystals of Cu(SEt₂)[Au(CN)₂] formed, were collected then air dried (10 mg; 27% yield). IR (cm⁻¹): 2163 (vs; ν_{CN}); 2992 (w), 2976 (m), 2934 (m), 2870 (w), 1449 (m), 1371 (s), 1288 (w), 1258 (s), 1045 (w), 983 (m), 789 (s).

Cu(dithiane)[Au(CN)₂]. (20-dithiane)

A 1 mL MeCN solution of [Cu(NCMe)₄]OTf (0.5 molL⁻¹; 0.5 mmol) was diluted to 5 mL with additional MeCN. To this, solid white 1,4-dithiane (78 mg; 0.65 mmol) was added, resulting in no discernible colour change. Solid white [Bu₄N][Au(CN)₂]H₂O (249 mg; 0.498 mmol) was then added with mixing, resulting in a white suspension. After being left in a sealed vessel overnight, the white solid of Cu(dithiane)[Au(CN)₂] was collected by gravity filtration and washed three times with 5 mL of MeCN (173 mg; 80% yield). This solid emits an intense blue colour under broad band UV light. IR (cm⁻¹): 2162 (s; ν_{CN}); 2960 (m), 2919 (m), 2910 (m), 1410 (vs), 1402 (s), 1297 (w), 1274 (m), 1162 (m), 1152 (w), 1003 (w), 902 (vs), 894 (s).

### Example 4.0

### Pb(II) Cyanoplatinate (II) Polymers

4.1 Pb[Pt(CN)₄](solvent)ₓ) System

In this example Pb(II) cyanoplatinate (II) polymers for use as reversible sensors for halogens, including chlorine, and S-donors, including H₂S, are described. Sensing of Cl₂ gas is an important area of research especially for pharmaceutical and paper and pulp industries. H₂S has wide applications including in the oil/gas sector²²¹⁻²²³ While several Cl₂ and H₂S sensors are already commercially available, many are disadvantaged by requiring high temperatures for regeneration,²²⁴ or react irreversibly and are thus effectively single-use. Pt(II) compounds are well known to react with halogens via oxidative addition in solution to give Pt(IV) compounds.^{225,226} Reductive eliminations of halogen in solution have been reported in a few cases (e.g., from [Pt^{IV}(CN)₄X₂]²⁻ to [Pt^{II}(CN)₄]²⁻),²²⁷ but, to the best of the inventors' knowledge, none of these reactions are known to occur in the solid state, nor have they been harnessed in sensing halogen gases. In this example, the inventors determined that substitution of [Au(CN)₂]⁻ by [Pt(CN)₄]⁻ in coordination polymers gives rise to analogues of the inventors' M[Au(CN)₂]-based systems that may respond reversibly to halogen or S-donors such as H₂S in the solid state. In particular, these compounds exhibit changes in their emissive properties as a sensory “readout.”

4.2 Synthesis and Characterization of Pb[Pt(CN)₄](solvent)ₓ (24) and Pb(H₂O)₂[Pt(CN)₄Br₂] (26)

Several [Pt(CN)₄]-based coordination polymers were prepared in this work so that their reactivity with halogens and S-donors in the solid-state could be explored. The synthesis of Ba[Pt(CN)₄] (28), which is known to be highly emissive, was previously reported.²²⁸⁻²³⁰ The inventors also made the new compounds Cd[Pt(CN)₄] (30) and Pb[Pt(CN)₄](solvent) (24) thus: Addition of either Cd(NO₃)₂.6H₂O or Pb(ClO₄)₂.xH₂O to K₂[Pt(CN)₄] in methanol generated Cd[Pt(CN)₄](H₂O)₃ and Pb[Pt(CN)₄](H₂0)_{2.5} respectively as orange/yellow powders. Both materials emit visible light upon excitation with a broad-band UV-source. The Cd-system emits blue, while the Pb-system emits yellow light. Crystals of both systems were obtained and the structures solved for both Cd (Unit Cell: a=9.923; b=10.093; c=10.705 Å; alpha=90; beta=90; gamma=90°) and Pb (Unit Cell: a=17.529; b=16.1951; c=6.556 Å; alpha=90; beta=99.57; gamma=90°). The Cd-material 30 forms 2-D corrugated Cd[Pt(CN)₄] sheets with the Cd(II) cations linked via bridging cyano-nitriles in the sheet; the sheets are separated by planes containing H₂O molecules and there are no platinophilic interactions. The Pb-material 24 forms a 3-D array, where the [Pt(CN)₄]²⁻ anions bridge Pb(II) cations in two directions and also form 1-D stacks via platinophilic interactions (Pt—Pt distance=3.297 and 3.279 Å; FIG. 36-left); the sheets are also connected via Pb—N interactions. Compounds containing Pt—Pt interactions are well-known to be emissive, as is observed here as well.

Similarly, addition of [NBu₄][Pt(CN)₄Br₂] to Pb(ClO₄)₂.xH₂O in methanol and slow evaporation in the dark yielded colourless crystals of the Pt(IV)-based coordination polymer Pb(H₂O)₂[Pt(CN)₄Br₂](26). If the reaction mixture is evaporated under ambient light, a mixture of the intended product and the aforementioned Pb[Pt(CN)₄](solvent)ₓ (24) is generated (by photo-induced reductive elimination of halogen). The crystal structure of Pb(H₂O)₂[Pt(CN)₄Br₂](26) (Unit Cell: a=12.415; b=14.8797; c=6.425 Å; alpha=90; beta=95.614; gamma=90°) shows a 2-D layer structure where the Pt(CN)₄-unit bridges Pb(II) centres and the Pt—Br bonds lie perpendicular to the sheets. Critically, no Pt—Pt interactions remain in this structure, given the octahedral nature of the Pt(IV) centre and its electronic change from d⁸ to d⁶. Consequently, this material is non-emissive.

4.3 Reactivity of Solid Pb[Pt(CN)₄](solvent)ₓ (24) with Cl₂ Vapour and Emissive Changes Thereon

A selection of Pt(CN)₄-based coordination polymers, including Pb[Pt(CN)₄](H₂O)_{2.5} (24), the Cd analogue and Ba[Pt(CN)₄](solvent) were exposed to Cl₂ gas in the solid-state. Neither Cd(H₂O)₃[Pt(CN)₄] nor Ba[Pt(CN)₄](solvent) showed any change in either colour or emission properties even after several hours. On the other hand, Pb[Pt(CN)₄](H₂O)_{2.5} (24) immediately changed colour to deep brown and its emission was completely quenched upon exposure to chlorine. This is likely due to oxidative addition of the chlorine to the Pt(II) centre to generate the Pt(IV) material, which as noted above, does not emit light. Thus, this Pb[Pt(CN)₄]-containing material can act as a sensor for chlorine (and other halogen) gas by monitoring the emission quenching (or, less ideally, the colour change), and/or the change in IR and Raman spectra (which change significantly for both the ν_{CN} and the appearance in the Raman of ν_{PtCl} peaks).

Upon removal from the chlorine gas, the Pb[Pt(CN)₄Cl₂](solvent)ₓ (32) material changes colour from brown to white and generates bright blue/teal emission (upon broad-band UV-excitation) within minutes. The change in emission colour from yellow to blue/teal is likely due to a change in solvation level (or a complete lack of solvation). Critically, re-exposure of this Pb[Pt(CN)₄Cl₂](solvent)ₓ (32) material to chlorine gas caused a return to the deep brown colour and emission quenching, and removal of the solid from the chlorine gas caused the solid to rapidly revert back to the white, blue/teal-emitting Pb[Pt(CN)₄](solvent)ₓ (24). Thus, the Pb[Pt(CN)₄]-containing material not only acts as a sensor for halogen gas, but it acts as a reversible sensor.

Upon exposure of Pb[Pt(CN)₄](solvent)ₓ (24) to 500 ppm of H₂S in a nitrogen stream, the orange material with yellow emission converted to a red coloured-material with a red emission, and concomitant changes in the IR from 2119, 2123, 2125 (sh) for 24 to 2115, 2129, 2144 cm⁻¹. Upon removal from the H₂S, the material reverted to the original colour and emission of 24. Thus, the Pb[Pt(CN)₄]-containing material not only acts as a sensor for H₂S gas, but it acts as a reversible sensor.

### 4.3 Summary of Experimental Results

Solid-state samples of Pb[Pt(CN)₄](solvent)ₓ (24) react reversibly with gaseous halogens and H₂S as evidenced by reversible quenching of (or shift in) their emission spectra. This demonstrates the suitability of this material in halogen-sensing or H₂S-sensing devices.

### 4.4 General Experimental Procedure, Physical Measurements and Crystallographic Analysis

The general experimental procedure, physical measurements and crystallographic analysis for this Example 4.0 was generally as described above in respect of Example 3.0.

### 4.5 Synthetic Procedures and Chemical Characterizations

Pb[Pt(CN)₄](solvent)ₓ (24).

K₂Pt(CN)₄] and Pb(ClO₄)₂ were each dissolved in 10 mL of methanol. The colourless lead solution was added via Pasteur pipette to the colourless platinum solution, generating an orange precipitate upon mixing. The supernatant was separated from the powder via centrifuging and washing with methanol (3×). The solution was left to slowly evaporate and orange needles of Pb[Pt(CN)₄](H₂O)_{2.5} (88 mg, 66.6% yield) (24) were isolated and crystallographically solved. IR: νCN=2125, 2123, 2119 cm⁻¹. The IR signals of the powder precipitate and crystalline product matched, indicating that they are the same material. The material emits yellow light upon long-wave UV-excitation. Excitation/emission data (298K): Excitation at 389 or 540 nm, emission at 570 nm. Emission data (77K): 593 nm. Upon heating, Pb[Pt(CN)₄](H₂O)_{2.5} loses water and initially generates a red/pink powder of the form Pb[Pt(CN)₄](H₂O)ₓ (x<2.5, IR: vCN=2114, 2129, 2143 cm⁻¹), which weakly emits a peach colour and upon further heating generates pale yellow Pb[Pt(CN)₄](H₂O)_{y} (y<x), which emits blue/teal. These dehydrates (vs. 24) species both re-hydrate to 24 in ambient air.

Cd[Pt(CN)₄](H₂O)₃ (30)

K₂Pt(CN)₄] (38 mg, 0.10 mmol) and Cd(NO₃)₂ (47 mg, 0.12 mmol) were each dissolved in 5 mL of deionized H₂O. The colourless cadmium solution was added via Pasteur pipette to the colourless platinum solution, generating a white precipitate upon mixing. The supernatant was separated from the powder via centrifuging and washing with water (3×). The solution was left to slowly evaporate and colourless, luminescent blue blocks of Cd[Pt(CN)₄](H₂O)₃ (30) were isolated and crystallographically solved. The IR: vCN=2180(s), 2160(m), 2145(w), 2133(w) (broad) cm 1.

[ⁿBu₄N]₂[PtBr₂(CN)₄].

A 10 mL H₂O solution of [ⁿBu₄N]Br (735 mg; 2.28 mmol) was added to a 15 mL yellow solution of K₂[PtBr₂(CN)₄] (510 mg; 0.983 mmol), resulting in an immediate yellow precipitate of [ⁿBu₄N]₂[PtBr₂(CN)₄] which was collected by vacuum filtration and allowed to air-dry overnight (755 mg; 81% yield). IR (cm⁻¹): 2160 (m; ν_{CN}); 2962 (vs), 2936 (s), 2875 (s), 1483 (s), 1381 (m), 1153 (w), 1032 (w), 880 (m), 751 (w). Anal. calcd for C₃₆H₇₂N₆Br₂Pt: C, 45.81%; H, 7.69%; N, 8.90%. Found: C, 46.11%; H, 7.40%; N, 9.03%.

Pb(H₂O)₂[Pt(CN)₄Br₂] (26).

[NBu₄][Pt(CN)₄Br₂] (90 mg, 0.1 mmol) and Pb(ClO₄)₂ (55 mg, 0.12 mmol) were each dissolved in 5 mL of methanol. The colourless lead solution was added via Pasteur pipette to the yellow platinum solution with no instant precipitate or change upon addition. The mixture was left to slowly evaporate and over one week the solution was colourless with orange powder rings along the edge of the vial. Further evaporation resulted in orange needle crystals (identified as Pb[Pt(CN)₄](methanol)ₓ (24), identical to that described above) as well as colourless plates of Pb(H₂O)₂[Pt(CN)₄Br₂] (26), which were crystallographically solved.

Addition of Cl₂ gas to Pb[Pt(CN)₄](Solvent) (24) and Analogues.

Approximately 3 mg of the test compound (e.g. Pb[Pt(CN)₄](H₂O)_{2.5} (24), the Cd analogue, Ba[Pt(CN)₄](solvent) etc.) was placed in powder form in the bottom of a 1-dram vial inside a Schlenk tube. To this tube was added 1 atm of Cl₂ gas. The change in colour and emission (by using a long-wave UV hand-held lamp) of the powder upon exposure to Cl₂ was observed directly. The Cd(solvent)[Pt(CN)₄] complex (newly synthesized in the inventors' laboratory) and Ba[Pt(CN)₄](solvent) showed no change in either colour or emission properties even after several hours of exposure to chlorine. The Pb[Pt(CN)₄](H₂O)_{2.5} (24) system changed colour to deep brown and its emission was completely quenched. Removal of the vial from the Schlenk tube into the open air resulted in a change in colour to white and the generation of a bright blue emission within minutes. IR vCN=2222, 2188, 2157 cm⁻¹. Re-exposure to chlorine gas caused a return to deep brown colour and emission quenching, which rapidly reverts back to the white, blue-emitting product upon removal of the chlorine.

Addition of H₂S Gas to Pb[Pt(CN)₄](Solvent) (24).

Approximately 3 mg of Pb[Pt(CN)₄](H₂O)_{2.5} (24) was placed in powder form in the bottom of a 1-dram vial inside a three necked-flask. To this tube was added a flow of 500 ppm of H₂S gas in nitrogen. The change in colour and emission (by using a long-wave UV hand-held lamp) of the powder upon exposure to H₂S was observed directly within minutes. This change was monitored by changes in the IR vCN spectral region (IR of H2S-exposed species: 2115, 2129 & 2144 cm⁻¹). Upon removal from the H₂S environment, the material reverts within an hour to 24. Re-exposure to hydrogen sulfide gas regenerated the red species. The Cd[Pt(CN)₄](H₂O)₃ powder showed no change in either colour or emission properties even after several hours of exposure to 500 ppm of hydrogen sulfide in nitrogen.

### Example 5.0

### Uranyl (UO₂²⁺) Cyanometallate Polymers

### 5.1 UO₂[Au(CN)₂]-Containing Systems

In this example uranyl UO₂²⁺ cyanoaurate(I) polymers for use as sensors for O-donors, including aldehydes such as formaldehyde and furfural, are described. Sensing of formaldehyde gas has wide industrial applications; furfural is of interest as a degradation product in electrical transformers.

5.2 Synthesis and Characterization of [ⁿBu₄N]₂[(UO₂)₂(μ²-O₂)(NO₃)₂(μ²-Au(CN)₂]₂ (34), [UO₂(bipy)(MeO)(MeOH)]₂[(μ²-Au(CN)₂)Au(CN)₂] (36) and K(UO₂)(μ³-O)₂(NO₃)₂(UO₂)(Au(CN)₂].nMeCN (38)

The uranyl (UO₂²⁺) ion is known to have strong emission properties that could be potentially exploited as a sensory output if incorporated into coordination polymers²³¹⁻²³⁴; indeed, existing uranium-based coordination polymers have wide-ranging chemical and physical properties.^{235-246.} The uranyl cation is classified as “hard”, thereby favouring oxygen-type ligands and donor analytes. However, only a few such materials contain any metal other than uranium (i.e., most are homo-metallic) and only a handful of actinide cyanometalate coordination polymers are known.²⁴⁷⁻²⁵⁰ Given that [Au(CN)₂]- and [Pt(CN)₄]-based materials are often emissive due to metallophilic interactions, it is of interest to mate these anions with the potentially emissive uranyl cation and examine changes in emission (from either the cyanometallate or the uranyl cation or both) as a function of analyte. In particular, there are no reported uranyl-cyanoaurate(I) materials.

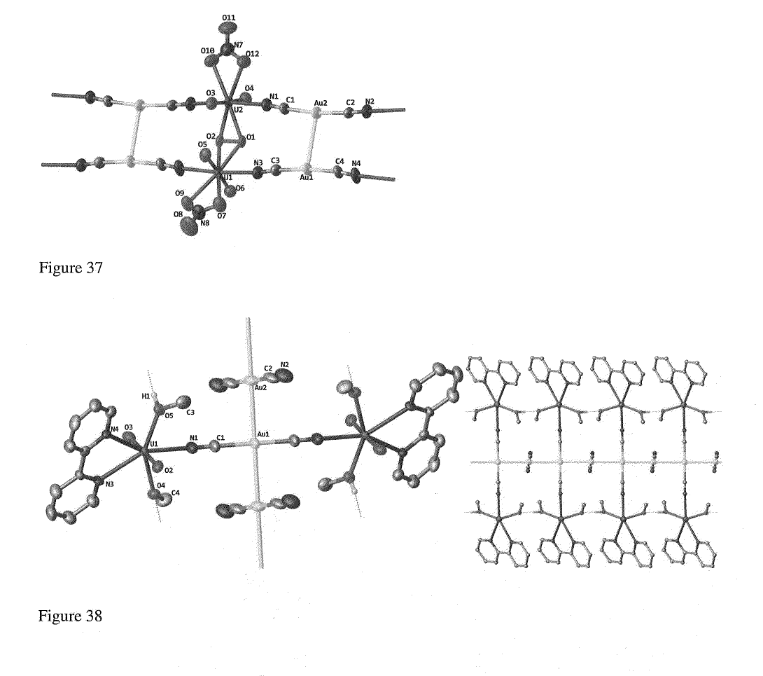

Thus, several UO₂²⁺-based [Au(CN)₂]-containing coordination polymers were prepared in this work so that their reactivity with aldehydes and other potential analytes (especially O-donors) in the solid-state could be explored. Dropwise addition of a tetrabutylammonium dicyanoaurate solution to a uranyl nitrate solution in ambient light produced yellow crystals of [ⁿBu₄N]₂[(UO₂)₂(μ²-O₂)(NO₃)₂(μ²-Au(CN)₂]₂ (34) (Unit Cell: a=11.1498; b=32.6853; c=14.5715 Å; alpha=90; beta=94.48; gamma=90°). The structure contains a 1-D ladder along the a-axis, composed of two chains of uranium centres connected by dicyanoaurate (U-NCAuCN-U), with U N distances of 2.495(8), 2.501(8), 2.503(8), and 2.504(8) Å. The two chains are connected by bridging bidentate peroxo ligands between the uranium (generated by uranyl photoredox chemistry in air), and also by aurophilic interactions (FIG. 37). Compound 34 emits a weak yellow/green colour at room temperature and a more intense green emission at 77K upon excitation with a broad-band UV-source.

The addition of 2,2′-bipyridine to a solution of tetrabutylammonium dicyanoaurate and uranyl nitrate produced red crystals of [UO₂(bipy)(MeO)(MeOH)]₂[(μ²-Au(CN)₂)Au(CN)₂] (36) (Unit Cell: a=6.1056(9); b=12.5052(18); c=13.1277(10) Å; alpha=113.61(1); beta=97.04(1); gamma=99.80(1°). In the solid-state, the uranium(VI) centre in 31 is pentagonal bipyramidal, with bipyridine, a methoxy and a methanol group in the equatorial plane as well as a terminally bound Au(CN)₂-unit. The Au(I) centres form aurophilic interactions with adjacent free [Au(CN)₂] units to propagate a 1-D aurophilic chain with 3.0528(5) Å Au—Au bonds (FIG. 38). Compound 36 is non-emissive to the eye at 298 and 77K when excited with a broad-band UV-source.

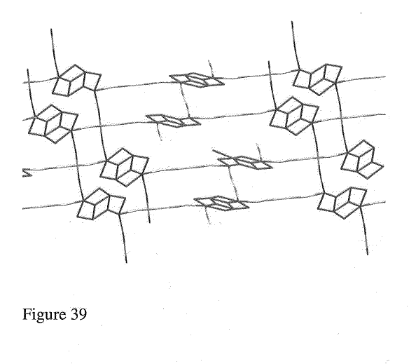

The solvothermal reaction of uranyl nitrate and K[Au(CN)₂] in acetonitrile yields K(UO₂)(μ³-O)₂(NO₃)₂(UO₂)(Au(CN)₂].nMeCN (38), a three-dimensional coordination polymer (Unit Cell: a=30.0072(14); b=15.8664(9); c=7.7487(4) Å; alpha=90; beta=99.71(1); gamma=90°) where the repeat unit is a potassium/uranium/oxygen cluster, connected into a sheet by K—O interactions; each sheet is further connected via bridging dicyanoaurate units (FIG. 39). The voids between the sheets are filled with MeCN solvent molecules. Coordination polymer 38 emits a typical uranyl-based green colour at both 298K and 77K.

5.3 Reactivity of Solid Uranyl-Cyanoaurate Materials 34-38 with Aldehydes, DMF and Emissive Changes Thereon

Three uranyl-cyanoaurate compounds 34, 36 and 38 were exposed to dimethylformamide (DMF), formaldehyde and furfural vapours in the solid-state. No changes were observed for 34 at room temperature. On exposure to DMF followed by a temperature reduction to 77 K compound 36 begins to emit green light upon excitation with broadband ultraviolet light irradiation; in the absence of DMF, no emission is observed. Upon exposure to formaldehyde or furfural vapours, the emission of 38 is quenched, but upon removal from the aldehyde-containing atmosphere, the green emission is regenerated; there was no sensory response to aldehydes from 36. Thus, certain uranyl-cyanoaurate containing materials can act as a reversible sensor for aldehydes such as formaldehyde and furfural, while others can act as sensors for DMF.

### 5.4 Summary of Experimental Results

Solid-state samples of compound 36 react reversibly with gaseous aldehydes as evidenced by reversible quenching of their emission spectra. This demonstrates the suitability of this class of materials for use in aldehyde sensing devices.

### 5.5 General Experimental Procedure, Physical Measurements and Crystallographic Analysis

The general experimental procedure, physical measurements and crystallographic analysis for this Example 5.0 was generally as described above in respect of Example 3.0; the exposure experiments were generally as described above in respect of Example 4.0 but using DMF or aldehydes such as formaldehyde and furfural as vapour analytes.

### 5.6 Synthetic Procedures and Chemical Characterizations

[ⁿBu₄N]₂[(UO₂)_{z}(μ²-O₂)(NO₃)₂(μ²-Au(CN)₂]₂ (34)

To a 3 mL methanol solution of tetrabutylammonium dicyanoaurate (250 mg, 500 μmol), a 4 mL methanol solution of uranyl nitrate hexahydrate (126 mg, 251 μmol) was added dropwise. The solution was then allowed to slowly evaporate at room temperature in ambient light for 13 days, at which point bowtie shaped clusters of small yellow needles formed. The solution was then allowed to slowly evaporate for an additional 14 days, at which point the crystals were collected and washed with methanol. The remaining solvent was kept and additional crystals were collected after 16 days, giving 39 mg of product in total (29.9% yield). Anal. Calcd. for C₃₆H₇₄Au₂N₆O₆U₂: C, 25.75%; H, 4.32%; N, 6.67%. Found: C, 25.34%; H, 4.16%; N, 6.59%. IR (2 cm⁻¹ resolution, cm⁻¹): 2965, 2940, 2876, 2230, 2177, 1628, 1623, 1616, 1576, 1569, 1559, 1540, 1493, 1483, 1469, 1462, 1419, 1379, 1290, 1030, 921, 878, 741. Raman (785 nm, cm⁻¹): 124, 188, 251, 330, 509, 743, 840, 863, 907, 1031, 1130, 1320, 1446, 2198.

[UO₂(bipy)(MeO)(MeOH)]₂[μ²-Au(CN)₂)Au(CN)₂] (36)

To a 3 mL methanol solution of tetrabutylammonium dicyanoaurate (50 mg, 100 μmol) methanol solutions of uranyl nitrate hexahydrate (3 mL, 25 mg, 50 μmol) and 2,2′-bipyridine (1 mL, 8 mg, 50 μmol) were added dropwise. The solution was then allowed to slowly evaporate at room temperature in ambient light. After three days, roughly spherical clusters of small red needles was observed. After an additional 28 days the crystals were collected, with a total mass of 58 mg (39.5% yield). Anal. Calcd. for C₂₈H₂₈Au₂N₈O₈U₂: C, 22.81%; H, 1.91%; N, 7.60%. Found: C, 23.13%; H, 1.73%; N, 8.00%. IR (2 cm⁻¹ resolution, cm⁻¹): 2169, 2133, 1602, 1597, 1565, 1530, 1494, 1475, 1434, 1314, 1275, 1240, 1219, 1176, 1152, 1100, 1068, 1027, 1015, 1002, 914, 840, 761, 734. Raman (785 nm, cm⁻¹): 630, 551, 766, 838, 858, 1016, 1035, 1069, 1312, 1493, 1566, 1596, 2148, 2188.

K(UO₂)(μ³-O)₂(NO₃)₂(UO₂)(Au(CN)₂].nMeCN (38).

Uranyl nitrate hexahydrate (200 mg, 400 μmol) and potassium dicyanoaurate (232 mg, 800 μmol) were flame-sealed in 4 ampoules with 3 mL of acetonitrile each. The ampoules were then heated to 125° C. under autogenous pressure over the course of three hours. It was held at this temperature and pressure for 12 h then allowed to cool to room temperature over the course of 96 hours. 12 mg (6.2%) of yellow crystals of 32 were isolated and washed with acetonitrile.

### Example 6.0

Example 6.0 describes vapochromic polymers or reaction products having the general formula M_{W}[M′_{X}(Z)_{Y}(Z′)_{O}]_{N}, for example Pb[Pt(CN)₄(X)₂] where X is a halogen such as Cl. In this embodiment the Z component is replaced by a combination of Z and Z′, for example in a ratio of 4:2. In one embodiment the product may reversibly detect a halogen, such as a chlorine as described in Example 4.0 above in respect of product (32). The M component could be Pb or another metal such as Cu, as described below.

Synthesis of Cu(OH₂)₂[PtCl₂(CN)₄] (40)

K₂Pt(CN)₄Cl₂] (42 mg, 0.09 mmol) and Cu(ClO₄)₂.6H₂O (45 mg, 0.12 mmol) were both dissolved separately in 2 mL of water. The light blue copper solution was added via Pasteur pipette to the yellow platinum solution resulting in an instant light blue precipitate. The product, Cu(OH₂)₂[PtCl₂(CN)₄] (21 mg, 51.22% yield) was isolated by a 3× centrifuge and rinse in water. Anal. calcd for C₄H₄N₄O₂Cl₂Pt: C, 10.23%; H, 0.86%; N, 11.93%. Found: C, 10.27%; H, 0.88%; N, 11.57%. (Unit Cell: a=7.243; b=10.131; c=7.236 Å; alpha=90; beta=89.949; gamma=90°) The material packs in two dimensional sheets where the cyanides of [Pt(CN)₄Cl₂]²⁻ bridge Cu(II) centres with chlorines oriented perpendicular to the sheets. Exposure to pyridine vapour results in a change in colour from light blue to dark blue and a change in IR from vCN=2237 cm⁻¹ to 2223 (m) cm⁻¹ including the emergence of many peaks in the fingerprint region that are indicative of the presence of pyridine: 1612 (s), 1451 (s), 1075 (m), 758 (m). Exposure to ammonia vapour results in a blue powder and exposure to DMF (dimethylformamide) results in a baby-blue powder. Similar results can be obtained for the Ni-analogue of this material.

### Example 7.0

Some mercury (Hg)-based materials have been developed.

HgPt(CN)₄ (42)

K₂Pt(CN)₄—H₂O (38 mg; 0.096 mmol) was dissolved in 10 mL of a 2.7 M aqueous solution of HNO₃. Hg(NO₃)₂.xH₂O (77 mg, 0.23 mmol) was dissolved in 15 mL of a 2.7 M aqueous solution of HNO₃. The K₂Pt(CN)₄ solution was added to the Hg(NO₃)₂ solution, forming a precipitate instantaneously. The precipitate was left to settle under a foil pyramid. After an hour, the precipitate was collected via centrifuge, washed by centrifuging with water 3 times, and transferred to a Petri dish with acetonitrile to air-dry. Mass of yellow HgPt(CN)₄ (42) recovered: 25 mg (0.05 mmol; 52% yield). IR (ATR): 2204 (s), 2142 (s) cm⁻¹. Raman: 2155 (s), 2222 (s) cm⁻¹. Fluorimetry: λₑₓ=273 (vw), 330 (sh), and 382 (s) nm; λₑₘ=459 nm.

Hg[Au(CN)₂]₂ (44)

This polymer is a related form of the Zn-material, with the same structure as 13γ described above.

KAu(CN)2 (51 mg; 0.18 mmol) was dissolved in 10 mL of a 2.7 M aqueous solution of HNO3. Hg(NO3)2.xH2O (77 mg; 0.23 mmol) was dissolved in 15 mL of a 2.7 M aqueous solution of HNO3. The KAu(CN)2 solution was added to the Hg(NO3)2 solution, forming a precipitate instantaneously. The precipitate was left to settle under a foil pyramid. After three hours, the precipitate was filtered, rinsed with 3×5 mL H2O, and air-dried. Mass of pale yellow Hg[Au(CN)₂]₂ (44) recovered: 20 mg (0.029 mmol; 16% yield). IR (ATR): 2171 cm-1 (s).

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

TABLE 1
Crystallographic Data and Structural Refinement Details

| | 1 (Green) | 2 (Blue) | 3 | 4 |
|---|---|---|---|---|
| empirical | C₈H₁₂N₄Au₂CuO₂S₂ | C₈H₁₂N₄Au₂CuO₂S₂ | C₇H₇N₅Au₂CuO | C₁₄H₁₀N₆Au₂Cu |
| formula | | | | |
| fw | 717.82 | 717.82 | 634.65 | 719.76 |
| Crystal system | monoclinic | triclinic | monoclinic | monoclinic |
| Space group | C2/c | P 1̅ | C2/c | P2₁/c |
| a, Å | 11.5449(15) | 7.874(7) | 12.8412(10) | 7.3438(7) |
| b, Å | 14.191(4) | 12.761(11) | 14.5056(8) | 14.1201(10) |
| c, Å | 11.5895(12) | 16.207(13) | 13.9932(9) | 8.2696(6) |
| α, deg | 90 | 89.61(7) | 90 | 90 |
| β, deg | 112.536(9) | 82.29(7) | 96.064(3) | 94.082(3) |
| γ, deg | 90 | 88.57(7) | 90 | 90 |
| V, Å³ | 1753.8(6) | 1613.2(24) | 2591.9(3) | 855.34(12) |
| Z | 4 | 2 | 8 | 4 |
| T, K | 293 | 293 | 293 | 293 |
| λ, Å | 0.70930 | 1.54180 | 1.54180 | 1.54180 |
| ρ_{calcd}, g · cm⁻³ | 2.719 | 2.955 | 3.253 | 2.794 |
| μ, mm⁻¹ | 18.079 | 37.500 | 43.542 | 33.103 |
| R₁^{a} (I > xσ(I))^{b} | 0.042 | 0.062 | 0.032 | 0.028 |
| wR₂^{a} (I > xσ(I))^{b} | 0.047 | 0.082 | 0.046 | 0.040 |
| Goodness of fit | 2.20 | 1.38 | 0.93 | 1.00 |

^{a}Function minimized Σw(|Fₒ| − |F_{c}|)² where w⁻¹ = σ²(Fₒ) + 0.0001Fₒ², R = Σ||Fₒ| − |F_{c}||/Σ|Fₒ|, R_{w} = [Σw□|Fₒ| − |F_{c}|)²/Σw|Fₒ|²)^{1/2}.
^{b}For 1, x = 2.5; for 2, 3 and 4, x = 3.

TABLE 2
Selected bond lengths (Å) and angles (°) for Cu[Au(CN)₂]₂(DMSO)₂ (1).

| | | | |
|---|---|---|---|
| Au(1)—Au(2) | 3.22007(5) | Cu(1)—N(2) | 2.107(18) |
| Cu(1)—O(1) | 1.949(7) | Cu(1)—N(3) | 1.965(11) |
| O(1)—Cu(1)—O(1*) | 167.0(6) | Cu(1)—N(2)—C(2) | 180 |
| O(1)—Cu(1)—N(2) | 96.5(3) | Cu(1)—N(3)—C(3) | 178.6(12) |
| O(1)—Cu(1)—N(3) | 87.3(4) | Au(2)—Au(1)—Au(2) | 171.73(3) |
| O(1*)—Cu(1)—N(3) | 88.4(4) | Au(1)—N(1)—C(1) | 180 |
| N(2)—Cu(1)—N(3) | 109.5(4) | Au(1)—N(2)—C(2) | 180 |
| N(3)—Cu(1)—N(3*) | 140.9(8) | Au(2)—N(3)—C(3) | 178.9(12) |
| Cu(1)—O(1)—S(1) | 127.2(6) | C(1)—Au(1)—C(2) | 180 |

Symmetry transformations: (*) −x + 1, y, −z + ½; (′) −x − ½, −y − 5/2, z + 1.

TABLE 3
Selected bond lengths (Å) and angles (°) for Cu[Au(CN)₂]₂(DMSO)₂ (2)

| | | | |
|---|---|---|---|
| Au(1)—Au(2) | 3.419(3) | Au(3) . . . Au(4) | 3.592(4) |
| Cu(1)—O(1) | 2.02(3) | Cu(2)—O(3) | 1.97(3) |
| Cu(1)—O(2) | 1.95(3) | Cu(2)—O(4) | 2.29(3) |
| Cu(1)—N(11) | 2.42(4) | Cu(2)—N(12) | 2.11(4) |
| Cu(1)—N(21) | 1.97(4) | Cu(2)—N(22) | 2.37(5) |
| Cu(1)—N(31) | 2.42(4) | Cu(2)—N(32) | 2.03(5) |
| Cu(1)—N(41) | 1.99(4) | Cu(2)—N(42) | 2.00(5) |
| O(1)—Cu(1)—O(2) | 95.2(12) | O(3)—Cu(2)—O(4) | 93.0(12) |
| O(1)—Cu(1)—N(11) | 85.9(12) | O(3)—Cu(2)—N(12) | 87.8(15) |
| O(2)—Cu(1)—N(11) | 86.4(12) | O(4)—Cu(2)—N(12) | 87.0(14) |
| N(11)—Cu(2)—N(21) | 92.7(14) | N(12)—Cu(2)—N(22) | 92.3(16) |
| N(11)—Cu(2)—N(31) | 172.7(13) | N(12)—Cu(2)—N(32) | 172.0(17) |
| N(11)—Cu(2)—N(41) | 92.6(14) | N(12)—Cu(2)—N(42) | 95.2(17) |
| N(21)—Cu(2)—N(31) | 92.6(15) | N(22)—Cu(2)—N(32) | 91.4(17) |
| N(21)—Cu(2)—N(41) | 90.7(15) | N(22)—Cu(2)—N(42) | 91.2(17) |
| N(31)—Cu(2)—N(41) | 92.3(14) | N(32)—Cu(2)—N(42) | 91.8(18) |
| Cu(1)—O(1)—S(1) | 124.9(17) | Cu(2)—O(3)—S(3) | 125.4(20) |
| Cu(1)—O(2)—S (2) | 124.4(19) | Cu(2)—O(4)—S(4) | 127.9(18) |
| Cu(1)—N(11)—C(11) | 169.2(45) | Cu(2)—N(12)—C(12) | 163.5(50) |
| Cu(1)—N(21)—C(21) | 163.5(41) | Cu(2)—N(22)—C(22) | 159.5(46) |
| Cu(1)—N(31)—C(31) | 161.7(43) | Cu(2)—N(32)—C(32′) | 174.6(45) |
| Cu(1)—N(41)—C(41) | 166.4(33) | Cu(2)—N(42)—C(42) | 170.0(45) |
| C(11)—Au(1)—C(12) | 172.7(25) | C(31)—Au(3)—C(32) | 172.6(18) |
| C(21)—Au(2)—C(22*) | 175.9(23) | C(41*b)—Au(4)—C(42) | 177.9(20) |
| Au(1)—C(11)—N(11) | 175.8(50) | Au(3)—C(31)—N(31) | 171.0(39) |
| Au(1)—C(12)—N(12) | 175.3(58) | Au(3)—C(32)—N(32′^{b}) | 175.6(49) |
| Au(2)—C(21)—N(21) | 173.2(42) | Au(4*^{b})—C(41)—N(41) | 174.2(38) |
| Au(2*)—C(22)—N(22) | 175.2(56) | Au(4)—C(42)—N(42) | 170.1(46) |

Symmetry transformations: (*) −x + 1, −y + 1, −z + 1; (*^{b}) −x + 1, −y, −z + 1; (′) x + 2, y, z − 1; (′^{b}) x − 2, y, z + 1.

TABLE 4
Selected bond lengths (Å) and angles (°) for Cu[Au(CN)₂]₂(DMF) (3).

| | | | |
|---|---|---|---|
| Au(1)—Au(1*^{a}) | 3.3050(12) | Cu(1)—N(2) | 1.990(11) |
| Au(2)—Au(2*^{b)} | 3.1335(13) | Cu(1)—N(3) | 1.961(10) |
| Cu(1)—O(1) | 2.202(12) | Cu(1)—N(4′^{b)} | 1.982(10) |
| Cu(1)—N(1′) | 1.958(10) | O(1)—C(5) | 1.202(17) |
| N(1′^{a})—Cu(1)—N(2) | 89.8(4) | C(1)—Au(1)—C(2) | 176.0(6) |
| N(1′^{a})—Cu(1)—N(3) | 88.7(5) | C(3)—Au(2)—C(4) | 175.4(6) |
| N(4′^{b})—Cu(1)—N(2) | 89.6(5) | Cu(1′^{c})—N(1)—C(1) | 170.1(12) |
| N(4′^{b})—Cu(1)—N(3) | 89.3(5) | Cu(1)—N(2)—C(2) | 172.7(14) |
| N(1′^{a})—Cu(1)—N(4′^{b}) | 166.7(5) | Cu(1)—N(3)—C(3) | 170.8(12) |
| N(2)—Cu(1)—N(3) | 169.2(5) | Cu(1′^{d})—N(4)—C(4) | 172.1(12) |
| O(1)—Cu(1)—N(1′^{a}) | 95.1(5) | Au(1)—C(1)—N(1) | 174.9(13) |
| O(1)—Cu(1)—N(2) | 98.3(5) | Au(1)—C(2)—N(2) | 177.8(14) |
| O(1)—Cu(1)—N(3) | 92.4(5) | Au(2)—C(3)—N(3) | 174.3(13) |
| O(1)—Cu(1)—N(4′^{b}) | 98.1(5) | Au(2)—C(4)—N(4) | 177.5(16) |
| Cu(1)—O(1)—C(5) | 125.4(13) | | |

Symmetry transformations: (*^{a}) −x − 1, y, −z + 3/2; (*^{b}) −x − 1, y, −z + ½; (′^{a}) x, −y, z − ½; (′^{b}) x, −y − 1, z + ½; (′^{c}) x, −y, z + ½; (′^{d}) x, −y − 1, z − ½.

TABLE 5
Selected bond lengths (Å) and angles (°) for Cu[Au(CN)₂]₂(pyridine)₂ (4).

| | | | |
|---|---|---|---|
| Cu(1)—N(1) | 2.016(9) | Cu(1)—N(3) | 2.007(7) |
| Cu(1)—N(2*^{a}) | 2.532(9) | | |
| N(1)—Cu(1)—N(2*^{a}) | 89.5(4) | C(2)—Au(1)—C(1) | 177.8(4) |
| N(1′)—Cu(1)—N(2*^{a}) | 90.5(4) | Cu(1)—N(1)—C(1) | 169.7(9) |
| N(1)—Cu(1)—N(3) | 90.0(3) | Cu(1*^{b})—N(2)—C(2) | 173.3(9) |
| N(1)—Cu(1)—N(3′) | 90.0(3) | Au(1)—C(1)—N(1) | 177.9(9) |
| N(2*^{a})—Cu(1)—N(3) | 90.4(3) | Au(1)—C(2)—N(2) | 177.2(11) |
| N(2*^{a})—Cu(1)—N(3′) | 89.6(3) | | |

Symmetry transformations: (*^{a})x − 1, −y + ½, z − ½; (*^{b}) x + 1, −y + ½, z + ½; (′) −x + 1, −y, −z + 1.

TABLE 6
Maximum Solid-state Visible Reflectance (nm) and Cyanide ν_{CN} Absorptions
(cm⁻¹) for Different Cu[Au(CN)₂]₂(solvent)ₓ Complexes

| | | Maximum | | |
|---|---|---|---|---|
| | | visible | ν_{CN} absorption(s) | |
| Complex | | reflectance | From solution | From adsorption^{a} |
| (1) | Cu[Au(CN)₂]₂(DMSO)₂ | 550 ± 7 | 2183 (s), 2151 (s) | 2184 (s), 2151 (s) (from 5) |
| (2) | Cu[Au(CN)₂]₂(DMSO)₂ | 535 ± 15 | 2206 (m), 2193 (s), | — |
| | | (broad) | 2175 (m), 2162 (m) | |
| (3) | Cu[Au(CN)₂]₂(DMF) | 498 ± 7 | 2199 (s) | 2199 (s) |
| (4) | Cu[Au(CN)₂]₂(pyridine)₂ | 480 ± 15 | 2179 (m), 2167 (s), | 2179 (m), 2167 (s), 2152 (m), |
| | | (broad) | 2152 (m), 2144 (m) | 2144 (m) |
| (5) | Cu[Au(CN)₂]₂(H₂O)₂ | 535 ± 5 | 2217 (s), 2194 (w), | 2217 (s), 2194 (w), 2171 (s) |
| | | | 2172 (s) | (from 1) |
| | | | | 2216 (s), 2196 (w), 2171 (s) |
| | | | | (from 2) |
| (6) | Cu[Au(CN)₂]₂ | 560 ± 20 | 2191 (s) | — |
| | | (v. broad) | | |
| (7) | Cu[Au(CN)₂]₂(CH₃CN)₂ | — | 2297 (w), 2269 (w), | |
| | | | 2191 (s) | |
| (8) | Cu[Au(CN)₂]₂(dioxane)(H₂O) | 505 ± 15 | 2201 (s), 2172 (w) | 2200 (s), 2174 (w) |
| | | (broad) | | |
| (9) | Cu[Au(CN)₂]₂(NH₃)₄ | 433 ± 7 | — | 2175 (m), 2148 (s) |

^{a}All solvent adducts were made from 2 unless specified

TABLE 7
Thermal Decomposition of Different Cu[Au(CN)₂]₂(solvent)ₓ Complexes

| | Temperature | Decomposition product | Weight (%) | |
|---|---|---|---|---|
| Complex | (° C.) | or lost fragment | calcd | found |
| 3 | 195-280 | -DMF | 11.5 | 13.6 |
| | 310-355 | -2 C₂N₂ + O | 13.8 | 11.5 |
| | 400 | CuO + 2 Au | 74.6 | 73.9 |
| 4 | 155-190 | -1 pyridine | 11.0 | 10.9 |
| | 210-260 | -1 pyridine | 11.0 | 12.6 |
| | 310-330 | -2 C₂N₂ + O | 12.2 | 9.2 |
| | 400 | CuO + 2 Au | 65.8 | 66.4 |
| 5 | 140-180 | -2 water | 6.0 | 5.5 |
| | 260-380 | -2 C₂N₂ + O | 14.7 | 13.5 |
| | 400 | CuO + 2 Au | 79.2 | 81.5 |
| 6 | 200-350 | -2 C₂N₂ + O | 15.2 | 15.5 |
| | 400 | CuO + 2 Au | 81.7 | 80.9 |
| 8 | 150-280 | -dioxane-H₂O | 15.9 | 17.5 |
| | 290-330 | -2 C₂N₂ + O | 13.2 | 10.3 |
| | 400 | CuO + 2 Au | 70.9 | 71.1 |
| 9 | 50-95 | -1 NH₃ | 2.7 | 2.8 |
| | 115-220 | -3 NH₃ | 8.1 | 7.5 |
| | 280-350 | -2 C₂N₂ + O | 14.0 | 13.7 |
| | 400 | CuO + 2 Au | 75.2 | 74.4 |

TABLE 8
List of Selected VOCs that 1 can Detect, Spectral Data, and Its Sensitivity

| | | | | | | Minimum | | |
|---|---|---|---|---|---|---|---|---|
| | | | | Minimum | ν_{CN} for 1 | detectable | λₘₐₓ (nm) | Rever- |
| | ν_{CN} for 1 | λₘₐₓ | Response | detectable | (VOC) at | concentration | at | sible |
| | (solvent)/ | (nm)/ | time at | concentration | sensitivity | by visible | sensitivity | without |
| VOC | excess | excess | saturation | by IR | limit | reflectance | limit | Heating |
| Compound 1 | 2216, | 532 | N/A | N/A | N/A | N/A | N/A | N/A |
| | 2171 | | | | | | | |
| Ammonia | 2141, | 435 | <5 s | 36 ppb | 2181, | 230 ppb | 510 | No |
| | 2136 | | | | 2151 | | | |
| Methylamine | 2139 | 438 | <8 s | 120 ppb | 2188 | 360 ppb | 495 | No |
| | | | | | 2139 | | | |
| Propylamine | 2143 | 428 | <10 s | 140 ppb | 2185, | 320 ppb | 502 | No |
| | | | | | 2155 | | | |
| Butylamine | 2141 | 460 | 2 min | 100 ppm | 2141 | 860 ppm | 468 | No |
| Diethylamine | 2144 | 478 | 10 min | 600 ppm | 2144 | 1600 ppm | 483 | No |
| Trimethylamine | Not | Not | N/A | N/A | N/A | N/A | Not | N/A |
| | sensitive | sensitive | | | | | sensitive | |
| Ethylenediamine | 2141 | 408 | 10 s | 385 ppb | 2141 | 720 ppb | 415 | No |
| Pyridine | 2140, | 485 | 8 min | 400 ppm | 2193, | 875 ppm | 490 | Yes |
| | 2133 | | | | 2148 | | | |
| | | | | | 2142 | | | |
| Acetonitrile | 2297, | Broad | 10 min | 470 ppm | 2304, | 1120 ppm | Broad | Yes |
| | 2269, | | | | 2266, | | | |
| | 2192 | | | | 2192 | | | |
| DMF | 2199, | 482 | 12 min | 450 ppm | 2199, | 1155 ppm | 488 | Yes |
| | 2171 | | | | 2171 | | | |
| DMSO | 2194, | 485 | 13 min | 1000 ppm | 2194, | 1640 ppm | 485 | Yes |
| | 2176, | | | | 2176, | | | |
| | 2162 | | | | 2162 | | | |

TABLE 9
Crystallographic Data for 13α-13δ and {Zn(NH₃)₂[Au(CN)₂]₂} 14

| | α^{a} | β | γ^{b} | b | {Zn(NH₃)₂[Au(CN)₂]₂}^{b} |
|---|---|---|---|---|---|
| empirical formula | C₄N₄Au₂Zn | C₄N₄Au₂Zn | C₄N₄Au₂Zn | C₄N₄Au₂Zn | C₄H₆N₆Au₂Zn |
| formula weight | 563.40 | 563.40 | 563.40 | 563.40 | 597.45 |
| crystal system | hexagonal | monoclinic | tetragonal | monoclinic | tetragonal |
| space group | P6₄2₂ | C2/c | P4b2 | C2/c | P4₂/mbc |
| crystal habit | hexagons | plates | — | crosses | — |
| a (Å) | 8.4520(10) | 8.90060(10) | 6.8208 | 9.9583(3) | 7.8554 |
| b (Å) | 8.4520(10) | 16.8152(2) | 6.8208 | 10.4988(3) | 7.8554 |
| c (Å) | 20.621(11) | 14.3808(2) | 8.4487 | 15.7961(4) | 17.0937 |
| α (deg) | 90 | 90 | 90 | 90 | 90 |
| β (deg) | 90 | 100.6000(10) | 90 | 98.407(2) | 90 |
| γ (deg) | 120 | 90 | 90 | 90 | 90 |
| V (Å³) | 1275.8(7) | 2115.58(5) | 393.03 | 1633.74(8) | 1054.81 |
| Z | 6 | 8 | 2 | 8 | 4 |
| T (K) | 293 | 293 | 293 | 293 | 293 |
| ρ_{calcd} (g cm⁻³) | 4.400 | 3.537 | 4.760 | 4.581 | 3.724 |
| μ (mm⁻¹) | 37.146 | 29.868 | 40.193 | 38.677 | 29.967 |
| R [Iₒ ≧ 2.50σ(Iₒ)]^{c} | 0.0459 | 0.0429 | 0.0082 | 0.0338 | 0.0366 |
| R_{w} [Iₒ ≧ 2.50σ(Iₒ)]^{c} | 0.0616 | 0.0564 | 0.0117 | 0.0543 | 0.0691 |
| goodness of fit | — | 1.1438 | — | 1.2462 | — |

^{a}From ref 50.
^{b}From X-ray powder diffraction data.
^{c}The function minimized was Σw(|Fₒ| − |Fₑ|)², where w⁻¹ = |σ²(Fₒ) + (nFₒ)²| with n = 0 for β, 0.030 for δ, and 0 for γ and |Zn(NH₃)₂[Au(CN)₂]₂. R = Σ||Fₒ| − |Fₒ||/Σ|Fₒ|; R_{w} = [Σw(|Fₒ| − |Fₒ|)²/Σw|Fₒ|²]^{1/2}.

TABLE 10
Bond Lengths (Å) and Angles (deg) for 13β^{a}

| | | | |
|---|---|---|---|
| Zn(1)—N(11) | 1.957(14) | Zn(1)—N(21) | 1.944(15) |
| Zn(1)—N(22) | 1.955(14) | Zn(1)—N(31) | 1.964(13) |
| Au(1)—Au(2*) | 3.2702(6) | Au(1)—Au(2^{†}) | 3.2702(6) |
| Au(2′)—Au(3) | 3.1925(7) | Au(2″)—Au(3) | 3.1925(7) |
| An(2″)—Au(2^{†}) | 3.1466(11) | | |
| Zn(1)—N(11)—C(11) | 168.6(16) | Zn(1)—N(21)—C(21) | 171.5(13) |
| Zn(1)—N(22)—C(22) | 162.9(14) | Zn(1)—N(31)—C(31) | 166.6(14) |
| N(11)—Zn(1)—N(21) | 111.4(6) | N(11)—Zn(1)—N(22) | 106.4(6) |
| N(11)—Zn(1)—N(31) | 106.3(6) | N(21)—Zn(1)—N(22) | 112.8(6) |
| N(21)—Zn(1)—N(31) | 108.9(6) | N(22)—Zn(1)—N(31) | 110.8(6) |
| Au(2*)—Au(1)—Au(2^{†}) | 180.00 | Au(3^{‡})—Au( 2^{†})—Au(1) | 104.944(17) |
| Au(3)—Au(2″)—Au(2^{†}) | 145.15(3) | Au(1)—Au(2^{†})—Au(2″) | 109.35(2) |
| Au(2′)—Au(3)—Au(2″) | 141.53(4) | | |

^{a}Symmetry operations: (*) x + ½, y + ½, z; (′) −x + 1, −y + 1, −z; (^{†}) −x + 2, −y + 1, −z; (^{‡}) x + 1, y, z; (″) x, −y + 1, z − ½.

TABLE 11
Bond Lengths (Å) and Angles (deg) for 13δ^{a}

| | | | |
|---|---|---|---|
| Zn(1)—N(11) | 1.975(10) | Zn(1)—N(21) | 1.956(10) |
| Zn(1)—N(31) | 1.968(10) | Zn(1)—N(32) | 1.956(10) |
| Au(1)—Au(3′) | 3.3382(5) | Au(1)—Au(3′) | 3.3382(5) |
| Au(2*)—Au(3″) | 3.318(4) | Au(2*)—Au(3) | 3.3318(4) |
| N(11)—Zn(1)—N(32) | 110.3(4) | N(11)—Zn(1)—N(21) | 113.8(4) |
| N(11)—Zn(1)—N(31) | 100.6(4) | N(21)—Zn(1)—N(31) | 118.9(4) |
| N(21)—Zn(1)—N(32) | 101.2(4) | N(31)—Zn(1)—N(33) | 112.3(5) |
| Zn(1)—N(11)—C(11) | 161.8(10) | Zn(1)—N(21)—C(21) | 163.1(10) |
| Zn(1)—N(31)—C(31) | 158.7(10) | Zn(1)—N(32)—C(32) | 159.3(10) |
| Au(3′)—Au(1)—Au(3″) | 180.00 | Au(3)—Au(2*)—Au(3″) | 180.00 |
| Au(1)—Au(3″)—Au(2*) | 65.690(8) | | |

^{a}Symmetry operations: (′) x − ½, y + ½, z; (″) −x + ½, −y + 3/2, −z + 1; (*) x, −y + 2, z + ½.

TABLE 12
Summary of Luminescence data for 13α-13δ, [Zn(NH₃)₄][Au(CN)₂]₂ 15,
and {Zn(NH₃)₂[Au(CN)₂]₂} 14

| | emission | excitation |
|---|---|---|
| compound | maximum (nm) | maximum (nm) |
| α | 390, 480 | 345 |
| β | 450 | 390 |
| γ | 440 | 360 |
| δ | none | none |
| [Zn(NH₃)₄][Au(CN)₂]₂ | 430 | 365 |
| {Zn(NH₃)₂[Au(CN)₂]₂} | 500 | 400 |

TABLE 13
Selected bond distances and angles in Cu₃(THT)₄[Au(CN)₂]₃(20-THT-A).
Bond distances (Å)

| | |
|---|---|
| Cu—S | 2.290(2), 2.301(2), 2.335(2), |
| | 2.367(2), 2.372(2), 2.411(2) |
| Cu—N | 1.935(7)-1.993(8) |
| S(3)—S(4) | 3.573(3) |
| Au(1)—Au(3) | 3.2145(5) |
| Au(3)—Au(2) | 3.3570(5) |
| Au(2)—Au(2)* | 3.5601(6) |

Bond angles (°)

| | |
|---|---|
| S—Cu—S | 106.63(7)-116.87(8) |
| S—Cu—N | 103.2(2)-113.0(2) |
| N—Cu—N | 108.0(3)-130.7(3) |
| Cu—S—Cu | 123.50(9), 132.81(9) |

^{a}Symmetry element: *: 1 − x, −y, −z.

TABLE 14
Selected bond distances and angles in Cu(SMe₂)[Au(CN)₂](20-Me₂S).
Bond distances (Å)

| | |
|---|---|
| Cu(1)—S(1) | 2.297(3) |
| Cu(1)—N(1) | 1.950(6) |
| Au(1)—Au(1)^{§} | 3.396(1) |

Bond angles (°)

| | |
|---|---|
| S—Cu(1)—S* | 105.96(9) |
| S—Cu(1)—N | 104.9(2), 112.3(2) |
| N—Cu(1)—N^{†} | 115.4(2) |
| Cu(1)—S(1)—Cu(1)^{‡} | 129.9(1) |

^{a}Symmetry elements: *1 − x, ½ + y, −½ − z; (^{†}) x, y, −½ − z; (^{‡}) 1 − x, −½ + y, −½ − z; (^{§}) x, −½ − y, −z.

TABLE 15
Crystallographic data for compounds 20•py, 20•PPh₃, 20•THT and 20•Me₂S.

| | 20•py | 20•PPh₃ | 20•THT | 20•Me₂S |
|---|---|---|---|---|
| empirical formula | C₁₂H₁₀AuCuN₄ | C₂₄H₂₁AuCuN₄ | C₂₂H₃₂Au₃Cu₃N₆S₄ | C₄H₆AuCuN₂S |
| formula weight (g/mol⁻¹) | 470.5 | 656.92 | 1290.29 | 374.67 |
| crystal system | monoclinic | Orthorhombic | triclinic | orthorhombic |
| space group | P 2₁/n | P b c a | P −1 | P b c m |
| a (Å) | 7.8408(2) | 8.8815(2) | 11.2249(13) | 7.938(3) |
| b (Å) | 12.6970(3) | 16.3080(4) | 11.2246(13) | 6.792(3) |
| c (Å) | 13.8774(3) | 32.4913(8) | 15.1160(17) | 16.999(6) |
| α (°) | 90 | 90 | 73.447(2) | 90 |
| β (°) | 90.519(1) | 90 | 89.666(2) | 90 |
| γ (°) | 90 | 90 | 66.0670(18) | 90 |
| V (Å³) | 1381.50(6) | 4706.02(19) | 1671.7(3) | 916.6(6) |
| Z | 4 | 8 | 2 | 4 |
| T(K) | 150(2) | 150(2) | 150(2) | 150(2) |
| ρ_{calc} (g/cm⁻³) | 2.263 | 1.854 | 2.563 | 2.715 |
| μ (mm⁻¹) | 12.132 | 7.218 | 15.261 | 18.460 |
| Reflections refined | 2815 | 8975 | 8287 | 971 |
| R₁, wR₂ [I₀ ≧ 2σ(I₀)]^{a} | 0.0177, 0.0361 | 0.0328, 0.0579 | 0.0360, 0.0628 | 0.0303, 0.0726 |
| goodness of fit | 1.013 | 1.010 | 1.034 | 1.043 |

^{a}Function minimized: Σw(F₀² − F_{c}²)². R₁ = Σ||F₀| − |F_{c}||/Σ|F₀| and wR₂ = [Σw(F₀² − F_{c}²)²/ΣwF₀⁴]^{0.5}

TABLE 16
Summary of reactivity of 20 and 22 with various analytes in the vapour
phase and in solution.

| | Phase | | |
|---|---|---|---|
| Analyte | Vapour | 1% v/v in H₂O | 1% v/v in hexanes |

20

| | | |
|---|---|---|
| pyridine | Green emission, | Not attempted |
| | reversible | |
| THT | No reaction | |
| H₂S | No reaction | |
| Me₂S | No reaction | |
| Et₂S | No reaction | |

22

| Pyridine | Green emission, not | Yellow emission | Yellow emission |
|---|---|---|---|
| | reversible | | |
| THT | No reaction | Not attempted | |
| H₂S | No reaction | Not attempted | |
| Me₂S | Blue emission, | Blue emission, | Blue emission, |
| | reversible | reversible | reversible |
| Et₂S | Blue emission, | Blue emission, | No reaction |
| | reversible | reversible | |

### REFERENCES

(1) Janiak, C. J. Chem. Soc., Dalton Trans. 2003, 2781-2804.
(2) James, S. L. Chem. Soc. ReV. 2003, 32, 276-288.
(3) Clemente-León, M.; Coronado, E.; Marti-Gastaldo, C.; Romero, F. M. Chem. Soc. Rev. 2011, 40, 473-497.
(4) Batten, S. R.; Murray, K. S. Coord. Chem. Rev. 2003, 246, 103-130.
(5) Lefebvre, J.; Callaghan, F.; Katz, M. J.; Sonier, J. E.; Leznoff, D. B. Inorg. Chem. 2006, 12, 6748-6761.
(6) Dul, M.-C.; Pardo, E.; Lescouëzec, R.; Journaux, Y.; Ferrando-Soria, J.; Ruiz-Garcia, R.; Cano, J.; Julve, M.; Lloret, F.; Cangussu, D.; Pereira, C. L. M.; Stumpf, H. O.; Pasán, J.; Ruiz-Pérez, C. Coord. Chem. Rev. 2010, 254, 2281-2296.
(7) Wriedt, M.; Yakovenko, A. a; Halder, G. J.; Prosvirin, A. V; Dunbar, K. R.; Zhou, H.-C. J. Am. Chem. Soc. 2013, 135, 4040-4050.
(8) Maxim, C.; Branzea, D. G.; Tiseanu, C.; Rouzières, M.; Clérac, R.; Andruh, M.; Avarvari, N. Inorg. Chem. 2014, 53, 2708-2717.
(9) Furukawa, H.; Cordova, K. E.; O'Keeffe, M.; Yaghi, O. M. Science 2013, 341, 1230444.
(10) Song, L.; Zhang, J.; Sun, L.; Xu, F.; Li, F.; Zhang, H.; Si, X.; Jiao, C.; Li, Z.; Liu, S.; Liu, Y.; Zhou, H.; Sun, D.; Du, Y.; Cao, Z.; Gabelica, Z. Energy Environ. Sci. 2012, 5, 7508.
(11) Kitagawa, S.; Uemura, K. Chem. Soc. Rev. 2005, 34, 109-119.
(12) Zhang, J.-P.; Liao, P.-Q.; Zhou, H.-L.; Lin, R.-B.; Chen, X.-M. Chem. Soc. Rev. 2014.
(13) Herm, Z. R.; Wiers, B. M.; Mason, J. A.; van Baten, J. M.; Hudson, M. R.; Zajdel, P.; Brown, C. M.; Masciocchi, N.; Krishna, R.; Long, J. R. Science 2013, 340, 960-964.
(14) Taylor, J. M.; Dawson, K. W.; Shimizu, G. K. H. J. Am. Chem. Soc. 2013, 135, 1193-1196.
(15) Cui, Y.; Yue, Y.; Qian, G.; Chen, B. Chem. Rev. 2012, 112, 1126-1162.
(16) Heine, J.; Müller-Buschbaum, K. Chem. Soc. Rev. 2013, 42, 9232-9242.
(17) Rocha, J.; Carlos, L. D.; Paz, F. a A.; Ananias, D. Chem. Soc. Rev. 2011, 40, 926-940.
(18) Katz, M. J.; Ramnial, T.; Yu, H.-Z.; Leznoff, D. B. J. Am. Chem. Soc. 2008, 130, 10662-10673.
(19) Roberts, R. J.; Li, X.; Lacey, T. F.; Pan, Z.; Patterson, H. H.; Leznoff, D. B. Dalton Trans. 2012, 41, 6992-6997.
(20) Fernández, E. J.; Laguna, A.; López-de-Luzuriaga, J. M. Dalton Trans. 2007, 1969-1981.
(21) Beauvais, L. G.; Shores, M. P.; Long, J. R. J. Am. Chem. Soc. 2000, 122, 2763-2772.
(22) Kreno, L. E.; Leong, K.; Farha, O. K.; Allendorf, M.; Van Duyne, R. P.; Hupp, J. T. Chem. Rev. 2012, 112, 1105-1125.
(23) Lim, S. H.; Olmstead, M. M.; Balch, A. L. J. Am. Chem. Soc. 2011, 133, 10229-10238.
(24) Lim, M. J.; Murray, C. A.; Tronic, T. A.; DeKrafft, K. E.; Ley, A. N.; DeButts, J. C.; Pike, R. D.; Lu, H.; Patterson, H. H. Inorg. Chem. 2008, 47, 6931-6947.
(25) Ley, A. N.; Dunaway, L. E.; Brewster, T. P.; Dembo, M. D.; Harris, T. D.; Baril-Robert, F.; Li, X.; Patterson, H. H.; Pike, R. D. Chem. Commun. (Camb). 2010, 46, 4565-4567.
(26) Lefebvre, J.; Korc\check{o}k, J. L.; Katz, M. J.; Leznoff, D. B. Sensors (Basel). 2012, 12, 3669-3692.
(27) Lefebvre, J.; Batchelor, R. J.; Leznoff, D. B. J. Am. Chem. Soc., 2004, 126, 16117-16125.
(28) Guillerm, V.; Kim, D.; Eubank, J. F.; Luebke, R.; Liu, X.; Adil, K.; Lah, M. S.; Eddaoudi, M. Chem. Soc. Rev. 2014.
(29) Stock, N.; Biswas, S. Chem. Rev. 2012, 112, 933-969.
(30) Burchell, T. J.; Puddephatt, R. J. Inorg. Chem. 2005, 44, 3718-3730.
(31) Hao, Z.; Yang, G.; Song, X.; Zhu, M.; Meng, X.; Zhao, S.; Song, S.; Zhang, H. J. Mater. Chem. A 2014, 2, 237.
(32) Li, Y.; Zhang, S.; Song, D. Angew. Chem. Int. Ed. Engl. 2013, 52, 710-713.
(33) Pramanik, S.; Hu, Z.; Zhang, X.; Zheng, C.; Kelly, S.; Li, J. Inorg. Chem. 2013, 19, 15964-15971.
(34) Tian, D.; Li, Y.; Chen, R.-Y.; Chang, Z.; Wang, G.-Y.; Bu, X.-H. J. Mater. Chem. A 2014, 2, 1465.
(35) Lan, A.; Li, K.; Wu, H.; Olson, D. H.; Emge, T. J.; Ki, W.; Hong, M.; Li, J. Angew. Chem. Int. Ed. Engl. 2009, 48, 2334-2338.
(36) Solid State Gas Sensors—Industrial Application; Fleischer, M.; Lehmann, M., Eds.; Springer: New York, 2012.
(37) Yamazoe, N. Sensors Actuators B Chem. 2005, 108, 2-14.
(38) Grundler, P. Chemical Sensors: An Introduction for Scientists and Engineers; Springer: Berlin, Germany, 2007.
(39) White-Morris, R. L.; Olmstead, M. M.; Jiang, F.; Tinti, D. S.; Balch, A. L. J. Am. Chem. Soc. 2002, 124, 2327-2336.
(40) Mansour, M. A.; Connick, W. B.; Lachicotte, R. J.; Gysling, H. J.; Eisenberg, R. J. Am. Chem. Soc. 1998, 120, 1329-1330.
(41) Rawashdeh-Omary, M. A.; Omary, M. A.; Fackler, J. P., Jr.; Galassi, R.; Pietroni, B. R.; Burini, A. J. Am. Chem. Soc. 2001, 123, 9689-9691.
(42) Fernandez Eduardo, J.; Lopez-De-Luzuriaga Jose, M.; Monge, M.; Olmos, M. E.; Perez, J.; Laguna, A.; Mohamed Ahmed, A.; Fackler John, P., Jr. J Am. Chem. Soc. 2003, 125, 2022-2023.
(43) Exstrom, C. L.; Sowa, J. R., Jr.; Daws, C. A.; Janzen, D.; Mann, K. R.; Moore, G. A.; Stewart, F. F. Chem. Mater. 1995, 7, 15-17.
(44) Drew, S. M.; Janzen, D. E.; Buss, C. E.; MacEwan, D. I.; Dublin, K. M.; Mann, K. R. J. Am. Chem. Soc. 2001, 123, 8414-8415.
(45) Lu, Z.-Z.; Zhang, R.; Li, Y.-Z.; Guo, Z.-J.; Zheng, H.-G. J. Am. Chem. Soc. 2011, 133, 4172-4174.
(46) Buss, C. E.; Anderson, C. E.; Pomije, M. K.; Lutz, C. M.; Britton, D.; Mann, K. R. J. Am. Chem. Soc. 1998, 120, 7783-7790.
(47) Bariain, C.; Matias, I. R.; Romeo, I.; Garrido, J.; Laguna, M. Appl. Phys. Lett. 2000, 77, 2274-2276.
(48) Kunugi, Y.; Mann, K. R.; Miller, L. L.; Exstrom, C. L. J. Am. Chem. Soc. 1998, 120, 589-590.
(49) Kunugi, Y.; Miller, L. L.; Mann, K. R.; Pomije, M. K. Chem. Mater. 1998, 10, 1487-1489.
(50) Daws, C. A.; Exstrom, C. L.; Sowa, J. R., Jr.; Mann, K. R. Chem. Mater. 1997, 9, 363-368.
(51) Exstrom, C. L.; Pomije, M. K.; Mann, K. R. Chem. Mater. 1998, 10, 942-945.
(52) Wenger, O. S. Chem. Rev. 2013, 113, 3686-3733.
(53) (43) Fung, E. Y.; Olmstead, M. M.; Vickery, J. C.; Balch, A. L. Coord. Chem. Rev. 1998, 171, 151-159.
(54) Lee, Y.; Eisenberg, R. J. Am. Chem. Soc. 2003, 125, 7778-7779.
(55) Vickery, J. C.; Olmstead, M. M.; Fung, E. Y.; Balch, A. L. Angew. Chemie Int. Ed. English 1997, 36, 1179-1181.
(56) Elosúa, C.; Bariáin, C.; Matias, I. R.; Arregui, F. J.; Luquin, A.; Laguna, M. Sensors Actuators B Chem. 2006, 115, 444-449.
(57) Elosua, C.; Bariain, C.; Matias, I. R.; Arregui, F. J.; Vergara, E.; Laguna, M. Sensors Actuators B Chem. 2009, 137, 139-146.
(58) Elosua, C.; Bariain, C.; Luquin, A.; Laguna, M.; Matias, I. R. Sensors Actuators B Chem. 2011, 157, 388-394.
(59) Elosua, C.; Arregui, F. J.; Zamarreño, C. R.; Bariain, C.; Luquin, A.; Laguna, M.; Matias, I. R. Sensors Actuators B Chem. 2012, 173, 523-529.
(60) Elosua, C.; Bariain, C.; Luquin, A.; Laguna, M.; Matias, I. R. IEEE Sens. I 2012, 12, 3156-3162.
(61) Elosúa, C.; Vidondo, I.; Arregui, F. J.; Bariain, C.; Luquin, A.; Laguna, M.; Matias, I. R. Sensors Actuators B Chem. 2013, 187, 65-71.
(62) Terrones, S. C.; Aguado, C. E.; Bariain, C.; Carretero, A. S.; Maestro, I. R. M.; Gutierrez, A. F.; Luquin, A.; Garrido, J.; Laguna, M. Opt. Eng. 2006, 45, 044401.
(63) Bariáin, C.; Matías, I. R.; Romeo, I.; Garrido, J.; Laguna, M. Sensors Actuators B Chem. 2001, 76, 25-31.
(64) Bezunartea, M.; Estella, J.; Echeverría, J. C.; Elosúa, C.; Bariáin, C.; Laguna, M.; Luquin, A.; Garrido, J. J. Sensors Actuators B Chem. 2008, 134, 966-973.
(65) Fernández, E. J.; Laguna, A.; López-de-Luzuriaga, J. M.; Montiel, M.; Olmos, M. E.; Pérez, J. Organometallics 2006, 25, 1689-1695.
(66) Fernández, E. J.; López-De-Luzuriaga, J. M.; Monge, M.; Olmos, M. E.; Pérez, J.; Laguna, A.; Mohamed, A. A.; Fackler, J. P. J. Am. Chem. Soc. 2003, 125, 2022-2023.
(67) Laguna, A.; Lasanta, T.; López-de-Luzuriaga, J. M.; Monge, M.; Naumov, P.; Olmos, M. E. J. Am. Chem. Soc. 2010, 132, 456-457.
(68) Strasser, C. E.; Catalano, V. J. J. Am. Chem. Soc. 2010, 132, 10009-10011.
(69) Osawa, M.; Kawata, I.; Igawa, S.; Hoshino, M.; Fukunaga, T.; Hashizume, D. Chemistry 2010, 16, 12114-12126.
(70) Elosua, C.; Bariain, C.; Matias, I. R.; Arregui, F. J.; Luquin, A.; Laguna, M. In 2009 IEEE Sensors; IEEE, 2009; pp. 154-157.
(71) King, C.; Wang, J. C.; Khan, M. N. I.; Fackler, J. P. Inorg. Chem. 1989, 28, 2145-2149.
(72) Ito, H.; Saito, T.; Oshima, N.; Kitamura, N.; Ishizaka, S.; Hinatsu, Y.; Wakeshima, M.; Kato, M.; Tsuge, K.; Sawamura, M. J. Am. Chem. Soc. 2008, 130, 10044-10045.
(73) Dong, W.; Zhu, L.-N.; Sun, Y.-Q.; Liang, M.; Liu, Z.-Q.; Liao, D.-Z.; Jiang, Z.-H.; Yan, S.-P.; Cheng, P. Chem. Commun. 2003, 2544-2545.
(74) Abrahams, S. C.; Zyontz, L. E.; Bernstein, J. L. J. Chem. Phys. 1982, 76, 5458.
(75) Abrahams, S. C.; Bernstein, J. L.; Liminga, R.; Eisenmann, E. T. J. Chem. Phys. 1980, 73,4585.
(76) Colacio, E.; Lloret, F.; Kivekaes, R.; Ruiz, J.; Suarez-Varela, J.; Sundberg, M. R. Chem. Commun. 2002, 592-593.
(77) Hoskins, B. F.; Robson, R.; Scarlett, N. V. Y. Angew. Chem. Int. Ed. Engl. 1995, 34, 1203.
(78) Assefa, Z.; Shankle, G.; Patterson, H. H.; Reynolds, R. Inorg. Chem. 1994, 33, 2187-2195.
(79) Stier, A.; Range, K.-J. Z. Naturforsch. 1996, 51b, 698.
(80) Stier, A.; Range, K.-J. Z. Kristallogr 1997, 212, 51.
(81) Assefa, Z.; Staples, R. J.; Fackler, J. P., Jr.; Patterson, H. H.; Shankle, G. Acta Crystallogr. 1995, C51, 2527.
(82) Leznoff, D. B.; Xue, B.-Y.; Patrick, B. O.; Sanchez, V.; Thompson, R. C. Chem. Commun. 2001, 259-260.
(83) Leznoff, D. B.; Xue, B. Y.; Stevens, C. L.; Storr, A.; Thompson, R. C.; Patrick, B. O. Polyhedron 2001, 20, 1247-1254.
(84) Leznoff, D. B.; Xue, B.-Y.; Batchelor, R. J.; Einstein, F. W. B.; Patrick, B. O. Inorg. Chem. 2001, 40, 6026-6034.
(85) Shorrock, C. J.; Xue, B.-Y.; Kim, P B; Batchelor, R. J.; Patrick, B. O.; Leznoff, D. B. Inorg. Chem., 2002, 41, 6743-53.
(86) Leznoff, D. B.; Draper, N. D.; Batchelor, R. J. Polyhedron, 2003, 22, 1735-1743.
(87) Draper, N. D.; Batchelor, R. J.; Sih, B. C.; Ye, Z.-G.; Leznoff, D. B. Chem. Mater., 2003, 15, 1612-1616.
(88) Shorrock, C. J.; Jong, H.; Batchelor, R. J.; Leznoff, D. B. Inorg. Chem., 2003, 42, 3917-3924.
(89) Draper, N. D.; Batchelor, R. J.; Leznoff, D. B. Crystal Growth and Design, 2004, 4, 621-632.
(90) Draper, N. D.; Batchelor, R. J.; Aguiar, P. M.; Kroeker, S.; Leznoff, D. B. Inorg. Chem., 2004, 43, 6557-6567.
(91) Katz, M. J.; Batchelor, R. J.; Leznoff, D. B. J. Am. Chem. Soc., in press.
(92) Henline, K. M.; Wang, C.; Pike, R. D.; Ahern, J. C.; Sousa, B.; Patterson, H. H.; Kerr, A. T.; Cahill, C. L. Cryst. Growth Des. 2014, 14, 1449-1458.
(93) Fang, W.-H.; Cheng, J.-W.; Yang, G.-Y. Chemistry 2014, 20, 2704-2711.
(94) Uemura, K.; Ebihara, M. Inorg. Chem. 2013, 52, 5535-5550.
(95) Lang, J.; Xu, Q.; Zhang, W.; Li, H.; Ren, Z.; Chen, J.; Zhang, Y. Inorg. Chem. 2006, 45, 10487-10496.
(96) Sculfort, S.; Braunstein, P. Chem. Soc. Rev. 2011, 40, 2741-2760.
(97) Jana, S.; Chattopadhyay, S. J. Coord. Chem. 2013, 66, 3906-3914.
(98) Ge, J.-Y.; Wang, J.-C.; Cheng, J.-Y.; Wang, P.; Ma, J.-P.; Liu, Q.-K.; Dong, Y.-B. Chem. Commun. (Camb). 2014, 50, 4434-4437.
(99) Mukherjee, S.; Thilagar, P. Dye. Pigment. 2014, 110, 2-27.
(100) Spielberg, E. T.; Edengeiser, E.; Mallick, B.; Havenith, M.; Mudring, A.-V. Chemistry 2014, 20, 5338-5345.
(101) Le, T. H.; Nafady, A.; Vo, N. T.; Elliott, R. W.; Hudson, T. A.; Robson, R.; Abrahams, B. F.; Martin, L. L.; Bond, A. M. Inorg. Chem. 2014, 53, 3230-3242.
(102) Skoch, K.; Císa\check{r}ová, I.; St\check{e}pni\check{c}ka, P. Inorg. Chem. 2014, 53, 568-577.
(103) Balakrishna, M. S.; Suresh, D.; Anantimag, G. S.; Mague, J. T. Dalton Trans. 2014, 43, 8835-8848.
(104) Wu, H.; Dong, X.-W.; Liu, H.-Y.; Ma, J.-F.; Li, S.-L.; Yang, J.; Liu, Y.-Y.; Su, Z.-M. Dalton Trans. 2008, 5331-5341.
(105) Yin, P.-X.; Zhang, J.; Li, Z.-J.; Qin, Y.-Y.; Cheng, J.-K.; Zhang, L.; Lin, Q.-P.; Yao, Y.-G. Cryst. Growth Des. 2009, 9, 4884-4896.
(106) He, X.; Lu, C.-Z.; Wu, C.-D.; Chen, L.-J. Eur. J. Inorg. Chem. 2006, 2006, 2491-2503.
(107) Dembo, M. D.; Dunaway, L. E.; Jones, J. S.; Lepekhina, E. A.; McCullough, S. M.; Ming, J. L.; Li, X.; Baril-Robert, F.; Patterson, H. H.; Bayse, C. a.; Pike, R. D. Inorganica Chim. Acta 2010, 364, 102-114.
(108) Bayse, C. A; Brewster, T. P.; Pike, R. D. Inorg. Chem. 2009, 48, 174-182.
(109) Mukherjee, R. Comprehensive Coordination Chemistry II; Elsevier, 2004; pp. 747-910.
(110) (83) Lobana, T.; Wang, J.; Liu, C. Coord. Chem. Rev. 2007, 251, 91-110.
(111) Kahn, O. Molecular Magnetism; VCH: Weinheim, 1993.
(112) Gabe, E. J.; White, P. S.; Enright, G. D. DIFRAC A Fortran 77 Control Routine for 4-Circle Diffractometers; N. R. C.: Ottawa, 1995.
(113) Gabe, E. J.; LePage, Y.; Charland, J.-P.; Lee, F. L.; White, P. S. J. Appl. Crystallogr. 1989, 22, 384.
(114) Higashi, T. Program for Absorption Correction; Rigaku Corporation: Tokyo, Japan, 1999.
(115) Watkin, D. J.; Prout, C. K.; Carruthers, J. R.; Betteridge, P. W.; Cooper, R. I. CRYSTALS Issue 11 Chemical Crystallography Laboratory, University of Oxford, Oxford, England, 1999.
(116) Farrugia, L. J. J. Appl. Crystallogr 1997, 30, 565.
(117) Fenn, T. D.; Ringe, D.; Petsko, J. Appl. Crystallogr. 2003, 36, 944-947. (Persistence of Vision Raytracing: http://www.povray.org).
(118) Dunbar, K. R.; Heintz, R. A. Prog. Inorg. Chem. 1997, 45, 283-391.
(119) Addison, A. W.; Rao, T. N.; Reedijk, J.; Van Rijn, J.; Verschoor, G. C. J. Chem. Soc., Dalton Trans. 1984, 1349-1356.
(120) Schmidbaur, H. Chem. Soc. ReV. 1995, 24, 391.
(121) Carlin, R. L. Magnetochemistry; Springer-Verlag: Berlin, Heidelberg, Germany, 1986.
(122) Colacio, E.; Lloret, F.; Kivekaes, R.; Suarez-Varela, J.; Sundberg, M. R.; Uggla, R. Inorg. Chem. 2003, 42, 560-565.
(123) Chomic, J.; Cernak, J. Thermochim. Acta 1985, 93, 93.
(124) Noro, S.-i.; Kitaura, R.; Kondo, M.; Kitagawa, S.; Ishii, T.; Matsuzaka, H.; Yamashita, M. J. Am. Chem. Soc. 2002, 124, 2568-2583.
(125) Seki, K. Chem. Commun. 2001, 1496-1497.
(126) Uemura, K.; Kitagawa, S.; Kondo, M.; Fukui, K.; Kitaura, R.; Chang, H.-C.; Mizutani, T. Chem. Eur. J. 2002, 8, 3586-3600.
(127) Eddaoudi, M.; Moler, D. B.; Li, H.; Chen, B.; Reineke, T. M.; O'Keeffe, M.; Yaghi, O. M. Acc. Chem. Res. 2001, 34, 319-330.
(128) Moulton, B.; Zaworotko, M. J. Chem. ReV. 2001, 101, 1629-1658.
(129) Batten, S. R.; Murray, K. S. Aust. J. Chem. 2001, 54, 605-609.
(130) Dunitz, J. D.; Bernstein, J. Acc. Chem. Res. 1995, 28, 193.
(131) Bernstein, J. Polymorphism in Molecular Crystals; Oxford University Press: Oxford, 2002.
(132) Braga, D.; Grepioni, F. Chem. Soc. ReV. 2000, 29, 229-238.
(133) Bernstein, J.; Davey, R. J.; Henck, J.-O. Angew. Chem., Int. Ed. 1999, 38, 3440.
(134) Jensen, P.; Batten, S. R.; Fallon, G. D.; Hockless, D. C. R.; Moubaraki, B.; Murray, K. S.; Robson, R. J. Solid State Chem. 1999, 145, 387-393.
(135) Barnett, S. A.; Blake, A. J.; Champness, N. R.; Wilson, C. Chem. Commun. 2002, 1640-1641.
(136) Heintz, R. A.; Zhao, H.; Ouyang, X.; Grandinetti, G.; Cowen, J.; Dunbar, K. R. Inorg. Chem. 1999, 38, 144.
(137) Atwood, J. L.; Barbour, L. J.; Jerga, A.; Schottel, B. L. Science 2002, 298, 1000-1002.
(138) Cote, A. P.; Shimizu, G. K. H. Chem. Commun. 2001, 251-252.
(139) Edgar, M.; Mitchell, R.; Slawin, A. M.; Lightfoot, P.; Wright, P. A. Chem. Eur. J. 2001, 7, 5168-5175.
(140) Miller, P. W.; Nieuwenhuyzen, M.; Xu, X.; James, S. L. Chem. Commun. 2002, 2008-2009.
(141) Lozano, E.; Nieuwenhuyzen, M.; James, S. L. Chem. Eur. J. 2001, 7, 2644-2651.
(142) Kitaura, R.; Fujimoto, K.; Noro, S.-i.; Kondo, M.; Kitagawa, S. Angew. Chem., Int. Ed. 2002, 41, 133-135.
(143) Côté, A. P.; Ferguson, M. J.; Khan, K. A.; Enright, G. D.; Kulynych, A. D.; Dalrymple, S. A.; Shimizu, G. K. H. Inorg. Chem. 2002, 41, 287-292.
(144) Lefebvre, J.; Chartrand, D.; Leznoff, D. B., Polyhedron 2007, 26, 2189.
(145) Betteridge, P. W.; Carruthers, J. R.; Cooper, R. I.; Prout, K.; Watkin, D. J., J. Appl. Crystallogr., 2003, 36, 1487.
(146) Watkin, D. J.; Prout, C. K.; Pearce, L. J., Cameron; University of Oxford Chemical Crystallography Laboratory: Oxford, U. K., 1996.
(147) Boultif, A.; Louer, D., J. Appl. Cryst. 2004, 37, 724.
(148) Kraus, W.; Nolze, G., J. Appl. Crystallogr. 1996, 29, 301.
(149) Soma, T.; Iwamoto, T., Chem. Lett. 1995, 271.
(150) Parmar, M. M.; Khan, O.; Ford, J. L., Cryst. Growth Des. 2007, 7, 1635.
(151) Blagus, A.; Kaitner, B., J. Chem. Crystallogr. 2007, 37, 473.
(152) Katz, M. J.; Shorrock, C. J.; Batchelor, R. J.; Leznoff, D. B., Inorg. Chem. 2006, 45, 1757.
(153) Blake, A. J.; Brooks, N. R.; Champness, N. R.; Crew, M.; Deveson, A.; Fenske, D.; Gregory, D. H.; Hanton, L. R.; Hubberstey, P.; Schröder, M., Chem. Commun. 2001, 1432.
(154) Lu, J.; Wang, X.-J.; Yang, X.; Ching, C.-B., Cryst. Growth Des. 2007, 7, 1590.
(155) Lee, I. S.; Kim, K. T.; Lee, A. Y.; Myerson, A. S., Cryst. Growth Des. 2008, 8, 108.
(156) Mølgaard, A.; Larsen, S., Acta Cryst. 2004, D60, 472.
(157) Zaworotko, M. J., Chem. Soc. Rev. 1994, 23, 283.
(158) Sun, J.; Weng, L.; Zhou, Y.; Chen, J.; Chen, Z.; Liu, Z.; Zhao, D., Angew. Chem. Int. Ed. 2002, 41, 4471.
(159) Hu, S.; Tong, M.-L., Dalton Trans. 2005, 1165.
(160) Batten, S. R.; Robson, R., Angew. Chem. Int. Ed. 1998, 37, 1460.
(161) Óhrstróm, L.; Larsson, K., Molecule-Based Materials: The Structural Network Approach. Elsevier: Amsterdam, 2005.
(162) Wenk, H.-R.; Bulakh, A., Minerals: Their Constitution and Origin. Cambridge University Press: Cambridge, 2004.
(163) Moulton, B.; Zaworotko, M. J., Chem. Rev. 2001, 101, 1629.
(164) Blatov, V. A.; Carlucci, L.; Ciani, G.; Proserpio, D. M., CrystEngComm 2004, 6, 377.
(165) Proserpio, D. M.; Hoffmann, R.; Preuss, P., J. Am. Chem. Soc. 1994, 116, 9634.
(166) Feldtmann, W. B., J. Chem. Metall. Min. Soc. South Afr. 1919, 20, 13.
(167) Dunitz, J. D.; Bernstein, J., Acc. Chem. Res. 1995, 28, 193.
(168) Blagden, N.; Davey, R. J., Cryst. Growth Des. 2003, 3, 873.
(169) Gavezzotti, A., CrystEngComm. 2002, 4, 343.
(170) Buschmann, W. E.; Miller, J. S., Inorg. Chem. Commun. 1998, 1, 174.
(171) Cartraud, P.; Cointot, A.; Renaud, A. J., J. Chem. Soc., Faraday Trans. 1981, 77, 1561.
(172) Evans, O. R.; Lin, W., Acc. Chem. Res. 2002, 35, 511.
(173) Bondi, A., J. Phys. Chem. 1964, 68, 441.
(174) Bardají, M.; Laguna, A., J. Chem. Educ. 1999, 76, 201.
(175) Stender, M.; Olmstead, M. M.; Balch, A. L.; Rios, D.; Attar, S., Dalton Trans. 2003, 4282.
(176) Pham, D. M.; Rios, D.; Olmstead, M. M.; Balch, A. L., Inorg. Chim. Acta 2005, 358, 4261.
(177) Fackler, J., J. P., Inorg. Chem. 2002, 41, 6959.
(178) Rawashdeh-Omary, M. A.; Omary, M. A.; Patterson, H. H.; Fackler Jr., J. P., J. Am. Chem. Soc. 2001, 123, 11237.
(179) Hettiarachchi, S. R.; Schaefer, B. K.; Yson, R. L.; Staples, R. J.; Herbst-Irmer, R.; Patterson, H. H., Inorg. Chem. 2007, 46, 6997.
(180) Arvapally, R. K.; Sinha, P.; Hettiarachchi, S. R.; Coker, N. L.; Bedel, C. E.; Patterson, H. H.; Elder, R. C.; Wilson, A. K.; Omary, M. A., J. Phys. Chem. C 2007, 111, 10689.
(181) Stender, M.; White-Morris, R. L.; Olmstead, M. M.; Balch, A. L., Inorg. Chem. 2003, 42, 4504.
(182) Timmer, B.; Olthuis, W.; van den Berg, A., Sens. Actuators B 2005, 107, 666.
(183) Budarvari, S.; O'Neil, M. J.; Smith, A.; Heckelman, P. E.; Kinneary, J. F., The Merck Index: An Encyclopedia of Chemicals, Drugs, and Biologicals. Merck: New Jersey, 1996.
(184) Nakamoto, K., Infrared and Raman Spectra of Inorganic and Coordination Compounds. Wiley: New York, 1986.
(185) Migdal-Mikuli, A.; Mikuli, E.; Hetmanczyk, L.; Natkaniec, I.; Holderna-Natkaniec, K.; Lasocha, W., J. Solid State Chem. 2003, 174, 357.
(186) Hillebrecht, H.; Thiele, G.; Koppenhöfer, A.; Vahrenkamp, H., Z. Naturforsch., B 1994, 49, 1163.
(187) Prince, R. H. In Comprehensive Coordination Chemistry, Oxford, 1987; Pergamon: Oxford, 1987.
(188) Suárez-Varela, J.; Sakiyama, H.; Cano, J.; Colacio, E., Dalton Trans. 2007, 249.
(189) Vlcek, A.; Orendác, M.; Orendácová, A.; Kajnaková, M.; Papageorgiou, T.; Chomic, J.; Cernák, J.; Massa, W.; Feher, A., Sol. State Sci. 2007, 9, 116.
(190) Reller, A.; Oswald, H.-R., J. Therm. Anal. 1994, 41, 535.
(191) Kaneko, W.; Ohba, M.; Kitagawa, S., J. Am. Chem. Soc. 2007, 129, 13706.
(192) Kitagawa, S.; Kitaura, R.; Noro, S.-I., Angew. Chem. Int. Ed. 2004, 43, 2334.
(193) Cole, S. C.; Coles, M. P.; Coles, P. B., Dalton Trans. 2003, 3663.
(194) Rout, C. S.; Hegde, M.; Govindaraj, A.; Rao, C. N. R., Nanotechnology 2007, 18, 205504.
(195) Galbarra, D.; Arregui, F. J.; Matias, I. R.; Claus, R. O., Smart Mater. Struct. 2005, 14, 739.
(196) Thangadurai, V.; Weppner, W., Solid State Ionics 2004, 174, 175.
(197) Vidotti, M.; Dall'Antonia, L. H.; Cintra, E. P.; Córdoba de Torresi, S. I., Electrochem. Acta 2004, 49, 3665.
(198) Lee, Y.-S.; Song, K.-D.; Huh, J.-S.; Chung, W.-Y.; Lee, D.-D., Sens. Actuators B 2005, 108, 292.
(199) Yagi, T.; Kuboki, N.; Suzuki, Y.; Uchino, N.; Nakamura, K.; Yoshida, K., Opt. Rev. 1997, 4, 596.
(200) Malins, C.; Doyle, A.; MacCraith, B. D.; Kvasnik, F.; Landl, M.; Simon, P.; Kalvoda, L.; Lukas, R.; Pufler, K.; Babusik, I., J. Environ. Monit. 1999, 1, 417.
(201) Katz, M. J.; Aguiar, P. M.; Batchelor, R. J.; Bokov, A. A.; Ye, Z.-G.; Kroeker, S.; Leznoff, D. B., J. Am. Chem. Soc., 2006, 128, 3669.
(202) Chippindale, A. M.; Hibble, S. J.; Bilbé, E. J.; Marelli, E.; Hannon, A. C.; Allain, C.; Pansu, R.; Hartl, F. J. Am. Chem. Soc., 2012, 134, 16387-400.
(203) Bowmaker, G. A.; Kennedy, B. J.; Reid, J. C. Inorg. Chem. 1998, 37, 3968-3974.
(204) Hibble, S. J.; Hannon, A. C.; Cheyne, S. M. Inorg. Chem. 2003, 42, 4724-4730.
(205) Katz, M. J.; Sakai, K.; Leznoff, D. B. Chem. Soc. Rev. 2008, 37, 1884-1895.
(206) Pearson, R. G. Chemical Hardness; Wiley, 2005.
(207) Cotton, F. A.; Diebold, M. P.; Roth, W. J. J. Am. Chem. Soc. 1986, 108, 3538-3539.
(208) Ahrland, S.; Noren, B.; Oskarsson, A. Inorg. Chem. 1985, 24, 1330-1333.
(209) Mashiko, T.; Reed, C. A.; Haller, K. J.; Kastner, M. E.; Scheidt, W. R. J. Am. Chem. Soc. 1981, 103, 5758-5767.
(210) Sanaullah; Hungerbuhler, H.; Schöneich, C.; Morton, M.; Vander Velde, D. G.; Wilson, G. S.; Asmus, K.; Glass, R. S. J. Am. Chem. Soc. 1997, 119, 2134-2145.
(211) Uson, R.; Fornias, J.; Espinet, P.; Lalinde, E.; Jones, P. G.; Sheldrick, G. M. J. Chem. Soc. Dalt. Trans. 1982, 2389.
(212) Fitzpatrick, J.; Kalyvas, H.; Filipovic, M. R.; Ivanović-Burmazović, I.; MacDonald, J. C.; Shearer, J.; Kim, E J. Am. Chem. Soc. 2014, 136, 7229-7232.
(213) Hidai, M.; Kuwata, S.; Mizobe, Y. Acc. Chem. Res. 2000, 33, 46-52.
(214) Bleiholder, C.; Werz, D. B.; Köppel, H.; Gleiter, R. J. Am. Chem. Soc. 2006, 128, 2666-2674.
(215) Mundt, O.; Becker, G.; Baumgarten, J.; Riffel, H.; Simon, A. Zeitschrift für Anorg. und Allg. Chemie 2006, 632, 1687-1709.
(216) Cui, Y.; Chen, B.; Qian, G. Coord. Chem. Rev. 2014, 273-274, 76-86.
(217) Tang, C.; Liu, X.-D.; Liu, F.; Wang, X.; Xu, H.; Huang, W. Macromol. Chem. Phys. 2013, 214, 314-342.
(218) Shang, M.; Li, C.; Lin, J. Chem. Soc. Rev. 2014, 43, 1372-1386.
(219) Hübschle, C. B.; Sheldrick, G. M.; Dittrich, B. J. Appl. Crystallogr. 2011, 44, 1281-1284.
(220) TOPAS-Academic V5, 2012.
(221) Rathore, D.; Kurchania, R.; Pandey, R. K., Sensors Actuators A, 2013, 199, 236-240.
(222) Zhang, H.; Li, J.; Zhang, H.; Liang, X.; Yin, C.; Diao, Q.; Zheng, J.; Lu, G., Sensors Actuators B, 2013, 66-70.
(223) Meskath, S.; Urban, G; Heinze, J., Sensors Actuators B, 2011, 151, 327-332.
(224) Miyata, T.; Hikosaka, T.; Minami, T., Sensors an Actuators B, 2000, 69, 16-21.
(225) Muhle, C.; Karpov, A.; Nuss, J.; Jansen, M., Z. Naturforsch. B, 2004, 59b, 567-572.
(226) Muhle, C.; Nuss, J.; Dinnebier, R. E.; Jansen, M., Chem. Inform., 2010, 41.
(227) Elding, L.; Gustafson, L., Inorg. Chim. Acta, 1976, 19, 165-171.
(228) Gliemann, G; Yersin, H., Struct. Bond., 1985, 62, 87.
(229) Holzapfel, W.; Yersin, H.; Gliemann, G, Z. Kristallogr, 1981, 157, 47.
(230) Day, P.; Ferguson, J., J. Chem. Soc., Faraday Trans., 1981, 77, 1579.(112) CRC Handbook of Chemistry and Physics; Lide, D. R., Ed.; 71̂{st} ed.; CRC Press, Inc.: Boca Raton, Fla., 1990.
(231) Thangavelu, S. G.; Cahill, C. L. Inorg. Chem. 2015, 2, 4208.
(232) McGrail, B. T.; Pianowski, L. S.; Burns, P. C. J. Am. Chem. Soc. 2014, 136, 4797.
(233) Baker, R. J.; Walshe, A. Chem. Commun. 2012, 48, 985.
(234) Enthaler, S. Chem. Eur. J. 2011, 17, 9316.
(235) Adelani, P. O.; Martinez, N. a.; Cook, N. D.; Burns, P. C. Eur. J. Inorg. Chem. 2015, 340.
(236) Xu, X.; Hou, Y.-N.; Wei, S.-Y.; Zhang, X.; Bai, F.; Sun, L.; Shi, Z.; Xing, Y.-H. CrystEngComm 2015, 17, 642.
(237) Cantos, P. M.; Cahill, C. L. Cryst. Growth Des. 2014, 14, 3044.
(238) Kerr, A. T.; Cahill, C. L. Cryst. Growth Des. 2014, 14, 1914.
(239) Yang, W.; Wang, H.; Tian, W.-G.; Li, J.; Sun, Z.-M. Eur. J. Inorg. Chem. 2014, 2, 5378.
(240) Yang, W.; Tian, W.-g.; Liu, X.-x.; Wang, L.; Sun, Z.-m. Cryst. Growth Des. 2014, 14, 5904.
(241) Zhai, X.-S.; Zheng, Y.-Q.; Lin, J.-L.; Xu, W. Inorganica Chim. Acta 2014, 423, 1.
(242) Mihalcea, I.; Henry, N.; Volkringer, C.; Loiseau, T. Cryst. Growth Des. 2012, 12, 526.
(243) Knope, K. E.; de Lill, D. T.; Rowland, C. E.; Cantos, P. M.; de Bettencourt-Dias, A.; Cahill, C. L. Inorg. Chem. 2012, 51, 201.
(244) Andrews, M. B.; Cahill, C. L. CrystEngComm 2011, 13, 7068.
(245) Yu, Z.-T.; Liao, Z.-L.; Jiang, Y.-S.; Li, G.-H.; Chen, J.-S. Chem. Eur. J. 2005, 11, 2642.
(246) Chen, W.; Yuan, H.-M.; Wang, J.-Y.; Liu, Z.-Y.; Xu, J.-J.; Yang, M.; Chen, J.-S. J. Am. Chem. Soc. 2003, 125, 9266.
(247) Hervé, A.; Thuéry, P.; Ephritikhine, M.; Berthet, J.-C. Organometallics 2014, 33, 2088.
(248) Maynard, B. A.; Lynn, K. S.; Sykora, R. E.; Gorden, A. E. V. J. Radioanal. Nucl. Chem. 2012, 296, 453.
(249) Maynard, B. A.; Lynn, K. S.; Sykora, R. E.; Gorden, A. E. V. Inorg. Chem. 2013, 52, 4880.
(250) Maynard, B. A.; Sykora, R. E.; Mague, J. T.; Gorden, A. E. V. Chem. Commun. 2010, 46, 4944.

What is claimed is:

1. A vapochromic coordination polymer comprising:
M_{W}[M′_{X}(Z)_{Y}]_{N}
wherein M and M′ are the same or different metals capable of forming a coordinate complex with the Z moiety;
Z is selected from the group consisting of halides, pseudohalides, thiolates, alkoxides and amides;
W is between 1-6;
X and Y are between 1-9; and
N is between 1-5.

2. The polymer as defined in claim 1, wherein M is selected from the group consisting of Cu and Ag, M′ is selected from the group consisting of Au and Ag, Z is CN, Y is 2 and N is 1.

3. The polymer as defined in claim 2, wherein M is Cu(I) and said polymer is reversibly vapochromic.

4. The polymer as defined in claim 2, further comprising an organic ligand bound to M.

5. The polymer as defined in claim 4, wherein said organic ligand comprises at least one nitrogen, oxygen, sulphur, selenium or phosphorus donor.

6. The polymer as defined in claim 2, wherein said polymer is vapoluminescent.

7. A composition comprising a polymer as defined in claim 2, and an analyte adsorbed to said polymer.

8. The composition as defined in claim 7, wherein said analyte is a volatile organic compound.

9. The composition as defined in claim 7, wherein said analyte is a gas having a donor hydrogen, nitrogen, oxygen, sulphur, selenium or phosphorus atom.

10. A solid-state vapochromic structure comprising a polymer as defined in claim 2.

11. A solid-state vapochromic structure comprising a composition as defined in claim 7.

12. The use of a structure a defined in claim 10 for vapochromically sensing the presence of an analyte.

13. An analyte-bound complex comprising an analyte adsorbed to a polymer as defined in claim 2.

14. The polymer as defined in claim 1, wherein each of M and M′ are selected from the group consisting of Au, Ag, Cu and Tl, Z is CN, Y is 2 and N is 1.

15. A vapochromic coordination polymer comprising:
Mₓ[M′_{y}M″_{2-x-y}(Z)₂]
wherein M, M′ and M″ are the same or different metals selected from the group consisting of Au, Ag, Cu and Tl;
Z is selected from the group consisting of halides, pseudohalides, thiolates, alkoxides and amides; and
X and Y are each between 0 and 1.

16. The polymer as defined in claim 15 wherein Z is CN.

17. The polymer as defined in claim 15, wherein M is Cu, M′ is Au, Z=CN and Y=2-X and M″ is omitted.

18. The polymer as defined in claim 15, wherein the oxidative state of M is 1.

19. The polymer as defined in claim 18, wherein M is Cu(I).

20. The polymer as defined in claim 1, wherein M is any metal, M′ is Pt, Z is CN, W is 1, X is 1, Y is 4 and N is 1.

21. The polymer as defined in claim 20, wherein M is selected from the group consisting of Pb and Cd.

22. The polymer as defined in claim 21, wherein M is Pb.

23. A vapochromic coordination polymer comprising:
M[M′(Z)₄]
wherein M is a metal other than M′;
M′ is Pt; and
Z is selected from the group consisting of halides, pseudohalides, thiolates, alkoxides and amides.

24. The polymer as defined in claim 23, wherein Z is CN.

25. A sensor comprising the polymer of claim 23 for reversibly sensing the presence of an analyte selected from the group consisting of a halogen gas and H₂S.

26. The sensor as defined in claim 24, wherein said halogen gas is chlorine.

27. An adduct comprising a polymer as defined in claim 23 and a halogen gas.

28. A method of detecting an analyte comprising:
(a) providing a vapochromic coordination polymer selected from the group consisting of:
(i) a polymer comprising M_{W}[M′_{X}(Z)_{Y}]_{N}
wherein M and M′ are capable of forming a coordinate complex with the Z moiety;
M is selected from the group consisting of Cu and Ag;
M′ is selected from the group consisting of Au and Ag;
Z is CN;
W is between 1-6;
X and Y are between 1-9; and
N is between 1-5; and
(ii) a polymer comprising M_{X}[M′_{y}M″_{2-x-y}(Z)₂]
wherein M, M′ and M″ are the same or different metals selected from the group consisting of Au, Ag, Cu and Tl;
Z is selected from the group consisting of halides, pseudohalides, thiolates, alkoxides and amides; and
X and Y are each between 0 and 1; and
(iii) a polymer comprising M[M′(Z)₄]
wherein M is a metal other than M′;
M′ is Pt; and
Z is selected from the group consisting of halides, pseudohalides, thiolates, alkoxides and amides;
(b) exposing said polymer to a supply of said analyte; and
(c) detecting any chromatic changes in said polymer resulting from exposure to said analyte.

29. The method as defined in claim 28, wherein said detecting comprises sensing any changes in the colour of said polymer.

30. The method as defined in claim 28, wherein said detecting comprises sensing any changes in the luminescence of said polymer.

31. The method as defined in claim 28, wherein said detecting comprises identifying any changes in the spectroscopic signature of said polymer.

32. The method as defined in claim 31, wherein said detecting comprises identifying changes in the infrared (IR) spectra of said polymer.

33. The method as defined in claim 31, wherein said detecting comprises identifying any changes in the Raman spectra of said polymer.

34. The method as defined in claim 33, wherein said detecting comprises identifying any changes in the surface-enhanced Raman spectra (SERS) of said polymer.

35. The method as defined in claim 28, wherein said analyte is selected from the group consisting of a phosphorous donor, a sulphur donor and a selenium donor.

36. The method as defined in claim 35, wherein said analyte is a phosphine or a sulphur donor selected from the group consisting of thiols, alkylthiols, H₂S, dialkylthioethers and diarylthioethers.

37. The method as defined in claim 36, wherein said sulfur donor is selected from the group consisting of Me₂S, Et₂S and H₂S.

38. The method as defined in claim 28, wherein said supply of said analyte is in the vapour phase.

39. The method as defined in claim 28, wherein said polymer is exposed to said analyte in the liquid phase by suspending said polymer in a solution containing said analyte.

40. The method as defined in claim 39, wherein said solution comprises a solvent selected from the group consisting of an aqueous solvent and a hydrocarbon solvent.

41. The method as defined in claim 40, wherein said hydrocarbon solvent comprises hexanes.

42. The method as defined in claim 28, wherein said polymer comprises M_{W}[M′_{X}(Z)_{Y}]_{N} and wherein M is Cu(I), W is 1, X is 1, Y is 2 and N is 1.

43. The method as defined in claim 28, wherein said polymer comprises Mₓ[M′_{y}M″_{2-x-y}(Z)₂] and wherein M is Cu(I), M′ is Au, Z is CN, and Y=2-X.

44. The method as defined in claim 28, wherein said polymer comprises M[M′(Z)₄] wherein M is Pb and Z is CN.

45. A method for reversibly detecting the presence of an analyte selected from the group consisting of Me₂S and Et₂S comprising exposing a polymer as defined in claim 18 to said analyte.

46. A method of reversibly sensing the presence of chlorine gas comprising exposing a polymer as defined in claim 23 to said gas.

47. A light-emitting composition having the general formula Cu[Au(CN)₂](Me₂S).

48. The composition as defined in claim 47 capable of emitting white light.

49. A vapochromic coordination polymer comprising:
M_{W}[M′_{X}(Z)_{Y}]_{N}
wherein M is a uranyl cation comprising uranium,
M′ is a metal
Z is selected from the group consisting of halides, pseudohalides, thiolates, alkoxides and amides;
W is 1; X is 1, Y is 2 and N is 1 or 2.

50. The polymer as defined in claim 49, wherein M′ is Au or Pt and Z is CN.

51. The polymer as defined in claim 50, wherein said polymer comprises structural elements selected from the group consisting of [ⁿBu₄N]₂[(UO₂)₂(μ²-O₂)(NO₃)₂(μ²-Au(CN)₂]₂, [UO₂(bipy)(MeO)(MeOH)]₂[(μ²-Au(CN)₂)Au(CN)₂] and K(UO₂)(μ³-O)₂(NO₃)₂(UO₂)(Au(CN)₂].nMeCN.

52. A method of detecting an analyte comprising:
(a) providing a polymer as defined in claim 49;
(b) exposing said polymer to a supply of said analyte; and
(c) detecting any chromatic changes in said polymer resulting from exposure to said analyte.

53. The method as defined in claim 52, wherein said analyte is an oxygen donor.

54. The method as defined in claim 52, wherein said analyte is selected from the group consisting of aldehydes and dimethylformamide (DMF).

55. The method as defined in claim 54, wherein said analyte is formaldehyde or furfural.

56. The method as defined in claim 55, wherein said detecting is reversible.

57. A method of detecting an analyte comprising:
(a) providing a polymer as defined in claim 23;
(b) exposing said polymer to a supply of said analyte; and
(c) detecting any chromatic changes in said polymer resulting from exposure to said analyte.

58. The method as defined in claim 57, wherein said analyte is selected from the group consisting of halogens and H₂S.

59. The method as defined in claim 58 wherein M is Pb.

60. The method as defined in claim 57, wherein said detecting is reversible.

61. A vapochromic coordination polymer comprising:
M_{W}[M′_{X}(Z)_{Y}(Z′)_{O}]_{N},
wherein M and M′ are the same or different metals selected from the group consisting of Au, Ag, Cu, Pb, Pt, Ni and Tl;
Z and Z′ are each selected from the group consisting of halogens, halides, pseudohalides, thiolates, alkoxides and amides; and
W is between 1-6;
X, Y and O are between 1-9; and
N is between 1-5.

62. The polymer as defined in claim 61, wherein M is Pb, Cu or Ni, M′ is Pt, Z is a pseudohalide, Z′ is a halogen, W, X and N are 1 or 2 and Y and O are between 1-4.

63. The polymer as defined in claim 62, wherein W, X and N are 1, Z is CN, Z′ is Cl, Y is 4 and O is 2.

64. A sensor comprising the vapochromic coordination polymer of claim 62.

65. A method of detecting an analyte comprising:
(a) providing a polymer as defined in claim 61;
(b) exposing said polymer to a supply of said analyte; and
(c) detecting any chromatic changes in said polymer resulting from exposure to said analyte.

66. The method as defined in claim 65, wherein said analyte is a nitrogen donor.

67. A vapochromic coordination polymer comprising units having the formula
M_{W}[M′_{X}(Z)_{Y}]_{N}
wherein M and M′ are the same or different metals capable of forming a coordinate complex with the Z moiety;
Z is selected from the group consisting of halides, pseudohalides, thiolates, alkoxides and amides;
W is between 1-6;
X and Y are between 1-9; and
N is between 1-5.

68. The polymer as defined in claim 67, wherein M is Cu(I), M′ is Au, Z is CN, X is 1 and 1, Y is 2 and N is 1.

69. The polymer as defined in claim 67, wherein M is Pb, M′ is Pt, Z is CN, X is 1, Y is 4 and N is 1.

70. A method of testing for the presence of an analyte in a test sample comprising:
(a) providing a coordination polymer as defined in claim 67;
(b) exposing said polymer to said test sample; and
(c) detecting any chromatic changes in said polymer.
